(19) United States
(12) Patent Application Publication
(10) Pub. No.: US 2011/0003524 A1
(43) Pub. Date: Jan. 6, 2011

(54) FIBERS AND FABRICS MADE FROM ETHYLENE/alpha-OLEFIN INTERPOLYMERS

(75) Inventors: Gert J. Claasen, Richterswil (CH); Ronald J. Weeks, Lake Jackson, TX (US); Andy C. Chang, Houston, TX (US); Debra H. Niemann, Lake Jackson, TX (US)

Correspondence Address: The Dow Chemical Company, P.O. BOX 1967, 2040 Dow Center, Midland, MI, 48641, US

(73) Assignee: DOW GLOBAL TECHNOLOGIES INC., Midland, MI (US)

(21) Appl. No.: 12/865,545

(22) PCT Filed: Feb. 20, 2009
(86) PCT No.: PCT/US2009/034666

§ 371 Date: Jul. 30, 2010

Related U.S. Application Data
(60) Provisional application No. 61/032,459, filed on Feb. 29, 2008.

(51) Int. Cl. D04H 13/00; B32B 5/26; D02G 3/04; D02G 3/36

(52) U.S. Cl. 442/329; 442/361; 442/364; 442/334; 428/373

(57) ABSTRACT

A bicomponent fiber is obtainable from or comprises an ethylene/α-olefin interpolymer characterized by an elastic recovery, Re, in percent at 300 percent strain and 1 cycle and a density, d, in grams/cubic centimeter, wherein the elastic recovery and the density satisfy the following relationship: Re>1481−1629(d). Such interpolymer can also be characterized by other properties. The fibers made therefrom have a relatively high elastic recovery and a relatively low coefficient of friction. The fibers can be cross-linked, if desired. Woven or non-woven fabrics, such as spunbond, melt blown and spun-laced fabrics or webs can be made from such fibers.

### CROSS-REFERENCE TO RELATED APPLICATIONS

This application is related to U.S. Provisional Application No. 60/718,197, filed Sep. 16, 2005. This application also is related to PCT Application No. PCT/US2005/008917, filed on Mar. 17, 2005, which in turn claims priority to U.S. Provisional Application No. 60/553,906, filed Mar. 17, 2004. This application is also related to U.S. application Ser. No. 11/376,873. For purposes of United States patent practice, the contents of these applications and the PCT application are herein incorporated by reference in their entirety.

### FIELD OF THE INVENTION

This invention relates to fibers made from ethylene/α-olefin interpolymers, methods of making the fibers, products made from the fibers, and articles which comprise the fibers and products. Products made from the fibers include woven, nonwoven fabrics (i.e webs). Extensible and elastic bicomponent fibers and webs of the present invention are particularly adapted for disposable personal care product component applications. Sheath/core configurations providing desirable feel properties for elastic embodiments when compared with conventional elastic fibers and webs are obtained with specific olefin polymer combinations and sheath configurations.

### BACKGROUND OF THE INVENTION

Fibers are typically classified according to their diameter. Monofilament fibers are generally defined as having an individual fiber diameter greater than about 15 denier, usually greater than about 30 denier per filament. Fine denier fibers generally refer to fibers having a diameter less than about 15 denier per filament. Microdenier fibers are generally defined as fibers having less than 100 microns in diameter. Fibers can also be classified by the process by which they are made, such as monofilament, continuous wound fine filament, staple or short cut fiber, spun bond, and melt blown fibers.

Fibers with excellent extensibility and elasticity are needed to manufacture a variety of fabrics which are used, in turn, to manufacture a myriad of durable articles (i.e. sport apparel, bedding, and furniture upholstery) and limited use articles (i.e. diapers, training pants, swim pants, feminine hygiene articles, incontinent wear, veterinary products, maternity support articles, wound care articles, medical gowns, sterilization wraps, medical drapes and the like). Extensibility is a performance attribute which describes the ability of a material such as fiber or fabric to undergo mechanical elongation to a significant extent without completely rupturing. Extensible materials can find use during manufacture (i.e. ring-rolling/selfing, stretch bond laminate processes, neck bond laminate processes) to produce particular products such as elastic laminates which in hygiene articles can be conform to the body of the wearer for increased comfort and fit. Elasticity is a subset of the extensibility. An elastic material such as a fiber or fabric is able to undergo mechanical elongation to a significant extent without completely rupturing and then is able to recover to a significant extent upon release of force. Furthermore, elastic materials can provide retractive force in end use to also maintain fit during extensions and retractions at ambient, body and other temperatures. In the case of multiple use articles, the material should exhibit sufficient heat resistance to maintain functionality in properties listed above at temperatures present such as those experienced during the washing and drying of the fabric.

Fibers are typically characterized as extensible if the elongation at a maximum force during the tensile test is at least 50% of the original dimension. For fabrics, the material is extensible if elongation at peak force (elong at peak) is at least 80% (i.e. 1.8× of the original dimension). Subsequent decrease in peak force after the peak typically corresponds to substantial rupture and loss of integrity of the fabric.

Fibers are typically characterized as elastic if they have a high percent elastic recovery (that is, a low percent permanent set) after application of a biasing force. Ideally, elastic materials are characterized by a combination of three important properties: (i) a low percent permanent set, (ii) a low stress or load at strain, (iii) a low percent stress or load relaxation (iv) sufficient retractive force (sufficient load down at a corresponding strain). In other words, elastic materials are characterized as having the following properties (i) a low stress or load requirement to stretch the material, (ii) minimal relaxing of the stress or unloading once the material is stretched, (iii) complete or high recovery to original dimensions after the stretching, biasing or straining is discontinued, and (iv) retractive force at a given basis weight that meets or exceeds a target level.

Spandex is a segmented polyurethane elastic material known to exhibit nearly ideal elastic properties. However, spandex is cost prohibitive for many applications. Also, spandex exhibits poor environmental resistance to ozone, chlorine and high temperature, especially in the presence of moisture. Such properties, particularly the lack of resistance to chlorine, causes spandex to pose distinct disadvantages in apparel applications, such as swimwear and in white garments that are desirably laundered in the presence of chlorine bleach.

A variety of fibers and fabrics have been made from thermoplastics, such as polypropylene, highly branched low density polyethylene (LDPE) made typically in a high pressure polymerization process, linear heterogeneously branched polyethylene (e.g., linear low density polyethylene made using Ziegler catalysis), blends of polypropylene and linear heterogeneously branched polyethylene, blends of linear heterogeneously branched polyethylene, and ethylene/vinyl alcohol copolymers.

Recently, ethylene-based and propylene-based copolymers marketed under tradenames such as VERSIFY™ and AFFINITY™ plastomers produced by The Dow Chemical Company, VISTAMAXX™ and EXACT produced by Exxon-Mobil, and, TAFMER™ produced by Mitsui, have been developed. While these new polymers may be made into extensible and elastic fibers and fabrics, they tend to suffer from poor processibility which is measurable in the form of stickiness, self-adherance, and poor formation during processing; and from poor end-use characteristics measured in terms of elasticity and heat resistance. These limitation can render materials comprised of the ones listed above, in particular those of random or substantially random molecular structure, significantly disadvantaged and therefore commercially unattractive.

One possible explanation for the difficulty in converting substantially random materials may be their molecular structures. These polymers have particular difficulty crystallizing in sufficient fashion at typical fabrication conditions and rates. The products can stick to converting equipment, stick each other, have narrow bonding temperature windows, block on the roll, and have low heat resistance. Having one or more of these characteristics can translate to a product which is inordinately difficult to fabricate and to use.

In spite of the advances made in the art, there is a persistent need for polyolefin-based elastic compositions that not only can be converted readily in order to be produced at advantaged line-speeds but also are soft and yielding to body movement. Preferably, such fibers would have been extensible, more preferably elastic, and could be made at a relatively high throughput. Moreover, it would be desirable to form fibers and fabrics which do not require cumbersome processing steps or modifications but still provide soft, comfortable fabrics which are not tacky.

### SUMMARY OF THE INVENTION

The aforementioned needs are met by various aspects of the invention.

In one aspect, the invention relates to a spunbond fabric obtainable from or comprising bicomponent fiber comprising at least one ethylene/α-olefin interpolymer, wherein the ethylene/α-olefin interpolymer is present in a portion of the fiber other than a surface and is characterized by one or more of the following properties:

(a) a Mw/Mn from about 1.7 to about 3.5, at least one melting point, Tm, in degrees Celsius, and a density, d, in grams/cubic centimeter, wherein the numerical values of Tm and d correspond to the relationship:

Tₘ>−6553.3+13735(d)−7051.7(d)², and preferably

Tₘ≧−6880.9+14422(d)−7404.3(d)², and more preferably

Tₘ≧−7208.6−15109(d)−7756.9(d)²; or

(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or

(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:

Re>1481−1629(d); or

(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer; or

(e) having a storage modulus at 25° C., G′ (25° C.), and a storage modulus at 100° C., G′ (100° C.), wherein the ratio of G′(25° C.) to G′ (100° C.) is from about 1:1 to about 10:1; or

(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(g) having an average block index greater than zero and up to about 1.0 and a molecular weight distribution, Mw/Mn, greater than about 1.3, preferably wherein the fibers have a thermal bonding temperature range of from about 70° C. to about 125° C. The interpolymer comprising the bicomponent fiber preferably has a density of 0.895 g/cc or below and/or a melt index of 15 g/10 minutes and above, preferably in from about 20 to about 30 grams/10 minutes.

Preferably, the bicomponent fiber comprises a sheath/core structure and where the interpolymer comprises the core of the fiber. The core can comprise from about 40 to about 95 weight percent, preferably 85 to 95 weight percent, of the total composition of the bicomponent fiber. The sheath can comprise from about 5 to about 35%. The sheath can be either continuous or discontinuous.

In another embodiment, the spunbonded fabric can further comprise a melt blown fabric thereby forming a spunbond/melt blown composite fabric structure, preferably wherein the melt blown fabric is in intimate contact with the spunbond fabric. The melt blown fabric preferably comprises at least one bicomponent fiber, especially wherein the bicomponent fiber comprises a sheath/core structure. More preferably, the core of the bicomponent fiber of the melt blown fabric comprises an ethylene/alpha-olefin interpolymer and is characterized by one or more of the following properties:

(a) a Mw/Mn from about 1.7 to about 3.5, at least one melting point, Tm, in degrees Celsius, and a density, d, in grams/cubic centimeter, wherein the numerical values of Tm and d correspond to the relationship:

Tₘ>−6553.3+13735(d)−7051.7(d)², and preferably

Tₘ≧−6880.9+14422(d)−7404.3(d)², and more preferably

Tₘ≧−7208.6−15109(d)−7756.9(d)²; or

(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or

(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:

Re>1481−1629(d); or

(d) molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer; or

(e) having a storage modulus at 25° C., G′ (25° C.), and a storage modulus at 100° C., G′ (100° C.), wherein the ratio of G′(25° C.) to G′ (100° C.) is from about 1:1 to about 10:1; or

(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(g) having an average block index greater than zero and up to about 1.0 and a molecular weight distribution, Mw/Mn, greater than about 1.3.

In another embodiment, the invention comprises a carded web obtainable from or comprising bicomponent fiber comprising at least one ethylene/α-olefin interpolymer, wherein the ethylene/α-olefin interpolymer is present in a portion of the fiber other than a surface and wherein the interpolymer characterized by one or more of the following properties:

(a) a Mw/Mn from about 1.7 to about 3.5, at least one melting point, Tm, in degrees Celsius, and a density, d, in grams/cubic centimeter, wherein the numerical values of Tm and d correspond to the relationship:

Tₘ>−6553.3+13735(d)−7051.7(d)², and preferably

Tₘ≧−6880.9+14422(d)−7404.3(d)², and more preferably

Tₘ≧−7208.6−15109(d)−7756.9(d)²; or

(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or

(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:

Re>1481−1629(d); or

(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer, or

(e) having a storage modulus at 25° C., G′ (25° C.), and a storage modulus at 100° C., G′ (100° C.), wherein the ratio of G′(25° C.) to G′ (100° C.) is from about 1:1 to about 10:1; or

(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(g) having an average block index greater than zero and up to about 1.0 and a molecular weight distribution, Mw/Mn, greater than about 1.3, preferably wherein the web is thermally bonded.

The carded staple fiber web can further comprise a spunbond fabric or a melt blown fabric.

In yet another embodiment, the invention comprises a spun laced web obtainable from or comprising bicomponent fiber comprising at least one ethylene/α-olefin interpolymer, wherein the ethylene/α-olefin interpolymer is present in a portion of the fiber other than a surface and wherein the interpolymer characterized by one or more of the following properties:

(a) a Mw/Mn from about 1.7 to about 3.5, at least one melting point, Tm, in degrees Celsius, and a density, d, in grams/cubic centimeter, wherein the numerical values of Tm and d correspond to the relationship:

Tₘ>−6553.3+13735(d)−7051.7(d)², and preferably

Tₘ≧−6880.9+14422(d)−7404.3(d)², and more preferably

Tₘ≧−7208.6−15109(d)−7756.9(d)²; or

(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or

(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:

Re>1481−1629(d); or

(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer or

(e) having a storage modulus at 25° C., G′ (25° C.), and a storage modulus at 100° C., G′ (100° C.), wherein the ratio of G′(25° C.) to G′ (100° C.) is from about 1:1 to about 10:1; or

(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(g) having an average block index greater than zero and up to about 1.0 and a molecular weight distribution, Mw/Mn, greater than about 1.3.

In other embodiments, the invention comprises:

a spunbonded fabric comprising an ethylene based bicomponent fiber (at least about 50 weight percent ethylene content), melt spun at a rate of no less than about 0.5 grams/minute/hole, and wherein the fabric has a root mean square elongation at peak force greater than about 50%, preferably greater than about 60%, more preferably greater than about 100%, and as high as about 250%; or

a spunbonded fabric comprising an ethylene based bicomponent fiber (at least about 50 weight percent ethylene content), melt spun at a rate of no less than about 0.5 grams/minute/hole, and wherein the fabric has a root mean square peak force greater than about 0.1 N/grams/square meter per inch width, preferably greater than about 0.15 grams/square meter per inch width, more preferably greater than about 0.2 grams/square meter per inch width, and as high as about 0.5 N/grams/square meter per inch width; or

a spunbonded fabric comprising an ethylene based bicomponent fiber (at least about 50 weight percent ethylene content), melt spun at a rate of no less than about 0.5 grams/minute/hole, and wherein the fabric has a root mean square permanent set greater than about 15%, preferably greater than about 20%, more preferably greater than about 25%, and as high as about 50%; or

a spunbonded fabric comprising an ethylene based bicomponent fiber (at least about 50 weight percent ethylene content), melt spun at a rate of no less than about 0.5 grams/minute/hole, and wherein the fabric has a root mean square load down at 50% strain greater than about 0 N/gram/square meter per inch width and as high as about 0.004 N/grams/square meter per inch width; or

a spunbonded fabric comprising an ethylene based bicomponent fiber (at least about 50 weight percent ethylene content), melt spun at a rate of no less than about 0.5 grams/minute/hole, and wherein the fabric has a coefficient of friction less than about 0.45 and as low as about 0.15.

Another embodiment of the invention comprises a method of mitigating tackiness comprising selecting a combination chosen from the group consisting of multiple beam spunbond and meltbown combinations such as spunbond/spunbond/spunbond (SSS), spunbond/melt blown (SM), SMS, SMMS, SSMMS, SSMMMS wherein an outermost layer comprises a material selected from the group consisting of spunbond homopolymer polypropylene (hPP), SB heterogeneously branched polyethylene, carded hPP, various bicomponent structures, wherein the selected combination has a coefficient of friction (COF) of less than about 0.45, preferably less than about 0.35, especially less than about 0.25, optionally wherein the selected combination further comprises addition of slip additive (erucamide for example) or addition of low molecular weight (i.e., Mw less than about 20,000) polymer.

In another aspect, the invention relates to a melt blown fabric obtainable from or comprising bicomponent fiber comprising at least one ethylene/α-olefin interpolymer, wherein the ethylene/α-olefin interpolymer is present in a portion of the fiber other than the sheath and is characterized by one or more of the following properties:

(a) a Mw/Mn from about 1.7 to about 3.5, at least one melting point, Tm, in degrees Celsius, and a density, d, in grams/cubic centimeter, wherein the numerical values of Tm and d correspond to the relationship:

Tₘ>−6553.3+13735(d)−7051.7(d)², and preferably

Tₘ≧−6880.9+14422(d)−7404.3(d)², and more preferably

Tₘ≧−7208.6−15109(d)−7756.9(d)²; or

(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or

(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:

Re>1481−1629(d); or

(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer or

(e) having a storage modulus at 25° C., G′ (25° C.), and a storage modulus at 100° C., G′(100° C.), wherein the ratio of G′(25° C.) to G′ (100° C.) is from about 1:1 to about 10:1; or

(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(g) having an average block index greater than zero and up to about 1.0 and a molecular weight distribution, Mw/Mn, greater than about 1.3.

In another embodiment, the invention comprises a bicomponent fiber comprising at least one ethylene/α-olefin interpolymer, wherein the ethylene/α-olefin interpolymer is present in a portion of the fiber other than the sheath and is characterized by one or more of the following properties:

(a) a Mw/Mn from about 1.7 to about 3.5, at least one melting point, Tm, in degrees Celsius, and a density, d, in grams/cubic centimeter, wherein the numerical values of Tm and d correspond to the relationship:

Tₘ>−6553.3+13735(d)−7051.7(d)², and preferably

Tₘ≧−6880.9+14422(d)−7404.3(d)², and more preferably

Tₘ≧−7208.6−15109(d)−7756.9(d)²; or

(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or

(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:

Re>1481−1629(d); or

(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer or

(e) having a storage modulus at 25° C., G′ (25° C.), and a storage modulus at 100° C., G′ (100° C.), wherein the ratio of G′(25° C.) to G′ (100° C.) is from about 1:1 to about 10:1; or

(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(g) having an average block index greater than zero and up to about 1.0 and a molecular weight distribution, Mw/Mn, greater than about 1.3, preferably wherein the interpolymer comprises from about 5 to about 35% of the total weight of the fiber.

In yet another aspect, the invention comprises a nonwoven fabric comprising a sheath/core bicomponent fiber comprising different ethylene/α-olefin interpolymers, wherein the sheath and the core each comprises an ethylene/α-olefin interpolymer characterized by one or more of the following properties:

(a) a Mw/Mn from about 1.7 to about 3.5, at least one melting point, Tm, in degrees Celsius, and a density, d, in grams/cubic centimeter, wherein the numerical values of Tm and d correspond to the relationship:

Tₘ>−6553.3+13735(d)−7051.7(d)², and preferably

Tₘ≧−6880.9+14422(d)−7404.3(d)², and more preferably

Tₘ≧−7208.6−15109(d)−7756.9(d)²; or

(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,
ΔT≧48° C. for ΔH greater than 130 J/g, wherein the CRYSTAF peak is determined using at least 5 percent of the cumulative polymer, and if less than 5 percent of the polymer has an identifiable CRYSTAF peak, then the CRYSTAF temperature is 30° C.; or

(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:

Re>1481−1629(d); or

(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer; or

(e) having a storage modulus at 25° C., G′ (25° C.), and a storage modulus at 100° C., G′ (100° C.), wherein the ratio of G′(25° C.) to G′ (100° C.) is from about 1:1 to about 10:1; or

(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(g) having an average block index greater than zero and up to about 1.0 and a molecular weight distribution, Mw/Mn, greater than about 1.3, and wherein the ethylene/α-olefin interpolymer in the core has a density less than that of the ethylene/α-olefin interpolymer in the sheath, preferably at least about 0.004 g/cm³ units less.

Use of fabric according to all of these aspects of the invention for manufacturing products selected from the group consisting of medical products, personal care products and outdoor fabrics is also contemplated.

The invention may be practiced using a variety of low modulus polymers for component A, including relatively nonelastic, higher melting and more crystalline polymers as well as blends of polymers that separate into sheath patches or discontinuities. Typically, component B comprises at least one ethylene/α-olefin copolymers but may also optionally include non block olefin polymers and copolymers including single site catalyzed or metallocene or non-metallocene catalyzed ethylene and propylene based polymers such as a reactor grade polymer having a MWD less than about 5 and blends, and in many cases will have a heat of melting less than about 60 Joules per gram. One or both components A and B may also comprise one or more styrenic block copolymer (SBC). Descriptions of suitable SBCs are described elsewhere in this document. Both components A and B may contain various additives for specific properties, and additional components may be included as explained in more detail below. Moreover, certain embodiments will utilize ethylene/α-olefin copolymers for components A and B with at least about 2% by weight less co-monomer in component A. Other embodiments use as component A or B, a ethylene/α-olefin copolymers containing at least 33% by weight comonomer. For example in the case of an ethylene-octene copolymer such that the α-olefin is octene, the polymer comprises at least 33% by weight octene (11 mole percent octene). Though not intended to be limited by theory, it is thought that comonomer content controls the ability of a polymer to crystallize which affects the resulting morphology. The morphology in turn is thought to strongly affect mechanical properties such as tensile and elastic performance.

The styrenic block copolymers (SBC) that are suitable for use in the invention are defined as having at least a first block of one or more mono alkenyl arenes (A block), such as styrene and a second block of a controlled distribution copolymer (B block) of diene and mono alkenyl arene. The method to prepare this thermoplastic block copolymer is via any of the methods generally known for block polymerizations.

The present invention includes as an embodiment a thermoplastic copolymer composition, which may be either a di-block copolymer, tri-block copolymer, tetra-block copolymer or multi-block copolymer composition. In the case of the di-block copolymer composition, one block is the alkenyl arene-based homopolymer block and polymerized therewith is a second block of a controlled distribution copolymer of diene and alkenyl arene. In the case of the tri-block copolymer composition it comprises, as end-blocks the glassy alkenyl arene-based homopolymer and as a mid-block the controlled distribution copolymer of diene and alkenyl arene. Where a tri-block copolymer composition is prepared, the controlled distribution diene/alkenyl arene copolymer can be herein designated as “B” and the alkenyl arene-based homopolymer designated as “A”. The A-B-A, tri-block copolymer compositions can be made by either sequential polymerization or coupling. In the sequential solution polymerization technique, the mono alkenyl arene is first introduced to produce the relatively hard aromatic block, followed by introduction of the controlled distribution diene/alkenyl arene mixture to form the mid block, and then followed by introduction of the mono alkenyl arene to form the terminal block. In addition to the linear, A-B-A configuration, the blocks can be structured to form a radial (branched) polymer, (A-B)ₙX, or both types of structures can be combined in a mixture. Some A-B diblock polymer can be present but preferably at least about 70 weight percent of the block copolymer is A-B-A or radial (or otherwise branched so as to have 2 or more terminal resinous blocks per molecule) so as to impart strength. In general, styrenic block copolymers suitable for this embodiment have at least two monoalkenyl arene blocks, preferably two polystyrene blocks, separated by a block of saturated conjugated diene comprising less than 20% residual ethylenic unsaturation, preferably a saturated polybutadiene block. The preferred styrenic block copolymers have a linear structure although branched or radial polymers or functionalized block copolymers make useful compounds.

In another embodiment of the invention the composition comprises at least one SBC in the group: styrene-ethylene-propylene-styrene (SEPS), styrene-ethylenepropylene-styrene-ethylene-propylene SEPSEP), hydrogenated polybutadiene polymers such as styrene-ethylenebutylene styrene (SEBS), styrene-ethylene-butylene-styrene-ethylene-butylene (SEBSEB), styrene-butadiene-styrene (SBS), styrene-isoprene-styrene (SIS), styrene-ethylene-styrene (SES), and hydrogenated poly isoprene/butadiene polymer such as styrene-ethylene-ethylene propylene-styrene (SEEPS).

In another embodiment of this invention, the styrenic block copolymers comprise the majority polymer component of at least one component of the structure. In another embodiment, the majority polymer component of at least one component of the structure comprises a blend comprising ethylene/alpha-olefin with at least one styrenic block copolymer as described in SIR 1808, EP0712892B1; DE69525900-8; ES2172552; U.S. Patent Application No. 60/237,533; and WO 02/28965 A1. In another embodiment, the majority polymer component of at least one layer of the structure comprises a blend of an ethylene/alpha-olefin multi-block interpolymer with at least one styrenic block copolymer as described in U.S. Patent Application No. 60/718,245 In another embodiment, the majority polymer component of at least one layer of the structure comprises a blend comprising propylene-alpha olefin copolymer with at least one styrenic block copolymer as described in U.S. Patent Application No. 60/753,225.

In another embodiment of the invention, at least one SBC-based composition is used from the group of materials described in at least one of the publications: WO2007/027990A2, U.S. Pat. No. 7,105,559, EP1625178B1, US2007/0055015A1 US2005/0196612A1, WO2005/092979A1, US2007/0004830A1, US2006/0205874A1, and EP1625178B1. The definitions, methods, synthetic chemical reactions, compositions, formulations, molecular weights, thermal properties, melt characteristics, phase structures, solid-state structures, mechanical characteristics, formulations, methods of compounding, methods of processing, and preferred operating ranges and material specifications are herein incorporated by reference.

Additional aspects of the invention and characteristics and properties of various embodiments of the invention become apparent with the following description.

### BRIEF DESCRIPTION OF THE DRAWINGS

FIG. 1 shows the throughput (grams/hole/minute) for various examples and comparative examples.

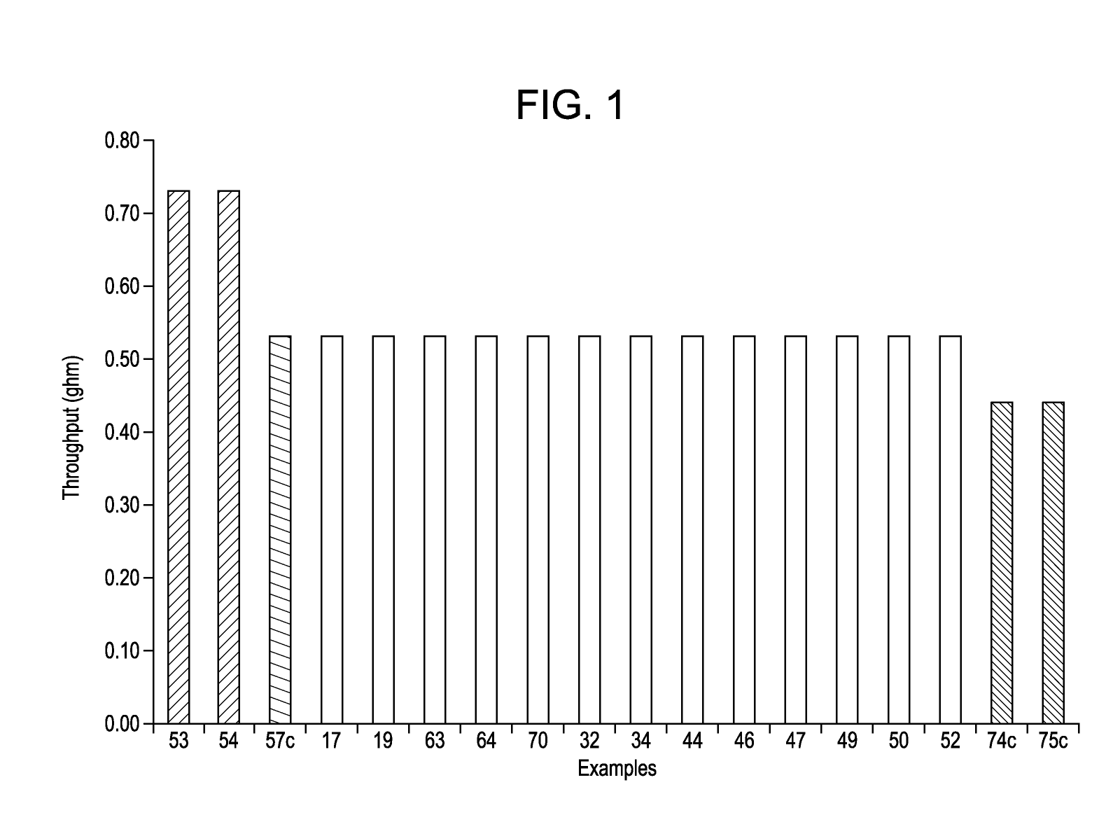

FIG. 2 is a schematic illustration of a bicomponent spinning system that may be used in accordance with the invention to form a spunbond nonwoven.

FIGS. 3a-3c illustrate various cross-sectional configurations of sheath/core structures for conjugate fibers in accordance with the invention.

FIGS. 4a-4c are schematic illustrations showing fibers in accordance with the invention at different sheath configurations.

FIG. 5 are stress/strain curves for Example 62 (MD and CD) and the methodology for calculating RMS elongation peak and RMS peak force.

### DETAILED DESCRIPTION OF THE INVENTION

### General Definitions

“Fiber” means a material in which the length to diameter ratio is greater than about 10. Fiber is typically classified according to its diameter. Filament fiber is generally defined as having an individual fiber diameter greater than about 15 denier, usually greater than about 30 denier per filament. Fine denier fiber generally refers to a fiber having a diameter less than about 15 denier per filament. Microdenier fiber is generally defined as fiber having a diameter less than about 100 microns denier per filament.

“Filament fiber” or “monofilament fiber” means a continuous strand of material of indefinite (i.e., not predetermined) length, as opposed to a “staple fiber” which is a discontinuous strand of material of definite length (i.e., a strand which has been cut or otherwise divided into segments of a predetermined length).

“Elastic” means that a fiber will recover at least about 50 percent of its stretched length after the first pull and after the fourth to 100% strain (doubled the length). Elasticity can also be described by the “permanent set” of the fiber. Permanent set is the converse of elasticity. A fiber is stretched to a certain point and subsequently released to the original position before stretch, and then stretched again. The point at which the fiber begins to pull a load is designated as the percent permanent set. “Elastic materials” are also referred to in the art as “elastomers” and “elastomeric”. Elastic material (sometimes referred to as an elastic article) includes the copolymer itself as well as, but not limited to, the copolymer in the form of a fiber, film, strip, tape, ribbon, sheet, coating, molding and the like. The preferred elastic material is fiber. The elastic material can be either cured or uncured, radiated or un-radiated, and/or crosslinked or uncrosslinked.

“Nonelastic material” means a material, e.g., a fiber, that is not elastic as defined above. The RMS elongation at peak force is less than 50% (i.e. less then 1.5× of the original dimension) using the tensile test described elsewhere in this document. Subsequent decrease in peak force after the peak typically corresponds to progressive fiber rupture and loss of integrity of the fabric.

“Extensible fabric” means that the RMS elongation at peak force is at least 50% (i.e. 1.5× of the original dimension) using the tensile test described elsewhere in this document. Subsequent decrease in peak force after the peak typically corresponds to progressive fiber rupture and loss of integrity of the fabric.

“Elastic fabric” means that the fabric for the RMS elongation at peak force is at least 80% (i.e. 1.8× of the original dimension) using the Fabric Tensile Test and that the RMS set is at most 25% after the 80% Hysteresis Test. The Fabric Tensile Test and the 80% Hysteresis Test are described elsewhere in this document. “Elastic fabrics” are also referred to in the art as articles comprising “elastomers” and exhibit “elastomeric” properties. “Elastic fabrics” material (sometimes referred to as an elastic article) includes the ethylene/α-olefin copolymer itself as well as, but not limited to structures comprising the copolymer in the form of a fiber, film, strip, tape, ribbon, sheet, coating, molding and the like. The preferred elastic material is fiber. The elastic material can be either cured or uncured, radiated or un-radiated, and/or crosslinked or uncrosslinked. Furthermore, the elastic fabrics may be combined with other components such as fiber, film, strip, tape, ribbon, sheet, molding using a means such as coating, thermal lamination, adhesive attachment, ultrasonic bonding, or any other means known to those of average knowledge in the art. The purpose would be to construct composite structures such as laminates or articles which would exhibit properties of its components.

“Substantially crosslinked” and similar terms mean that the copolymer, shaped or in the form of an article, has xylene extractables of less than or equal to 70 weight percent (i.e., greater than or equal to 30 weight percent gel content), preferably less than or equal to 40 weight percent (i.e., greater than or equal to 60 weight percent gel content). Xylene extractables (and gel content) are determined in accordance with ASTM D-2765.

“Homofil fiber” means a fiber that has a single polymer region or domain, and that does not have any other distinct polymer regions (as do bicomponent fibers).

“Bicomponent fiber” means a fiber that has two or more distinct polymer regions or domains. Bicomponent fibers are also know as conjugated or multicomponent fibers. The polymers are usually different from each other although two or more components may comprise the same polymer. The polymers are arranged in substantially distinct zones across the cross-section of the bicomponent fiber, and usually extend continuously along the length of the bicomponent fiber. The configuration of a bicomponent fiber can be, for example, a sheath/core arrangement (in which one polymer is surrounded by another), a side by side arrangement, a pie arrangement or an “islands-in-the sea” arrangement. Bicomponent fibers are further described in U.S. Pat. Nos. 6,225,243, 6,140,442, 5,382,400, 5,336,552 and 5,108,820.

In some embodiments, the fiber has a diameter in the range of about 0.1 denier to about 1000 denier and the interpolymer has a melt index from about 0.5 to about 2000 and a density from about 0.865 g/cc to about 0.955 g/cc. In other embodiments, the fiber has a diameter in the range of about 0.1 denier to about 1000 denier and the interpolymer has a melt index from about 1 to about 2000 and a density from about 0.865 g/cc to about 0.955 g/cc. In still other embodiments, the fiber has a diameter in the range of about 0.1 denier to about 1000 denier and the interpolymer has a melt index from about 3 to about 1000. For nonwoven process and a density from about 0.865 g/cc to about 0.955 g/cc.

The bicomponent fiber can have a sheath-core structure; a sea-island structure; a side-by-side structure; a matrix-fibril structure; or a segmented pie structure. The fiber can be a staple fiber or a binder fiber. In some embodiments, the fiber has a coefficient of friction of less than about 1.2, wherein the interpolymer is not mixed with any filler.

In some embodiments, the bicomponent fiber comprises 0.001% to about 20% desirably to about 15% for some applications and to about 10% for other applications by weight of the total fiber, of a first component A which comprises at least a portion, in some cases at least a third, of the fiber surface, said first component comprising a higher crystalline homopolymer or copolymer, and a second component B which comprises an elastic ethylene/α-olefin copolymer, which in some cases comprises an ethylene-based olefin block interpolymer. Preferably, component B is completely encased by component A (other than the fiber ends). Also, preferably component A is selected from the group consisting of heterogeneous ethylene based copolymers (such as Ziegler Natta copolymers—for example DOWLEX™ LLDPE and/or ASPUN™ Fiber Grade Resins supplied by The Dow Chemical Company), other ethylene based copolymers such as ELITE™ enhanced polyethylene, propylene homopolymers and copolymers (such as VERSIFY™ plastomers supplied by The Dow Chemical Company and VISTAMAXX™ produced by Exxon-Mobil) and blends thereof.

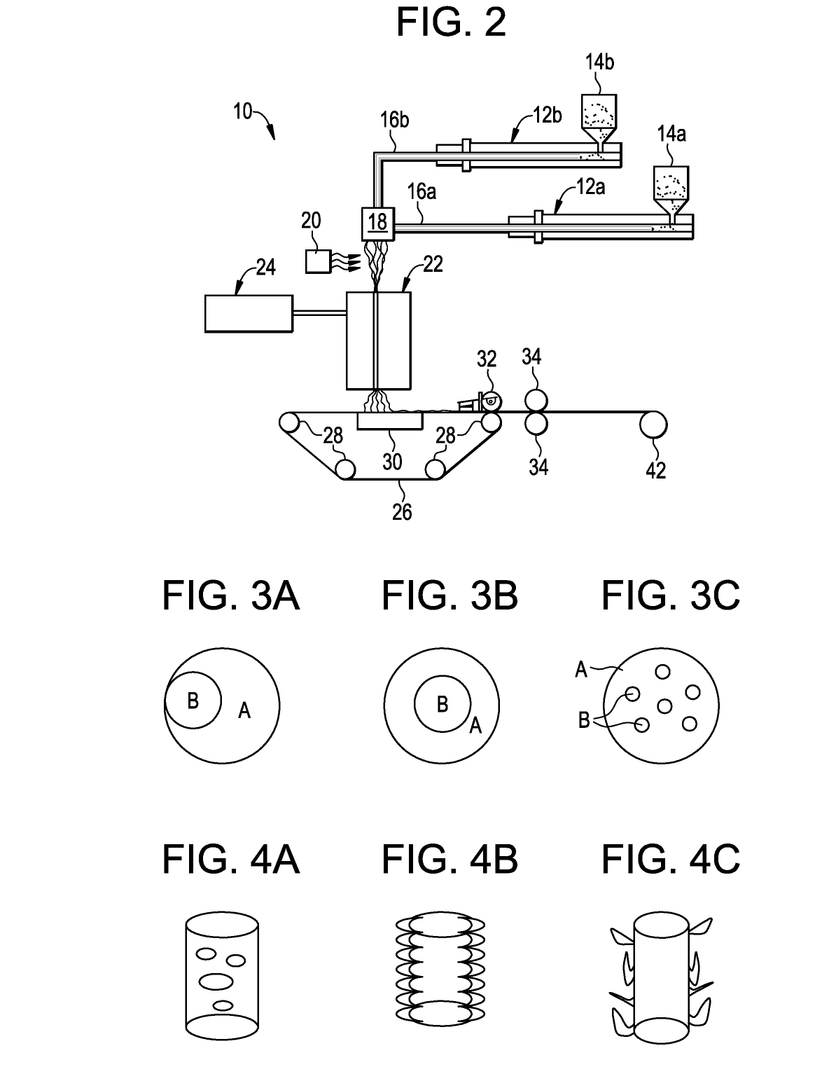

Turning to FIG. 2, a process line 10 for preparing one embodiment of the present invention is illustrated. The process line 10 is arranged to produce bicomponent continuous filaments but it should be understood that the present invention comprehends nonwoven fabrics made with conjugate filaments having more than two components. For example, the filaments and nonwoven fabrics of the present invention can be made with filaments having one, two, three, four or more components.

The process line 10 includes a pair of extruders 12a and 12b for separately extruding a polymer component A and a polymer component B. Polymer component A is fed into the respective extruder 12a from a first hopper 14a and a polymer component B is fed into the respective extruder 12b from a second hopper 14b. Polymer components A and B are fed from the extruders 12a and 12b through respective polymer conduits 16a and 16b to a spinneret 18.

Spinnerets for extruding conjugate filaments are well-known to those of skill in the art and thus are not described herein in detail. Generally described, the spinneret 18 includes a housing containing a spin pack which includes a plurality of plates stacked one on top of the other with a pattern of openings arranged to create flow paths for directing polymer components A and B separately through the spinneret. The spinneret 18 has openings arranged in one or more rows. The spinneret openings form a downwardly extruding curtain of filaments when the polymers are extruded through the spinneret. Spinneret 18 may be arranged to form sheath/core, eccentric sheath/core or other filament cross-sections.

The process line 10 also includes a quench blower 20 positioned adjacent the curtain of filaments extending from the spinneret 18. Air from the quench air blower 20 quenches the filaments extending from the spinneret 18. The quench air can be directed from one side of the filament curtain as shown in FIG. 2 or both sides of the filament curtain.

A fiber draw unit or aspirator 22 is positioned below the spinneret 18 and receives the quenched filaments. Fiber draw units or aspirators for use in melt spinning polymers are well-known as discussed above. Suitable fiber draw units for use in the process of the present invention include a linear fiber aspirator of the type shown in U.S. Pat. Nos. 3,802,817 and 3,423,255, the disclosures of which are incorporated herein by reference in their entireties.

Generally described, the fiber draw unit 22 includes an elongate vertical passage through which the filaments are drawn by aspirating air entering from the sides of the passage and flowing downwardly through the passage. A heater or blower 24 supplies aspirating air to the fiber draw unit 22. The aspirating air draws the filaments and ambient air through the fiber draw unit.

An endless forminis forming surface 26 is positioned below the fiber draw unit 22 and receives the continuous filaments from the outlet opening of the fiber draw unit. The forming surface 26 travels around guide rollers 28. A vacuum 30 positioned below the forming surface 26 where the filaments are deposited draws the filaments against the forming surface.

The process line 10 further includes a bonding apparatus such as thermal point bonding rollers 34 (shown in phantom) or a through-air bonder. Thermal point bonders and through-air bonders are well-known to those skilled in the art and are not described herein in detail. Generally described, the through-air bonder includes a perforated roller which receives the web, and a hood surrounding the perforated roller. Lastly, the process line 10 includes a winding roll 42 for taking up the finished fabric.

To operate the process line 10, the hoppers 14a and 14b are filled with the respective polymer components A and B. Polymer components A and B are melted and extruded by the respective extruders 12a and 12b through polymer conduits 16a and 16b and the spinneret 18. As the extruded filaments extend below the spinneret 18, a stream of air from the quench blower 20 at least partially quenches the filaments.

After quenching, the filaments are drawn into the vertical passage of the fiber draw unit 22 by a flow of a gas such as air, from the heater or blower 24 through the fiber draw unit. The flow of gas causes the filaments to draw or attenuate which increases the molecular orientation or crystallinity of the polymers forming the filaments.

The filaments are deposited through the outlet opening of the fiber draw unit 22 onto the traveling forming surface 26. The vacuum 30 draws the filaments against the forming surface 26 to consolidate an unbonded nonwoven web of continuous filaments. If necessary the web may be further compressed by a compression roller 32 and then thermal point bonded by rollers 34 or through air bonder 36.

In an alternative configuration of process line 10 fitted with an air bonder, air having a temperature above the melting temperature of component B and equal to or below the melting temperature of component A is directed from the hood through the web and into the perforated roller. The hot air melts the polymer component B and thereby forms bonds between the bicomponent filaments to integrate the web. When polypropylene and polyethylene are used as polymer components, the air flowing through the through air bonder preferably has a temperature typically ranging from about 230° to about 280° F. and a velocity from about 100 to about 500 feet per minute. The dwell time in the through air bonder is preferably less than about 6 seconds. It should be understood, however, that the parameters of the through air bonder depend on factors such as the type of polymers used and thickness of the web. One of average skill in the art is capable of optimizing these parameters to optimize conditions for particular products.

Lastly the finished web may be wound onto the winding roller 42 or directed to additional in line processing and/or converting steps (not shown) as will be understood by those skilled in the art.

Although the methods of bonding discussed with respect to FIG. 2 are thermal point bonding and through air bonding, it should be understood that the nonwoven fabric of the invention may be bonded by other means such as oven bonding, ultrasonic bonding, hydroentangling, needling, or combinations thereof. Such steps are known, and are not discussed herein in detail.

The invention further provides for an extensible conjugate fiber with specific thermal properties. In an embodiment of the invention, the 2^{nd} heat of melting of the fibers is from 1 to 200 J/g. In another embodiment of the invention, the 2^{nd} heat of melting of the fibers is from 10 to 200 J/g. In another embodiment of the invention, the 2^{nd} heat of melting of the fibers is from 20 to 180 J/g. In another embodiment of the invention, the 2^{nd} heat of melting of the fibers is from 30 to 160 J/g. In another embodiment of the invention, the 2^{nd} heat of melting of the fibers is from 40 to 140 J/g. In another embodiment of the invention, the 2^{nd} heat of melting of the fibers is from 50 to 120 J/g.

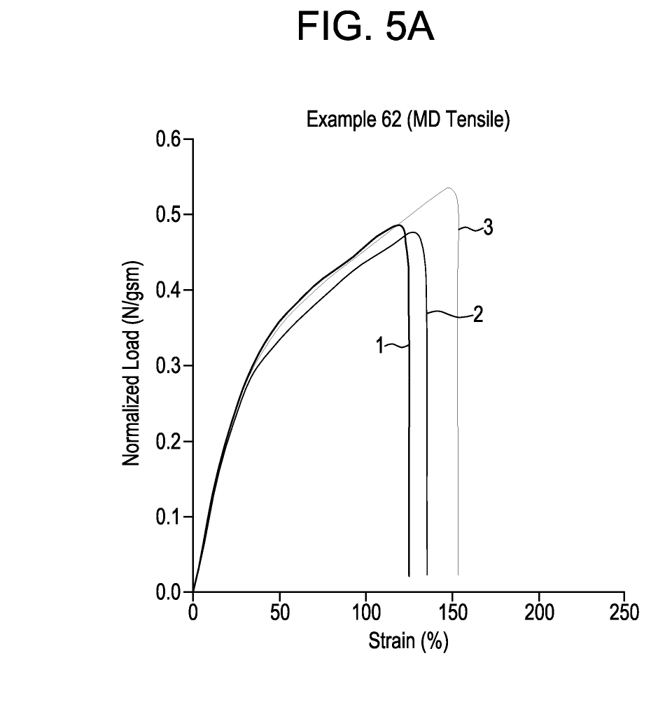

Turning to FIG. 3, there are illustrated in cross-section three forms of conjugate sheath/core fibers. Cross-sections are perpendicular to the fiber axis. FIG. 3a is an eccentric arrangement where core component B is off-center and may actually form a part of the outer fiber surface but is still primarily within the fiber cross-section. FIG. 3b is a standard sheath/core arrangement with the core component wholly within core component A and generally centrally located. FIG. 3c represents an islands-in-the-sea arrangement where there are multiple core components B within component A. Other arrangements will be apparent to those skilled in the art.

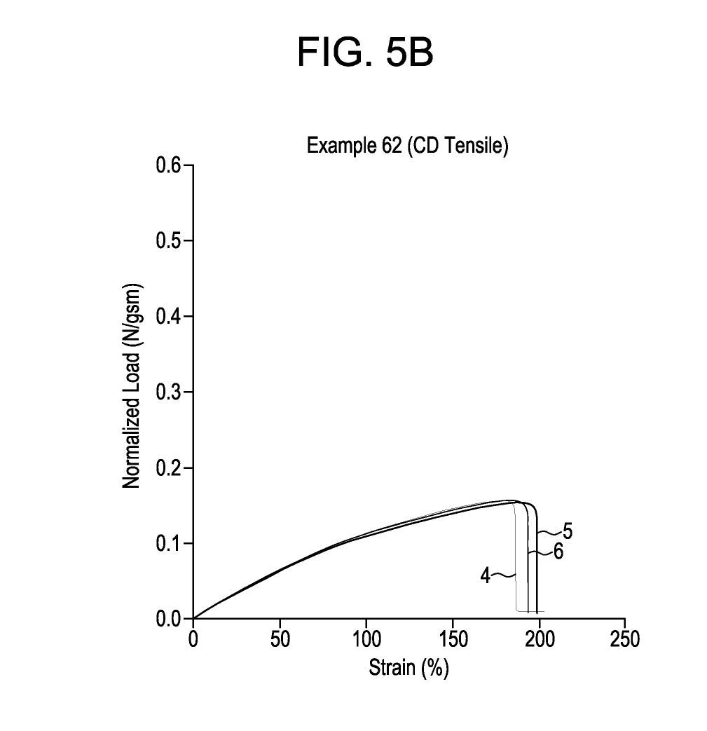

Turning to FIGS. 4a-4c, there are illustrated in schematic perspective several types of sheath arrangements contemplated in accordance with the invention. FIG. 4a illustrates an arrangement where the sheath forms patches on the surface and may result from the use of a sheath component A that is a blend of incompatible polymers as described below. FIG. 4b illustrates a ripple or corrugated sheath forming a series of folds concentrically arranged around the fiber core component B. FIG. 4c illustrates a sheath forming discontinuous fragments along the surface of the fiber. Other arrangements will be apparent to those skilled in the art. Embodiments include those where the conjugate fiber is in a sheath/core configuration, eccentric sheath/core, islands-in-the-sea configuration or other configuration such as hollow or pie segment arrangement. Other arrangements will be apparent to those skilled in the art. Advantageous results are obtained with sheath/core configurations where the sheath is discontinuous or fractured. In some embodiments, component A will constitute 90% or more of the fiber surface. Also, the fiber may be in continuous filament length or staple length form for various applications. Webs may be formed by spunbonding, meltblowing, carding, wetlaying, airlaying or using textile forming steps like knitting and weaving.

Fibers and webs may also be treated by known techniques such as crimping, creping, laminating and coating, printing or impregnating with agents to obtain properties such as repellency, wettability, or absorbency as desired. Fibers, webs, laminates, and articles may also be treated by known stretching techniques such as ring-rolling, selfing, incremental stretching tentering, machine direction orientation. In a specific embodiment, nonwovens (spunbond, melt blown, carded webs) are treated by one of the above listed stretching techniques to impart at least one of the following properties: increased softness, loft, and asymmetric tensile properties, asymmetric elastic properties, and reduced basis weight. In another specific embodiment, this stretching results in a microtextured, corrugated, or crenulated surface on fibers which originates from the differential elastic recovery of the components comprising the fibers. In another specific embodiment, laminates are treated by one of the above listed stretching techniques to impart at least one of the following properties: increased softness, loft, and asymmetric tensile properties, asymmetric elastic properties, and reduced basis weight. In another specific embodiment, stretching of the laminate results in a microtextured, corrugated, or crenulated surface on fibers which originates from the differential elastic recovery of the components comprising the fibers. The invention also includes disposable and other product applications for these elastic fibers and webs.

Different embodiments include sheath/core configurations where the sheath forms ripples, fractures or patches and/or is discontinuous. In one embodiment the sheath may include a blend of phase separated polymers forming patches.

In yet another aspect, the invention relates to a fabric comprising the fibers made in accordance with various embodiments of the invention. The fabrics can be formed by melt extrusion pneumatically drawn processes like spunbond and melt blown. The fabrics can be gel spun, solution spun or other non melt extrusion processes. The fabrics can be extensible or elastic, woven or non-woven or knit. In some embodiments, the fabrics have an RMS Set of 0 to 50%. In another embodiment, the RMS set is 5 to 45%. In another embodiment, the RMS set is 5 to 40%. In another embodiment, the RMS set is 5 to 35%. In another embodiment, the RMS set is 10 to 35%. In another embodiment, the RMS set is 10 to 25%. RMS set is measured using the 80% Hysteresis Test described elsewhere in this document.

In still another aspect, the invention relates to a carded web or yarn comprising the fibers made in accordance with various embodiments of the invention. The fiber used for this process may be staple fiber or continuous filament. The yarn can be covered or not covered. When covered, it may be covered by cotton yarns or nylon yarns.

In yet still another aspect, the invention relates to a method of making the fibers. The method comprises (a) melting an ethylene/α-olefin interpolymer (as described herein); and (b) extruding the ethylene/α-olefin interpolymer into a fiber. The fiber can be formed by melt extrusion pneumatically drawn processes listed above. In a particular aspect, the method comprises the steps of (i) forming a melt of the copolymer, (ii) extruding the melted copolymer through a die, and (iii) subjecting the extruded copolymer to a draw down greater than about 200. The fibers are oriented by subjecting the fiber to tensile elongation during a drawing operation. In one aspect of this embodiment, the tensile elongation is imparted in the quench zone of the drawing operation, i.e., between the spinneret and the godets.

The fibers of this invention can be made from the ethylene/α-olefin copolymers alone, or they can be made from blends of the ethylene/α-olefin copolymers and one or more other polymers, and/or additives and/or nucleators. The fibers can take any form, e.g., monofilament, bicomponent, etc., and they can be used with or without post-formation treatment, e.g., annealing.

The fibers of this invention can be used to manufacture various articles of manufacture, e.g., fabrics (woven, knit or nonwoven), which in turn can be incorporated into multicomponent articles such as diapers, wound dressings, feminine hygiene products and the like.

Certain inventive nonwoven fabrics comprising fibers of this invention are further characterized by substantial RMS elongation at peak force is 4 to 500%. In another embodiment, the RMS elongation at peak force is 10 to 500%. In another embodiment, the RMS elongation at peak force is 25 to 500%. In another embodiment, the RMS elongation at peak force is 50 to 500%. In another embodiment, the RMS elongation at peak force is 75 to 500%. In another embodiment, the RMS elongation at peak force is 100 to 500%.

“Meltblown fibers” are fibers formed by extruding a molten thermoplastic polymer composition through a plurality of fine, usually circular, die capillaries as molten threads or filaments into converging high velocity gas streams (e.g. air) which function to attenuate the threads or filaments to reduced diameters. The filaments or threads are carried by the high velocity gas streams and deposited on a collecting surface to form a web of randomly dispersed fibers with average diameters generally smaller than 10 microns.

“Meltspun fibers” are fibers formed by melting at least one polymer and then drawing the fiber in the melt to a diameter (or other cross-section shape) less than the diameter (or other cross-section shape) of the die.

“Spunbond fibers” are fibers formed by extruding a molten thermoplastic polymer composition as filaments through a plurality of fine, usually circular, die capillaries of a spinneret. The diameter of the extruded filaments is rapidly reduced, and then the filaments are deposited onto a collecting surface to form a web of randomly dispersed fibers with average diameters generally between about 7 and about 30 microns.

“Nonwoven” means a web or fabric having a structure of individual fibers or threads which are randomly interlaid, but not in an identifiable manner as is the case of a knitted fabric. The elastic fiber in accordance with embodiments of the invention can be employed to prepare nonwoven structures as well as composite structures of elastic nonwoven fabric in combination with nonelastic materials.

“Yarn” means a continuous length of twisted or otherwise entangled filaments which can be used in the manufacture of woven or knitted fabrics and other articles. Yarn can be covered or uncovered. Covered yarn is yarn at least partially wrapped within an outer covering of another fiber or material, typically a natural fiber such as cotton or wool.

“Polymer” means a polymeric compound prepared by polymerizing monomers, whether of the same or a different type. The generic term “polymer” embraces the terms “homopolymer,” “copolymer,” “terpolymer” as well as “interpolymer.”

“Interpolymer” means a polymer prepared by the polymerization of at least two different types of monomers. The generic term “interpolymer” includes the term “copolymer” (which is usually employed to refer to a polymer prepared from two different monomers) as well as the term “terpolymer” (which is usually employed to refer to a polymer prepared from three different types of monomers). It also encompasses polymers made by polymerizing four or more types of monomers.

The term “ethylene/α-olefin interpolymer” generally refers to polymers comprising ethylene and an α-olefin having 3 or more carbon atoms. Preferably, ethylene comprises the majority mole fraction of the whole polymer, i.e., ethylene comprises at least about 50 mole percent of the whole polymer. More preferably ethylene comprises at least about 60 mole percent, at least about 70 mole percent, or at least about 80 mole percent, with the substantial remainder of the whole polymer comprising at least one other comonomer that is preferably an α-olefin having 3 or more carbon atoms. For many ethylene/octene copolymers, the preferred composition comprises an ethylene content greater than about 80 mole percent of the whole polymer and an octene content of from about 10 to about 15, preferably from about 15 to about 20 mole percent of the whole polymer. In some embodiments, the ethylene/α-olefin interpolymers do not include those produced in low yields or in a minor amount or as a by-product of a chemical process. While the ethylene/α-olefin interpolymers can be blended with one or more polymers, the as-produced ethylene/α-olefin interpolymers are substantially pure and often comprise a major component of the reaction product of a polymerization process.

The term “α-olefin” in “ethylene/α-olefin interpolymer” or “ethylene/a-olefin/diene interpolymer” herein refers to C₃ and higher α-olefins. In some embodiments, the α-olefin is styrene, propylene, 1-butene, 1-hexene, 1-octene, 4-methyl-1-pentene, 1-decene, or a combination thereof and the diene is norbornene, 1,5-hexadiene, or a combination.

The ethylene/α-olefin interpolymers comprise ethylene and one or more copolymerizable α-olefin comonomers in polymerized form, characterized by multiple blocks or segments of two or more polymerized monomer units differing in chemical or physical properties. That is, the ethylene/α-olefin interpolymers are block interpolymers, preferably multi-block interpolymers or copolymers. The terms “interpolymer” and copolymer” are used interchangeably herein. In some embodiments, the multi-block copolymer can be represented by the following formula:

(AB)ₙ

where n is at least 1, preferably an integer greater than 1, such as 2, 3, 4, 5, 10, 15, 20, 30, 40, 50, 60, 70, 80, 90, 100, or higher, “A” represents a hard block or segment and “B” represents a soft block or segment. Preferably, As and Bs are linked in a substantially linear fashion, as opposed to a substantially branched or substantially star-shaped fashion. In other embodiments, A blocks and B blocks are randomly distributed along the polymer chain. In other words, the block copolymers usually do not have a structure as follows.

AAA-AA-BBB-BB

In still other embodiments, the block copolymers do not usually have a third type of block, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

The multi-block polymers typically comprise various amounts of “hard” and “soft” segments. “Hard” segments refer to blocks of polymerized units in which ethylene is present in an amount greater than about 95 weight percent, and preferably greater than about 98 weight percent based on the weight of the polymer. In other words, the comonomer content (content of monomers other than ethylene) in the hard segments is less than about 5 weight percent, and preferably less than about 2 weight percent based on the weight of the polymer. In some embodiments, the hard segments comprise all or substantially all ethylene. “Soft” segments, on the other hand, refer to blocks of polymerized units in which the comonomer content (content of monomers other than ethylene) is greater than about 5 weight percent, preferably greater than about 8 weight percent, greater than about 10 weight percent, or greater than about 15 weight percent based on the weight of the polymer. In some embodiments, the comonomer content in the soft segments can be greater than about 20 weight percent, greater than about 25 weight percent, greater than about 30 weight percent, greater than about 35 weight percent, greater than about 40 weight percent, greater than about 45 weight percent, greater than about 50 weight percent, or greater than about 60 weight percent.

The soft segments can often be present in a block interpolymer from about 1 weight percent to about 99 weight percent of the total weight of the block interpolymer, preferably from about 5 weight percent to about 95 weight percent, from about 10 weight percent to about 90 weight percent, from about 15 weight percent to about 85 weight percent, from about 20 weight percent to about 80 weight percent, from about 25 weight percent to about 75 weight percent, from about 30 weight percent to about 70 weight percent, from about 35 weight percent to about 65 weight percent, from about 40 weight percent to about 60 weight percent, or from about 45 weight percent to about 55 weight percent of the total weight of the block interpolymer. Conversely, the hard segments can be present in similar ranges. The soft segment weight percentage and the hard segment weight percentage can be calculated based on data obtained from DSC or NMR. Such methods and calculations are disclosed in filed U.S. patent application Ser. No. 11/376,835, Attorney Docket No. 385063-999558, entitled “Ethylene/α-Olefin Block Interpolymers”, filed on Mar. 15, 2006, in the name of Colin L. P. Shan, Lonnie Hazlitt, et. al. and assigned to Dow Global Technologies Inc., the disclosure of which is incorporated by reference herein in its entirety.

The term “crystalline” if employed, refers to a polymer that possesses a first order transition or crystalline melting point (Tm) as determined by differential scanning calorimetry (DSC) or equivalent technique. The term may be used interchangeably with the term “semicrystalline”. The term “amorphous” refers to a polymer lacking a crystalline melting point as determined by differential scanning calorimetry (DSC) or equivalent technique.

The term “multi-block copolymer” or “segmented copolymer” refers to a polymer comprising two or more chemically distinct regions or segments (referred to as “blocks”) preferably joined in a linear manner, that is, a polymer comprising chemically differentiated units which are joined end-to-end with respect to polymerized ethylenic functionality, rather than in pendent or grafted fashion. In a preferred embodiment, the blocks differ in the amount or type of comonomer incorporated therein, the density, the amount of crystallinity, the crystallite size attributable to a polymer of such composition, the type or degree of tacticity (isotactic or syndiotactic), regio-regularity or regio-irregularity, the amount of branching, including long chain branching or hyper-branching, the homogeneity, or any other chemical or physical property. The multi-block copolymers are characterized by unique distributions of both polydispersity index (PDI or Mw/Mn), block length distribution, and/or block number distribution due to the unique process making of the copolymers. More specifically, when produced in a continuous process, the polymers desirably possess PDI from 1.7 to 2.9, preferably from 1.8 to 2.5, more preferably from 1.8 to 2.2, and most preferably from 1.8 to 2.1. When produced in a batch or semi-batch process, the polymers possess PDI from 1.0 to 2.9, preferably from 1.3 to 2.5, more preferably from 1.4 to 2.0, and most preferably from 1.4 to 1.8.

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L} and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. When a particular reference is mentioned (e.g., a patent or journal article), it should be understood that such reference is incorporated by reference herein in its entirety, regardless of whether such wording is used in connection with it.

Embodiments of the invention provide fibers obtainable from or comprising a new ethylene/α-olefin interpolymer with unique properties and fabrics and other products made from such fibers. The fibers may have good abrasion resistance; low coefficient of friction; high upper service temperature; high recovery/retractive force; low stress relaxation (high and low temperatures); soft stretch; high elongation at break; inert: chemical resistance; and/or UV resistance. The fibers can be melt spun at a relatively high spin rate and lower temperature. In addition, the fibers are less sticky, resulting in better unwind performance and better shelf life, and the fabrics made from the fibers are substantially free of roping (i.e., fiber bundling, self-adhesion, self-sticking). Because the fibers can be spun at a higher spin rate, the fibers' production throughput is high. Such fibers also have broad formation windows and broad processing windows.

In a particular embodiment, the fiber is drawn below the peak melting temperature of at least one of the polymers comprising the fiber. In a particular embodiment, the fiber is drawn below the peak melting temperature of the ethylene/α-olefin copolymer comprising the fiber. In a further embodiment, the fiber is drawn pneumatically using air, which has a temperature below the peak melting temperature of at least one of the polymers comprising the fiber, at the point which it impinges the fiber. In a further embodiment, the fiber is drawn pneumatically using air, which has a temperature below the peak melting temperature of the ethylene/α-olefin copolymer comprising the fiber, at the point which it impinges the fiber.

### Ethylene/α-Olefin Interpolymers

The ethylene/α-olefin interpolymers used in embodiments of the invention (also referred to as “inventive interpolymer” or “inventive polymer”) comprise ethylene and one or more copolymerizable α-olefin comonomers in polymerized form, characterized by multiple blocks or segments of two or more polymerized monomer units differing in chemical or physical properties (block interpolymer), preferably a multi-block copolymer. The ethylene/α-olefin interpolymers are characterized by one or more of the aspects described as follows.

In one aspect, the ethylene/α-olefin interpolymers used in the bicomponent fibers provided herein have a M_{w}/Mₙ from about 1.7 to about 3.5 and at least one melting point, Tₘ, in degrees Celsius and density, d, in grams/cubic centimeter, wherein the numerical values of the variables correspond to the relationship:

Tₘ>−6553.3+13735(d)−7051.7(d)², and preferably

Tₘ≧−6880.9+14422(d)−7404.3(d)², and more preferably

Tₘ≧−7208.6−15109(d)−7756.9(d)².

Unlike the traditional random copolymers of ethylene/α-olefins whose melting points decrease with decreasing densities, fibers made from the inventive interpolymers have melting points substantially independent of the density, particularly when density is between about 0.87 g/cc to about 0.95 g/cc. For example, the melting point of such polymers are in the range of about 110° C. to about 130° C. when density ranges from 0.875 g/cc to about 0.945 g/cc. In some embodiments, the melting point of such polymers are in the range of about 115° C. to about 125° C. when density ranges from 0.875 g/cc to about 0.945 g/cc.

In another aspect, the ethylene/α-olefin interpolymers comprise, in polymerized form, ethylene and one or more α-olefins and are characterized by a ΔT, in degree Celsius, defined as the temperature for the tallest Differential Scanning Calorimetry (“DSC”) peak minus the temperature for the tallest Crystallization Analysis Fractionation (“CRYSTAF”) peak and a heat of fusion in J/g, ΔH, and ΔT and ΔH satisfy the following relationships:

ΔT>−0.1299(ΔH)+62.81, and preferably

ΔT≧−0.1299(ΔH)+64.38, and more preferably

ΔT≧−0.1299(ΔH)+65.95,

for ΔH up to 130 J/g. Moreover, ΔT is equal to or greater than 48° C. for ΔH greater than 130 J/g. The CRYSTAF peak is determined using at least 5 percent of the cumulative polymer (that is, the peak must represent at least 5 percent of the cumulative polymer), and if less than 5 percent of the polymer has an identifiable CRYSTAF peak, then the CRYSTAF temperature is 30° C., and ΔH is the numerical value of the heat of fusion in J/g. More preferably, the highest CRYSTAF peak contains at least 10 percent of the cumulative polymer.

In yet another aspect, the ethylene/α-olefin interpolymers have a molecular fraction which elutes between 40° C. and 130° C. when fractionated using Temperature Rising Elution Fractionation (“TREF”), characterized in that said fraction has a molar comonomer content higher, preferably at least 5 percent higher, more preferably at least 10 percent higher, than that of a comparable random ethylene interpolymer fraction eluting between the same temperatures, wherein the comparable random ethylene interpolymer contains the same comonomer(s), and has a melt index, density, and molar comonomer content (based on the whole polymer) within 10 percent of that of the block interpolymer. Preferably, the Mw/Mn of the comparable interpolymer is also within 10 percent of that of the block interpolymer and/or the comparable interpolymer has a total comonomer content within 10 weight percent of that of the block interpolymer.

In still another aspect, the ethylene/α-olefin interpolymers are characterized by an elastic recovery, Re, in percent at 300 percent strain and 1 cycle measured on a compression-molded film of an ethylene/α-olefin interpolymer, and has a density, d, in grams/cubic centimeter, wherein the numerical values of Re and d satisfy the following relationship when ethylene/α-olefin interpolymer is substantially free of a cross-linked phase:

Re>1481−1629(d); and preferably

Re≧1491−1629(d); and more preferably

Re≧1501−1629(d); and even more preferably

Re≧1511−1629(d).

In some embodiments, the ethylene/α-olefin interpolymers have a tensile strength above 10 MPa, preferably a tensile strength ≧11 MPa, more preferably a tensile strength ≧13 MPa and/or an elongation at break of at least 600 percent, more preferably at least 700 percent, highly preferably at least 800 percent, and most highly preferably at least 900 percent at a crosshead separation rate of 11 cm/minute.

In other embodiments, the ethylene/α-olefin interpolymers have (1) a storage modulus ratio, G′(25° C.)/G′(100° C.), of from 1 to 50, preferably from 1 to 20, more preferably from 1 to 10; and/or (2) a 70° C. compression set of less than 80 percent, preferably less than 70 percent, especially less than 60 percent, less than 50 percent, or less than 40 percent, down to a compression set of 0 percent.

In still other embodiments, the ethylene/α-olefin interpolymers have a 70° C. compression set of less than 80 percent, less than 70 percent, less than 60 percent, or less than 50 percent. Preferably, the 70° C. compression set of the interpolymers is less than 40 percent, less than 30 percent, less than 20 percent, and may go down to about 0 percent.

In some embodiments, the ethylene/α-olefin interpolymers have a heat of fusion of less than 85 J/g and/or a pellet blocking strength of equal to or less than 100 pounds/foot² (4800 Pa), preferably equal to or less than 50 lbs/ft² (2400 Pa), especially equal to or less than 5 lbs/ft² (240 Pa), and as low as 0 lbs/ft² (0 Pa).

In other embodiments, the ethylene/α-olefin interpolymers comprise, in polymerized form, at least 50 mole percent ethylene and have a 70° C. compression set of less than 80 percent, preferably less than 70 percent or less than 60 percent, most preferably less than 40 to 50 percent and down to close zero percent.

In some embodiments, the multi-block copolymers possess a PDI fitting a Schultz-Flory distribution rather than a Poisson distribution. The copolymers are further characterized as having both a polydisperse block distribution and a polydisperse distribution of block sizes and possessing a most probable distribution of block lengths. Preferred multi-block copolymers are those containing 4 or more blocks or segments including terminal blocks. More preferably, the copolymers include at least 5, 10 or 20 blocks or segments including terminal blocks.

Comonomer content may be measured using any suitable technique, with techniques based on nuclear magnetic resonance (“NMR”) spectroscopy preferred. Moreover, for polymers or blends of polymers having relatively broad TREF curves, the polymer desirably is first fractionated using TREF into fractions each having an eluted temperature range of 10° C. or less. That is, each eluted fraction has a collection temperature window of 10° C. or less. Using this technique, said block interpolymers have at least one such fraction having a higher molar comonomer content than a corresponding fraction of the comparable interpolymer.

Preferably, for interpolymers of ethylene and 1-octene, the block interpolymer has a comonomer content of the TREF fraction eluting between 40 and 130° C. greater than or equal to the quantity (−0.2013) T+20.07, more preferably greater than or equal to the quantity (−0.2013) T+21.07, where T is the numerical value of the peak elution temperature of the TREF fraction being compared, measured in ° C.

In addition to the above aspects and properties described herein, the inventive polymers can be characterized by one or more additional characteristics. In one aspect, the inventive polymer is an olefin interpolymer, preferably comprising ethylene and one or more copolymerizable comonomers in polymerized form, characterized by multiple blocks or segments of two or more polymerized monomer units differing in chemical or physical properties (blocked interpolymer), most preferably a multi-block copolymer, said block interpolymer having a molecular fraction which elutes between 40° C. and 130° C., when fractionated using TREF increments, characterized in that said fraction has a molar comonomer content higher, preferably at least 5 percent higher, more preferably at least 10, 15, 20 or 25 percent higher, than that of a comparable random ethylene interpolymer fraction eluting between the same temperatures, wherein said comparable random ethylene interpolymer comprises the same comonomer(s), preferably it is the same comonomer(s), and a melt index, density, and molar comonomer content (based on the whole polymer) within 10 percent of that of the blocked interpolymer. Preferably, the Mw/Mn of the comparable interpolymer is also within 10 percent of that of the blocked interpolymer and/or the comparable interpolymer has a total comonomer content within 10 weight percent of that of the blocked interpolymer.

Preferably, the above interpolymers are interpolymers of ethylene and at least one alpha-olefin, especially those interpolymers having a whole polymer density from about 0.855 to about 0.935 g/cm³, and more especially for polymers having more than about 1 mole percent comonomer, the blocked interpolymer has a comonomer content of the TREF fraction eluting between 40 and 130° C. greater than or equal to the quantity (−0.1356) T+13.89, more preferably greater than or equal to the quantity (−0.1356) T+14.93, and most preferably greater than or equal to the quantity (−0.2013)T+21.07, where T is the numerical value of the peak ATREF elution temperature of the TREF fraction being compared, measured in ° C.

Preferably, for the above interpolymers of ethylene and at least one alpha-olefin especially those interpolymers having a whole polymer density from about 0.855 to about 0.935 g/cm³, and more especially for polymers having more than about 1 mole percent comonomer, the blocked interpolymer has a comonomer content of the TREF fraction eluting between 40 and 130° C. greater than or equal to the quantity (−0.2013) T+20.07, more preferably greater than or equal to the quantity (−0.2013) T+21.07, where T is the numerical value of the peak elution temperature of the TREF fraction being compared, measured in ° C.

In still another aspect, the inventive polymer is an olefin interpolymer, preferably comprising ethylene and one or more copolymerizable comonomers in polymerized form, characterized by multiple blocks or segments of two or more polymerized monomer units differing in chemical or physical properties (blocked interpolymer), most preferably a multi-block copolymer, said block interpolymer having a molecular fraction which elutes between 40° C. and 130° C., when fractionated using TREF increments, characterized in that every fraction having a comonomer content of at least about 6 mole percent, has a melting point greater than about 100° C. For those fractions having a comonomer content from about 3 mole percent to about 6 mole percent, every fraction has a DSC melting point of about 110° C. or higher. More preferably, said polymer fractions, having at least 1 mol percent comonomer, has a DSC melting point that corresponds to the equation:

Tm≧(−5.5926)(mol percent comonomer in the fraction)+135.90.

In yet another aspect, the inventive polymer is an olefin interpolymer, preferably comprising ethylene and one or more copolymerizable comonomers in polymerized form, characterized by multiple blocks or segments of two or more polymerized monomer units differing in chemical or physical properties (blocked interpolymer), most preferably a multi-block copolymer, said block interpolymer having a molecular fraction which elutes between 40° C. and 130° C., when fractionated using TREF increments, characterized in that every fraction that has an ATREF elution temperature greater than or equal to about 76° C., has a melt enthalpy (heat of fusion) as measured by DSC, corresponding to the equation:

Heat of fusion (J/gm)≦(3.1718)(ATREF elution temperature in Celsius)−136.58,

The inventive block interpolymers have a molecular fraction which elutes between 40° C. and 130° C., when fractionated using TREF increments, characterized in that every fraction that has an ATREF elution temperature between 40° C. and less than about 76° C., has a melt enthalpy (heat of fusion) as measured by DSC, corresponding to the equation:

Heat of fusion (J/gm)≦(1.1312)(ATREF elution temperature in Celsius)+22.97.

### ATREF Peak Comonomer Composition Measurement by Infra-Red Detector

The comonomer composition of the TREF peak can be measured using an IR4 infra-red detector available from Polymer Char, Valencia, Spain (http://www.polymerchar.com/).

The “composition mode” of the detector is equipped with a measurement sensor (CH₂) and composition sensor (CH₃) that are fixed narrow band infra-red filters in the region of 2800-3000 cm⁻¹. The measurement sensor detects the methylene (CH₂) carbons on the polymer (which directly relates to the polymer concentration in solution) while the composition sensor detects the methyl (CH₃) groups of the polymer. The mathematical ratio of the composition signal (CH₃) divided by the measurement signal (CH₂) is sensitive to the comonomer content of the measured polymer in solution and its response is calibrated with known ethylene alpha-olefin copolymer standards.

The detector when used with an ATREF instrument provides both a concentration (CH₂) and composition (CH₃) signal response of the eluted polymer during the TREF process. A polymer specific calibration can be created by measuring the area ratio of the CH₃ to CH₂ for polymers with known comonomer content (preferably measured by NMR). The comonomer content of an ATREF peak of a polymer can be estimated by applying a the reference calibration of the ratio of the areas for the individual CH₃ and CH₂ response (i.e. area ratio CH₃/CH₂ versus comonomer content).

The area of the peaks can be calculated using a full width/half maximum (FWHM) calculation after applying the appropriate baselines to integrate the individual signal responses from the TREF chromatogram. The full width/half maximum calculation is based on the ratio of methyl to methylene response area [CH₃/CH₂] from the ATREF infra-red detector, wherein the tallest (highest) peak is identified from the base line, and then the FWHM area is determined. For a distribution measured using an ATREF peak, the FWHM area is defined as the area under the curve between T1 and T2, where T1 and T2 are points determined, to the left and right of the ATREF peak, by dividing the peak height by two, and then drawing a line horizontal to the base line, that intersects the left and right portions of the ATREF curve.

The application of infra-red spectroscopy to measure the comonomer content of polymers in this ATREF-infra-red method is, in principle, similar to that of GPC/FTIR systems as described in the following references: Markovich, Ronald P.; Hazlitt, Lonnie G.; Smith, Linley; “Development of gel-permeation chromatography-Fourier transform infrared spectroscopy for characterization of ethylene-based polyolefin copolymers”. Polymeric Materials Science and Engineering (1991), 65, 98-100; and Deslauriers, P. J.; Rohlfing, D. C.; Shieh, E. T.; “Quantifying short chain branching microstructures in ethylene-1-olefin copolymers using size exclusion chromatography and Fourier transform infrared spectroscopy (SEC-FTIR)”, Polymer (2002), 43, 59-170, both of which are incorporated by reference herein in their entirety.

In other embodiments, the inventive ethylene/α-olefin interpolymer is characterized by an average block index, ABI, which is greater than zero and up to about 1.0 and a molecular weight distribution, M_{w}/Mₙ, greater than about 1.3. The average block index, ABI, is the weight average of the block index (“BI”) for each of the polymer fractions obtained in preparative TREF from 20° C. and 110° C., with an increment of 5° C.:

ABI=Σ(wᵢBIᵢ)

where BIᵢ is the block index for the ith fraction of the inventive ethylene/α-olefin interpolymer obtained in preparative TREF, and wᵢ is the weight percentage of the ith fraction.

For each polymer fraction, BI is defined by one of the two following equations (both of which give the same BI value):

$$BI = \frac{1 / {T}_{X} - 1 / {T}_{XO}}{1 / {T}_{A} - 1 / {T}_{AB}} or BI = - \frac{Ln {P}_{X} - Ln {P}_{XO}}{Ln {P}_{A} - Ln {P}_{AB}}$$

where T_{X} is the preparative ATREF elution temperature for the ith fraction (preferably expressed in Kelvin), P_{X} is the ethylene mole fraction for the ith fraction, which can be measured by NMR or IR as described above. P_{AB} is the ethylene mole fraction of the whole ethylene/α-olefin interpolymer (before fractionation), which also can be measured by NMR or IR. T_{A} and P_{A} are the ATREF elution temperature and the ethylene mole fraction for pure “hard segments” (which refer to the crystalline segments of the interpolymer). As a first order approximation, the T_{A} and P_{A} values are set to those for high density polyethylene homopolymer, if the actual values for the “hard segments” are not available. For calculations performed herein, T_{A} is 372° K, P_{A} is 1.

T_{AB} is the ATREF temperature for a random copolymer of the same composition and having an ethylene mole fraction of P_{AB} T_{AB} can be calculated from the following equation:

LnP_{AB}=α/T_{AB}+β

where β and β are two constants which can be determined by calibration using a number of known random ethylene copolymers. It should be noted that α and β may vary from instrument to instrument. Moreover, one would need to create their own calibration curve with the polymer composition of interest and also in a similar molecular weight range as the fractions. There is a slight molecular weight effect. If the calibration curve is obtained from similar molecular weight ranges, such effect would be essentially negligible. In some embodiments, random ethylene copolymers satisfy the following relationship:

LnP=−237.83/T_{ATREF}+0.639

T_{XO} is the ATREF temperature for a random copolymer of the same composition and having an ethylene mole fraction of P_{X}. T_{XO} can be calculated from LnP_{X}=α/T_{XO}+β. Conversely, P_{XO} is the ethylene mole fraction for a random copolymer of the same composition and having an ATREF temperature of T_{X}, which can be calculated from Ln P_{XO}=α/T_{X}+β.

Once the block index (BI) for each preparative TREF fraction is obtained, the weight average block index, ABI, for the whole polymer can be calculated. In some embodiments, ABI is greater than zero but less than about 0.3 or from about 0.1 to about 0.3. In other embodiments, ABI is greater than about 0.3 and up to about 1.0. Preferably, ABI should be in the range of from about 0.4 to about 0.7, from about 0.5 to about 0.7, or from about 0.6 to about 0.9. In some embodiments, ABI is in the range of from about 0.3 to about 0.9, from about 0.3 to about 0.8, or from about 0.3 to about 0.7, from about 0.3 to about 0.6, from about 0.3 to about 0.5, or from about 0.3 to about 0.4. In other embodiments, ABI is in the range of from about 0.4 to about 1.0, from about 0.5 to about 1.0, or from about 0.6 to about 1.0, from about 0.7 to about 1.0, from about 0.8 to about 1.0, or from about 0.9 to about 1.0.

Another characteristic of the inventive ethylene/α-olefin interpolymer is that the inventive ethylene/α-olefin interpolymer comprises at least one polymer fraction which can be obtained by preparative TREF, wherein the fraction has a block index greater than about 0.1 and up to about 1.0 and a molecular weight distribution, M_{w}/Mₙ, greater than about 1.3. In some embodiments, the polymer fraction has a block index greater than about 0.6 and up to about 1.0, greater than about 0.7 and up to about 1.0, greater than about 0.8 and up to about 1.0, or greater than about 0.9 and up to about 1.0. In other embodiments, the polymer fraction has a block index greater than about 0.1 and up to about 1.0, greater than about 0.2 and up to about 1.0, greater than about 0.3 and up to about 1.0, greater than about 0.4 and up to about 1.0, or greater than about 0.4 and up to about 1.0. In still other embodiments, the polymer fraction has a block index greater than about 0.1 and up to about 0.5, greater than about 0.2 and up to about 0.5, greater than about 0.3 and up to about 0.5, or greater than about 0.4 and up to about 0.5. In yet other embodiments, the polymer fraction has a block index greater than about 0.2 and up to about 0.9, greater than about 0.3 and up to about 0.8, greater than about 0.4 and up to about 0.7, or greater than about 0.5 and up to about 0.6.

For copolymers of ethylene and an α-olefin, the inventive polymers preferably possess (1) a PDI of at least 1.3, more preferably at least 1.5, at least 1.7, or at least 2.0, and most preferably at least 2.6, up to a maximum value of 5.0, more preferably up to a maximum of 3.5, and especially up to a maximum of 2.7; (2) a heat of fusion of 80 J/g or less; (3) an ethylene content of at least 50 weight percent; (4) a glass transition temperature, T_{g}, of less than −25° C., more preferably less than −30° C., and/or (5) one and only one Tₘ.

Further, the inventive polymers can have, alone or in combination with any other properties disclosed herein, a storage modulus, G′, such that log(G′) is greater than or equal to 400 kPa, preferably greater than or equal to 1.0 MPa, at a temperature of 100° C. Moreover, the inventive polymers possess a relatively flat storage modulus as a function of temperature in the range from 0 to 100° C. that is characteristic of block copolymers, and heretofore unknown for an olefin copolymer, especially a copolymer of ethylene and one or more C₃₋₈ aliphatic α-olefins. (By the term “relatively flat” in this context is meant that log G′ (in Pascals) decreases by less than one order of magnitude between 50 and 100° C., preferably between 0 and 100° C.).

The inventive interpolymers may be further characterized by a thermomechanical analysis penetration depth of 1 mm at a temperature of at least 90° C. as well as a flexural modulus of from 3 kpsi (20 MPa) to 13 kpsi (90 MPa). Alternatively, the inventive interpolymers can have a thermomechanical analysis penetration depth of 1 mm at a temperature of at least 104° C. as well as a flexural modulus of at least 3 kpsi (20 MPa). They may be characterized as having an abrasion resistance (or volume loss) of less than 90 mm³.

Additionally, the ethylene/α-olefin interpolymers can have a melt index, I₂, from 0.01 to 2000 g/10 minutes, preferably from 0.01 to 1000 g/10 minutes, more preferably from 0.01 to 500 g/10 minutes, and especially from 0.01 to 100 g/10 minutes. In certain embodiments, the ethylene/α-olefin interpolymers have a melt index, I₂, from 0.01 to 10 g/10 minutes, from 0.5 to 50 g/10 minutes, from 1 to 30 g/10 minutes, from 1 to 6 g/10 minutes or from 0.3 to 10 g/10 minutes. In certain embodiments, the melt index for the ethylene/α-olefin polymers is 1 g/10 minutes, 3 g/10 minutes or 5 g/10 minutes.

The polymers can have molecular weights, M_{w} from 1,000 g/mole to 5,000,000 g/mole, preferably from 1000 g/mole to 1,000,000, more preferably from 10,000 g/mole to 500,000 g/mole, and especially from 10,000 g/mole to 300,000 g/mole. The density of the inventive polymers can be from 0.80 to 0.99 g/cm³ and preferably for ethylene containing polymers from 0.85 g/cm³ to 0.97 g/cm³. In certain embodiments, the density of the ethylene/α-olefin polymers ranges from 0.860 to 0.925 g/cm³ or 0.867 to 0.910 g/cm³.

The process of making the polymers has been disclosed in the following patent applications: U.S. Provisional Application No. 60/553,906, filed Mar. 17, 2004; U.S. Provisional Application No. 60/662,937, filed Mar. 17, 2005; U.S. Provisional Application No. 60/662,939, filed Mar. 17, 2005; U.S. Provisional Application No. 60/566,2938, filed Mar. 17, 2005; PCT Application No. PCT/US2005/008916, filed Mar. 17, 2005; PCT Application No. PCT/US2005/008915, filed Mar. 17, 2005; and PCT Application No. PCT/US2005/008917, filed Mar. 17, 2005, all of which are incorporated by reference herein in their entirety. For example, one such method contains contacting ethylene and optionally one or more addition polymerizable monomers other than ethylene under addition polymerization conditions with a catalyst composition containing:

the admixture or reaction product resulting from combining:
(a) a first olefin polymerization catalyst having a high comonomer incorporation index,
(b) a second olefin polymerization catalyst having a comonomer incorporation index less than 90 percent, preferably less than 50 percent, most preferably less than 5 percent of the comonomer incorporation index of catalyst (A), and
(c) a chain shuttling agent.

Representative catalysts and chain shuttling agent are as follows.

Catalyst (A1) is [N-(2,6-di(1-methylethyl)phenyl)amido)(2-isopropylphenyl)(α-naphthalen-2-diyl(6-pyridin-2-diyl)methane)]hafnium dimethyl, prepared according to the teachings of WO 03/40195, 2003US0204017, U.S. Ser. No. 10/429,024, filed May 2, 2003, and WO 04/24740.

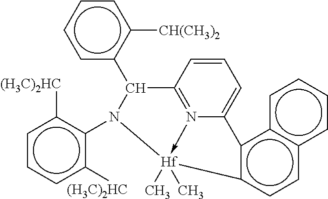

Catalyst (A2) is [N-(2,6-di(1-methylethyl)phenyl)amido)(2-methylphenyl)(1,2-phenylene-(6-pyridin-2-diyl)methane)]hafnium dimethyl, prepared according to the teachings of WO 03/40195, 2003US0204017, U.S. Ser. No. 10/429,024, filed May 2, 2003, and WO 04/24740.

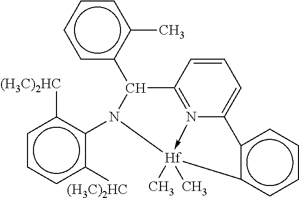

Catalyst (A3) is bis[N,N′″-(2,4,6-tri(methylphenyl)amido)ethylenediamine]hafnium dibenzyl.

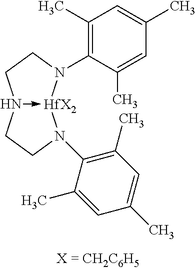

Catalyst (A4) is bis((2-oxoyl-3-(dibenzo-1H-pyrrole-1-yl)-5-(methyl)phenyl)-2-phenoxymethyl)cyclohexane-1,2-diyl zirconium (IV) dibenzyl, prepared substantially according to the teachings of US-A-2004/0010103.

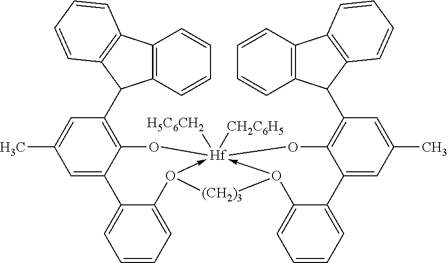

Catalyst (B1) is 1,2-bis-(3,5-di-t-butylphenylene)(1-(N-(1-methylethyl)immino)methyl)(2-oxoyl)zirconium dibenzyl

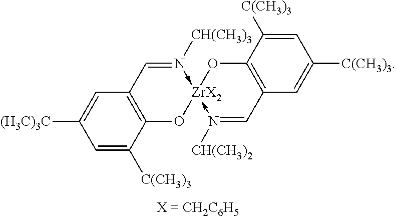

Catalyst (B2) is 1,2-bis-(3,5-di-t-butylphenylene)(1-(N-(2-methylcyclohexyl)-immino)methyl)(2-oxoyl)zirconium dibenzyl

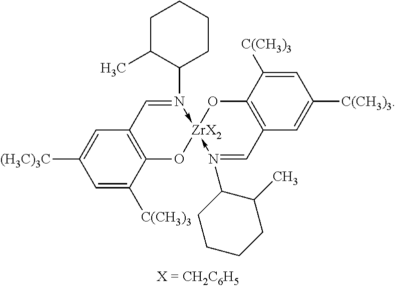

Catalyst (C1) is (t-butylamido)dimethyl(3-N-pyrrolyl-1,2,3,3a,7a-η-inden-1-yl)silanetitanium dimethyl prepared substantially according to the techniques of U.S. Pat. No. 6,268,444:

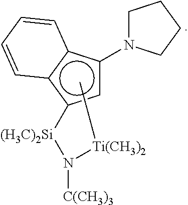

Catalyst (C2) is (t-butylamido)di(4-methylphenyl)(2-methyl-1,2,3,3a,7a-η-inden-1-yl)silanetitanium dimethyl prepared substantially according to the teachings of US-A-2003/004286:

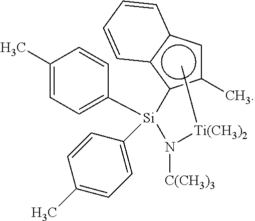

Catalyst (C3) is (t-butylamido)di(4-methylphenyl)(2-methyl-1,2,3,3a,8a-η-s-indacen-1-yl)silanetitanium dimethyl prepared substantially according to the teachings of US-A-2003/004286:

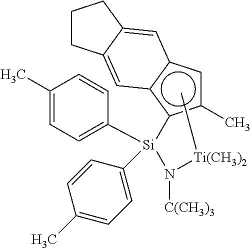

Catalyst (D1) is bis(dimethyldisiloxane)(indene-1-yl)zirconium dichloride available from Sigma-Aldrich:

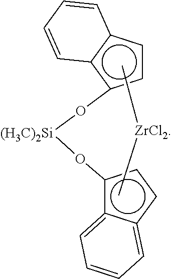

Shuttling Agents The shuttling agents employed include diethylzinc, di(i-butyl)zinc, di(n-hexyl)zinc, triethylaluminum, trioctylaluminum, triethylgallium, i-butylaluminum bis(dimethyl(t-butyl)siloxane), i-butylaluminum bis(di(trimethylsilyl)amide), n-octylaluminum di(pyridine-2-methoxide), bis(n-octadecyl)i-butylaluminum, i-butylaluminum bis(di(n-pentyl)amide), n-octylaluminum bis(2,6-di-t-butylphenoxide, n-octylaluminum di(ethyl(1-naphthyl)amide), ethylaluminum bis(t-butyldimethylsiloxide), ethylaluminum di(bis(trimethylsilyl)amide), ethylaluminum bis(2,3,6,7-dibenzo-1-azacycloheptaneamide), n-octylaluminum bis(2,3,6,7-dibenzo-1-azacycloheptaneamide), n-octylaluminum bis(dimethyl(t-butyl)siloxide, ethylzinc (2,6-diphenylphenoxide), and ethylzinc (t-butoxide).

Preferably, the foregoing process takes the form of a continuous solution process for forming block copolymers, especially multi-block copolymers, preferably linear multi-block copolymers of two or more monomers, more especially ethylene and a C₃₋₂₀ α-olefin or cycloolefin, and most especially ethylene and a C₄₋₂₀ α-olefin, using multiple catalysts that are incapable of interconversion. That is, the catalysts are chemically distinct. Under continuous solution polymerization conditions, the process is ideally suited for polymerization of mixtures of monomers at high monomer conversions. Under these polymerization conditions, shuttling from the chain shuttling agent to the catalyst becomes advantaged compared to chain growth, and multi-block copolymers, especially linear multi-block copolymers are formed in high efficiency.

The inventive interpolymers may be differentiated from conventional, random copolymers, physical blends of polymers, and block copolymers prepared via sequential monomer addition, fluxional catalysts, anionic or cationic living polymerization techniques. In particular, compared to a random copolymer of the same monomers and monomer content at equivalent crystallinity or modulus, the inventive interpolymers have better (higher) heat resistance as measured by melting point, higher TMA penetration temperature, higher high-temperature tensile strength, and/or higher high-temperature torsion storage modulus as determined by dynamic mechanical analysis. Compared to a random copolymer containing the same monomers and monomer content, the inventive interpolymers have lower compression set, particularly at elevated temperatures, lower stress relaxation, higher creep resistance, higher tear strength, higher blocking resistance, faster setup due to higher crystallization (solidification) temperature, higher recovery (particularly at elevated temperatures), better abrasion resistance, higher retractive force, and better oil and filler acceptance.

The inventive interpolymers also exhibit a unique crystallization and branching distribution relationship. That is, the inventive interpolymers have a relatively large difference between the tallest peak temperature measured using CRYSTAF and DSC as a function of heat of fusion, especially as compared to random copolymers containing the same monomers and monomer level or physical blends of polymers, such as a blend of a high density polymer and a lower density copolymer, at equivalent overall density. It is believed that this unique feature of the inventive interpolymers is due to the unique distribution of the comonomer in blocks within the polymer backbone. In particular, the inventive interpolymers may contain alternating blocks of differing comonomer content (including homopolymer blocks). The inventive interpolymers may also contain a distribution in number and/or block size of polymer blocks of differing density or comonomer content, which is a Schultz-Flory type of distribution. In addition, the inventive interpolymers also have a unique peak melting point and crystallization temperature profile that is substantially independent of polymer density, modulus, and morphology. In a preferred embodiment, the microcrystalline order of the polymers demonstrates characteristic spherulites and lamellae that are distinguishable from random or block copolymers, even at PDI values that are less than 1.7, or even less than 1.5, down to less than 1.3.

Moreover, the inventive interpolymers may be prepared using techniques to influence the degree or level of blockiness (i.e., the magnitude of the block index for a particular fraction or for the entire polymer). That is the amount of comonomer and length of each polymer block or segment can be altered by controlling the ratio and type of catalysts and shuttling agent as well as the temperature of the polymerization, and other polymerization variables. A surprising benefit of this phenomenon is the discovery that as the degree of blockiness is increased, the optical properties, tear strength, and high temperature recovery properties of the resulting polymer are improved. In particular, haze decreases while clarity, tear strength, and high temperature recovery properties increase as the average number of blocks in the polymer increases. By selecting shuttling agents and catalyst combinations having the desired chain transferring ability (high rates of shuttling with low levels of chain termination) other forms of polymer termination are effectively suppressed. Accordingly, little if any β-hydride elimination is observed in the polymerization of ethylene/α-olefin comonomer mixtures according to embodiments of the invention, and the resulting crystalline blocks are highly, or substantially completely, linear, possessing little or no long chain branching.

Polymers with highly crystalline chain ends can be selectively prepared in accordance with embodiments of the invention. In elastomer applications, reducing the relative quantity of polymer that terminates with an amorphous block reduces the intermolecular dilutive effect on crystalline regions. This result can be obtained by choosing chain shuttling agents and catalysts having an appropriate response to hydrogen or other chain terminating agents. Specifically, if the catalyst which produces highly crystalline polymer is more susceptible to chain termination (such as by use of hydrogen) than the catalyst responsible for producing the less crystalline polymer segment (such as through higher comonomer incorporation, regio-error, or atactic polymer formation), then the highly crystalline polymer segments will preferentially populate the terminal portions of the polymer. Not only are the resulting terminated groups crystalline, but upon termination, the highly crystalline polymer forming catalyst site is once again available for reinitiation of polymer formation. The initially formed polymer is therefore another highly crystalline polymer segment. Accordingly, both ends of the resulting multi-block copolymer are preferentially highly crystalline.

The ethylene α-olefin interpolymers used in the embodiments of the invention are preferably interpolymers of ethylene with at least one C₃-C₂₀ α-olefin.

Copolymers of ethylene and a C₃-C₂₀ α-olefin are especially preferred. The interpolymers may further comprise C₄-C₁₈ diolefin and/or alkenylbenzene. Suitable unsaturated comonomers useful for polymerizing with ethylene include, for example, ethylenically unsaturated monomers, conjugated or nonconjugated dienes, polyenes, alkenylbenzenes, etc. Examples of such comonomers include C₃-C₂₀ α-olefins such as propylene, isobutylene, 1-butene, 1-hexene, 1-pentene, 4-methyl-1-pentene, 1-heptene. 1-octene, 1-nonene, 1-decene, and the like. 1-Butene and 1-octene are especially preferred. Other suitable monomers include styrene, halo- or alkyl-substituted styrenes, vinylbenzocyclobutane. 1,4-hexadiene, 1,7-octadiene, and naphthenics (e.g., cyclopentene, cyclohexene and cyclooctene).

While ethylene/α-olefin interpolymers are preferred polymers, other ethylene/olefin polymers may also be used. Olefins as used herein refer to a family of unsaturated hydrocarbon-based compounds with at least one carbon-carbon double bond. Depending on the selection of catalysts, any olefin may be used in embodiments of the invention. Preferably, suitable olefins are C₃-C₂₀ aliphatic and aromatic compounds containing vinylic unsaturation, as well as cyclic compounds, such as cyclobutene, cyclopentene, dicyclopentadiene, and norbornene, including but not limited to, norbornene substituted in the 5 and 6 position with C₁-C₂₀ hydrocarbyl or cyclohydrocarbyl groups. Also included are mixtures of such olefins as well as mixtures of such olefins with C₄-C₄₀ diolefin compounds.

Examples of olefin monomers include, but are not limited to propylene, isobutylene, 1-butene, 1-pentene, 1-hexene, 1-heptene, 1-octene, 1-nonene, 1-decene, and 1-dodecene, 1-tetradecene, 1-hexadecene, 1-octadecene, 1-eicosene, 3-methyl-1-butene, 3-methyl-1-pentene, 4-methyl-1-pentene, 4,6-dimethyl-1-heptene, 4-vinylcyclohexene, vinylcyclohexane, norbornadiene, ethylidene norbornene, cyclopentene, cyclohexene, dicyclopentadiene, cyclooctene, C₄-C₄₀ dienes, including but not limited to 1,3-butadiene, 1,3-pentadiene, 1,4-hexadiene, 1,5-hexadiene, 1,7-octadiene, 1,9-decadiene, other C₄-C₄₀ α-olefins, and the like. In certain embodiments, the α-olefin is propylene, 1-butene, 1-pentene, 1-hexene, 1-octene or a combination thereof. Although any hydrocarbon containing a vinyl group potentially may be used in embodiments of the invention, practical issues such as monomer availability, cost, and the ability to conveniently remove unreacted monomer from the resulting polymer may become more problematic as the molecular weight of the monomer becomes too high.

The polymerization processes described herein are well suited for the production of olefin polymers containing monovinylidene aromatic monomers including styrene, o-methyl styrene, p-methyl styrene, t-butylstyrene, and the like. In particular, interpolymers containing ethylene and styrene can be prepared by following the teachings herein. Optionally, copolymers containing ethylene, styrene and a C₃-C₂₀ alpha olefin, optionally containing a C₄-C₂₀ diene, having improved properties can be prepared.

Suitable non-conjugated diene monomers can be a straight chain, branched chain or cyclic hydrocarbon diene having from 6 to 15 carbon atoms. Examples of suitable non-conjugated dienes include, but are not limited to, straight chain acyclic dienes, such as 1,4-hexadiene, 1,6-octadiene, 1,7-octadiene, 1,9-decadiene, branched chain acyclic dienes, such as 5-methyl-1,4-hexadiene; 3,7-dimethyl-1,6-octadiene; 3,7-dimethyl-1,7-octadiene and mixed isomers of dihydromyricene and dihydroocinene, single ring alicyclic dienes, such as 1,3-cyclopentadiene; 1,4-cyclohexadiene; 1,5-cyclooctadiene and 1,5-cyclododecadiene, and multi-ring alicyclic fused and bridged ring dienes, such as tetrahydroindene, methyl tetrahydroindene, dicyclopentadiene, bicyclo-(2,2,1)-hepta-2,5-diene; alkenyl, alkylidene, cycloalkenyl and cycloalkylidene norbornenes, such as 5-methylene-2-norbornene (MNB); 5-propenyl-2-norbornene, 5-isopropylidene-2-norbornene, 5-(4-cyclopentenyl)-2-norbornene, 5-cyclohexylidene-2-norbornene, 5-vinyl-2-norbornene, and norbornadiene. Of the dienes typically used to prepare EPDMs, the particularly preferred dienes are 1,4-hexadiene (HD), 5-ethylidene-2-norbornene (ENB), 5-vinylidene-2-norbornene (VNB), 5-methylene-2-norbornene (MNB), and dicyclopentadiene (DCPD). The especially preferred dienes are 5-ethylidene-2-norbornene (ENB) and 1,4-hexadiene (HD).

One class of desirable polymers that can be made in accordance with embodiments of the invention are elastomeric interpolymers of ethylene, a C₃-C₂₀ α-olefin, especially propylene, and optionally one or more diene monomers. Preferred α-olefins for use in this embodiment of the invention are designated by the formula CH₂═CHR*, where R* is a linear or branched alkyl group of from 1 to 12 carbon atoms. Examples of suitable α-olefins include, but are not limited to, propylene, isobutylene, 1-butene, 1-pentene, 1-hexene, 4-methyl-1-pentene, and 1-octene. A particularly preferred α-olefin is propylene. The propylene based polymers are generally referred to in the art as EP or EPDM polymers. Suitable dienes for use in preparing such polymers, especially multi-block EPDM type polymers include conjugated or non-conjugated, straight or branched chain-, cyclic- or polycyclic-dienes containing from 4 to 20 carbons. Preferred dienes include 1,4-pentadiene, 1,4-hexadiene, 5-ethylidene-2-norbornene, dicyclopentadiene, cyclohexadiene, and 5-butylidene-2-norbornene. A particularly preferred diene is 5-ethylidene-2-norbornene.

Because the diene containing polymers contain alternating segments or blocks containing greater or lesser quantities of the diene (including none) and α-olefin (including none), the total quantity of diene and α-olefin may be reduced without loss of subsequent polymer properties. That is, because the diene and α-olefin monomers are preferentially incorporated into one type of block of the polymer rather than uniformly or randomly throughout the polymer, they are more efficiently utilized and subsequently the crosslink density of the polymer can be better controlled. Such crosslinkable elastomers and the cured products have advantaged properties, including higher tensile strength and better elastic recovery.

In some embodiments, the inventive interpolymers made with two catalysts incorporating differing quantities of comonomer have a weight ratio of blocks formed thereby from 95:5 to 5:95. The elastomeric polymers desirably have an ethylene content of from 20 to 90 percent, a diene content of from 0.1 to 10 percent, and an α-olefin content of from 10 to 80 percent, based on the total weight of the polymer. Further preferably, the multi-block elastomeric polymers have an ethylene content of from 60 to 90 percent, a diene content of from 0.1 to 10 percent, and an α-olefin content of from 10 to 40 percent, based on the total weight of the polymer. Preferred polymers are high molecular weight polymers, having a weight average molecular weight (Mw) from 10,000 to about 2,500,000, preferably from 20,000 to 500,000, more preferably from 20,000 to 350,000, and a polydispersity less than 3.5, more preferably less than 3.0, and a Mooney viscosity (ML (1+4) 125° C.) from 1 to 250. More preferably, such polymers have an ethylene content from 65 to 75 percent, a diene content from 0 to 6 percent, and an α-olefin content from 20 to 35 percent.

The ethylene/α-olefin interpolymers can be functionalized by incorporating at least one functional group in its polymer structure. Exemplary functional groups may include, for example, ethylenically unsaturated mono- and di-functional carboxylic acids, ethylenically unsaturated mono- and di-functional carboxylic acid anhydrides, salts thereof and esters thereof. Such functional groups may be grafted to an ethylene/α-olefin interpolymer, or it may be copolymerized with ethylene and an optional additional comonomer to form an interpolymer of ethylene, the functional comonomer and optionally other comonomer(s). Means for grafting functional groups onto polyethylene are described for example in U.S. Pat. Nos. 4,762,890, 4,927,888, and 4,950,541, the disclosures of these patents are incorporated herein by reference in their entirety. One particularly useful functional group is malic anhydride.

The amount of the functional group present in the functional interpolymer can vary. The functional group can typically be present in a copolymer-type functionalized interpolymer in an amount of at least about 1.0 weight percent, preferably at least about 5 weight percent, and more preferably at least about 7 weight percent. The functional group will typically be present in a copolymer-type functionalized interpolymer in an amount less than about 40 weight percent, preferably less than about 30 weight percent, and more preferably less than about 25 weight percent.

The following examples are provided to illustrate the synthesis of the inventive polymers. Certain comparisons are made with some existing polymers.

Testing Methods

In the examples that follow, the following analytical techniques are employed:

### GPC Method for Samples

An automated liquid-handling robot equipped with a heated needle set to 160° C. is used to add enough 1,2,4-trichlorobenzene stabilized with 300 ppm Ionol to each dried polymer sample to give a final concentration of 30 mg/mL. A small glass stir rod is placed into each tube and the samples are heated to 160° C. for 2 hours on a heated, orbital-shaker rotating at 250 rpm. The concentrated polymer solution is then diluted to 1 mg/ml using the automated liquid-handling robot and the heated needle set to 160° C.

A Symyx Rapid GPC system is used to determine the molecular weight data for each sample. A Gilson 350 pump set at 2.0 ml/min flow rate is used to pump helium-purged 1,2-dichlorobenzene stabilized with 300 ppm Ionol as the mobile phase through three Plgel 10 micrometer (μm) Mixed B 300 mm×7.5 mm columns placed in series and heated to 160° C. A Polymer Labs ELS 1000 Detector is used with the Evaporator set to 250° C., the Nebulizer set to 165° C., and the nitrogen flow rate set to 1.8 SLM at a pressure of 60-80 psi (400−600 kPa) N₂. The polymer samples are heated to 160° C. and each sample injected into a 250 μl loop using the liquid-handling robot and a heated needle. Serial analysis of the polymer samples using two switched loops and overlapping injections are used. The sample data is collected and analyzed using Symyx Epoch™ software. Peaks are manually integrated and the molecular weight information reported uncorrected against a polystyrene standard calibration curve.

Standard CRYSTAF Method

Branching distributions are determined by crystallization analysis fractionation (CRYSTAF) using a CRYSTAF 200 unit commercially available from PolymerChar, Valencia, Spain. The samples are dissolved in 1,2,4 trichlorobenzene at 160° C. (0.66 mg/mL) for 1 hr and stabilized at 95° C. for 45 minutes. The sampling temperatures range from 95 to 30° C. at a cooling rate of 0.2° C./min. An infrared detector is used to measure the polymer solution concentrations. The cumulative soluble concentration is measured as the polymer crystallizes while the temperature is decreased. The analytical derivative of the cumulative profile reflects the short chain branching distribution of the polymer.

The CRYSTAF peak temperature and area are identified by the peak analysis module included in the CRYSTAF Software (Version 2001.b, PolymerChar, Valencia, Spain). The CRYSTAF peak finding routine identifies a peak temperature as a maximum in the dW/dT curve and the area between the largest positive inflections on either side of the identified peak in the derivative curve. To calculate the CRYSTAF curve, the preferred processing parameters are with a temperature limit of 70° C. and with smoothing parameters above the temperature limit of 0.1, and below the temperature limit of 0.3.

DSC Standard Method

Differential Scanning Calorimetry results are determined using a TAI model Q1000 DSC equipped with an RCS cooling accessory and an autosampler. A nitrogen purge gas flow of 50 ml/min is used. The sample is pressed into a thin film and melted in the press at about 175° C. and then air-cooled to room temperature (25° C.). 3-10 mg of material is then cut into a 6 mm diameter disk, accurately weighed, placed in a light aluminum pan (ca 50 mg), and then crimped shut. The thermal behavior of the sample is investigated with the following temperature profile. The sample is rapidly heated to 180° C. and held isothermal for 3 minutes in order to remove any previous thermal history. The sample is then cooled to −40° C. at 10° C./min cooling rate and held at −40° C. for 3 minutes. The sample is then heated to 150° C. at 10° C./min heating rate. The cooling and second heating curves are recorded.

The DSC melting peak is measured as the maximum in heat flow rate (W/g) with respect to the linear baseline drawn between −30° C. and end of melting. The heat of fusion is measured as the area under the melting curve between −30° C. and the end of melting using a linear baseline.

GPC Method

The gel permeation chromatographic system consists of either a Polymer Laboratories Model PL-210 or a Polymer Laboratories Model PL-220 instrument. The column and carousel compartments are operated at 140° C. Three Polymer Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume used is 100 microliters and the flow rate is 1.0 ml/minute.

Calibration of the GPC column set is performed with 21 narrow molecular weight distribution polystyrene standards with molecular weights ranging from 580 to 8,400,000, arranged in 6 “cocktail” mixtures with at least a decade of separation between individual molecular weights. The standards are purchased from Polymer Laboratories (Shropshire, UK). The polystyrene standards are prepared at 0.025 grams in 50 milliliters of solvent for molecular weights equal to or greater than 1,000,000, and 0.05 grams in 50 milliliters of solvent for molecular weights less than 1,000,000. The polystyrene standards are dissolved at 80° C. with gentle agitation for 30 minutes. The narrow standards mixtures are run first and in order of decreasing highest molecular weight component to minimize degradation. The polystyrene standard peak molecular weights are converted to polyethylene molecular weights using the following equation (as described in Williams and Ward, J. Polym. Sci., Polym. Let. 6, 621 (1968)): M_{polyethylene}=0.431(M_{polystyrene}).

Polyethylene equivalent molecular weight calculations are performed using Viscotek TriSEC software Version 3.0.

Density

Samples for density measurement are prepared according to ASTM D 1928. Measurements are made within one hour of sample pressing using ASTM D792, Method B.

Nonwoven Fabrication

The spunbond nonwoven examples are made using a Reicofil 4 (RF 4) (Reifenhäuser REICOFIL GmbH & Co. KG, Troisdorf, Germany) bicomponent spunbond line equipped with a single beam and having a width of 1.2 meters. A bicomponent spinnerette block with 6827 holes/meter and with a diameter of 0.6 mm per hole and an length/diameter ratio (L/D) of 4 is used. The spunbond machine comprises two extruders running into a bicomponent block. (bi-component configuration). The two extruders (120 mm and 80 mm diameter screws, respectively) have different outputs and also go through two separate spin pumps. Volumetric output rate is controlled by rotational frequency (rotations per minute—RPM) to produce the desired core to sheath ratio. The screenpacks used are a 5 pack configuration (40 mesh, 100 mesh, 80 micron, 60 mesh and 31 mesh). The web belt used is a standard Kofpa Velostat design for RF 4.

The melt blown examples are made using a 1.2 meter wide J&M bicomponent meltblown die. The die used has 35 holes/per inch with a 0.4 mm diameter holes with a L/D of 10. The die was fed by two Davis Standard Fibermaster extruders (A-side 3.0″ in diameter and B-side 2.0″ in diameter). Conditions used to fabricate the fabric are described in Table VII. Bonding of the fabric was done using a calendar roll with 15% bonding area and using a oval design with calendar oil temperature set at 105° C. Nip roll pressure was set at 15 N/mm. Line-speed was 7 meters per minute.

Fabric Test Methods

Fabrics are allowed to age for at least 24 hours at ambient conditions (20-25° C., 50% relative humidity) prior to measurements.

Basis weight, measured in grams per square meter (g/m²) is calculated by dividing the weight of the fabric, measured with an analytical balance, by the corresponding fabric area. Care is taken to not include the edges of the fabric which can have substantially different formation compared to the center section of the fabric.

Tensile and hysteresis experiments are carried out on fabrics with samples that are 1 inch wide and at least 6 inches long. The sample is cut length parallel to the machine direction (MD) or parallel to the cross direction (CD) from the center of the fabric. The samples are loaded into an Instron 5564 (Norwood, Mass., United States) fitted with a 100 N load cell and pneumatically activated grips fitted with hemispherical line-contact facings with opposing rubber-faced flat facings. Grip separation is set to be 5 inches. Gauge length is taken to be 5 inches. A 3 gram weight is attached to one end of the sample and the other end is loaded into the top grip thereby allowing the weight to hold the sample straight. The bottom grip is then closed. Crosshead speed is set at 100%/min (5 inches per minute).

In the tensile test, the specimen in the MD and CD is pulled until it breaks. At least 3 samples per direction are tested. Strain (ε) is calculated according to the following equation:

$$ɛ = \frac{Δ l}{{l}_{o}} \times 100 \%$$

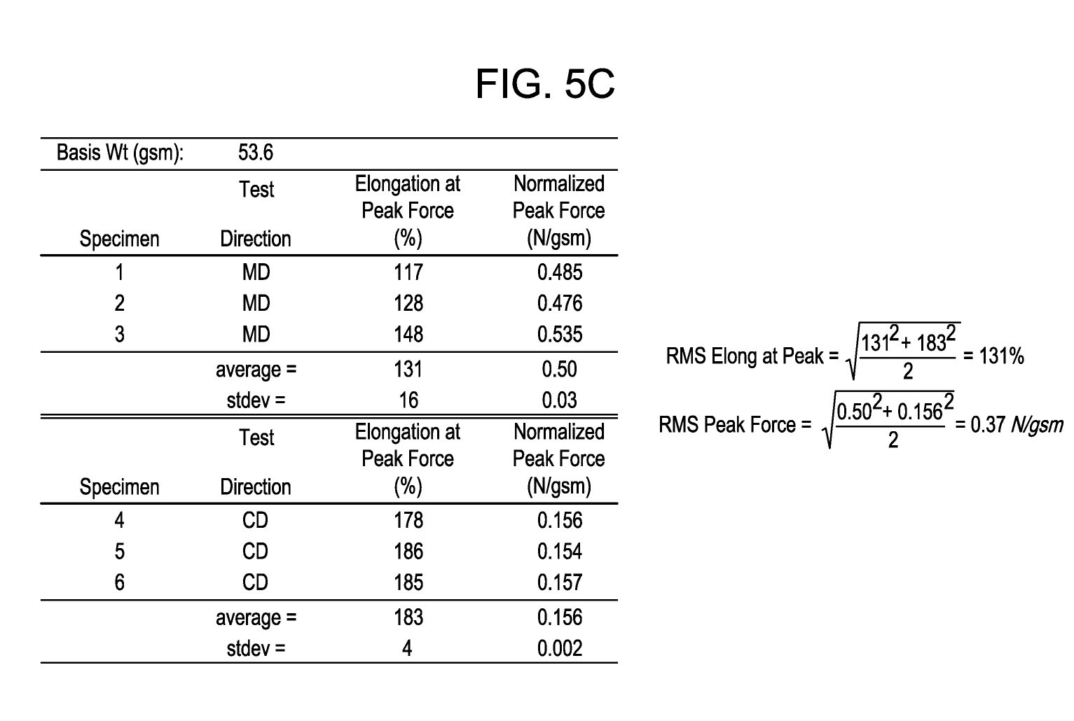

such that Δl is the crosshead displacement and lₒ is the gauge length (5 inches). The elongation at peak force (elongation at peak) is defined as the strain corresponding to the maximum force at or prior to break. The average and standard deviation in the elongation at peak is calculated for each direction. Normalized load is defined as the instantaneous tensile force measured in Newtons (N) during the test divided by the initial basis weight of the sample measured in grams per square meter area of material. Peak force is defined as the maximum load during the tensile test. Normalized Peak Force is defined as the maximum normalized load during the tensile test. The elongation at peak is defined as the strain corresponding to the maximum force during the tensile test. The average and standard deviation of the Normalized Peak Force and of the elongation at peak calculated for each direction. The root mean square of these quantities in the MD and CD are defined as RMS Peak Force and RMS Elongation at Peak (RMS Elong at Peak), respectively. An example of this calculation is given (see FIG. 5).

In the 80% hysteresis test, a specimen is extended to 80% strain (4 inches displacement). This step is designated as the first cycle extension. Without delay, the crosshead direction is then reversed the position corresponding to 0% strain. This step is designated as the first cycle retraction. Without delay, the sample is extended to 80% strain (4 inches crosshead displacement). This step is designated the second cycle extension. The strain corresponding to 0.05 Newton (N) tension in the second cycle extension is designated the permanent set. The hysteresis loss is defined as the energy difference between the strain and retraction cycle. The load down is defined as the retractive force at 50% strain during the first cycle retraction. Normalized load down is defined as the load down divided by the initial basis weight of the sample measured in grams per square meter area of material. The average values of the permanent set, hysteresis loss, and the normalized load down are measured for each direction. The root mean square of these quantities in the MD and CD are defined as RMS Permanent Set, RMS Hysteresis Lost, and the RMS Load Down, respectively.

Coefficient of friction of the fabrics to the supplied machine milled stainless metal platen surface was measured using method described in ASTM D 1894-06. A nonwoven was used in lieu of the flexible film. Otherwise, the procedures described for a flexible film were used. The nonwoven was attached to the bottom of the sled such that the machine direction (MD) of the nonwoven was parallel to sled movement and the texture of the metal platen surface. The leading edge of the sled was attached to the nonwoven with paper masking tape. The instrument used was a Model 32-06-00-0002. The sled was a model 32-06-02. Both the instrument and the sled were made by Testing Machines Incorporated (Ronkonkoma, N.Y., USA).

To quantify a fabric with good formation, the number of filament aggregates per 2 cm length is measured. Each filament aggregate is at least 10 times the fiber width in length. Care is taken to not include thermal and pressure bond points in the 2 cm length. Over a 2 cm length in random directions, the linear line count of filament aggregates is taken. Filament aggregates (synonymous with self-adhered, self-sticking, married, roped or roping, bundled fibers) consists of multiple filaments in parallel orientation fused together. The filaments are fused for greater than 10 times the width of the fiber. Filament aggregates are separate from thermal or pressure bond points. For good web formation, the number of filament aggregates is lower than 30/2 cm, preferentially lower than 20/2 cm.

Melt Index

Melt index, or I₂, is measured in accordance with ASTM D 1238, Condition 190° C./2.16 kg. Melt index, or I₁₀ is also measured in accordance with ASTM D 1238, Condition 190° C./10 kg.

ATREF

Analytical temperature rising elution fractionation (ATREF) analysis is conducted according to the method described in U.S. Pat. No. 4,798,081 and Wilde, L.; Ryle, T. R.; Knobeloch, D. C.; Peat, I. R.; Determination of Branching Distributions in Polyethylene and Ethylene Copolymers, J. Polym. Sci., 20, 441-455 (1982), which are incorporated by reference herein in their entirety. The composition to be analyzed is dissolved in trichlorobenzene and allowed to crystallize in a column containing an inert support (stainless steel shot) by slowly reducing the temperature to 20° C. at a cooling rate of 0.1° C./min The column is equipped with an infrared detector. An ATREF chromatogram curve is then generated by eluting the crystallized polymer sample from the column by slowly increasing the temperature of the eluting solvent (trichlorobenzene) from 20 to 120° C. at a rate of 1.5° C./min

### ¹³C NMR Analysis

The samples are prepared by adding approximately 3 g of a 50/50 mixture of tetrachloroethane-d²/orthodichlorobenzene to 0.4 g sample in a 10 mm NMR tube. The samples are dissolved and homogenized by heating the tube and its contents to 150° C. The data are collected using a JEOL Eclipse™ 400 MHz spectrometer or a Varian Unity Plus™ 400 MHz spectrometer, corresponding to a ¹³C resonance frequency of 100.5 MHz. The data are acquired using 4000 transients per data file with a 6 second pulse repetition delay. To achieve minimum signal-to-noise for quantitative analysis, multiple data files are added together. The spectral width is 25,000 Hz with a minimum file size of 32K data points. The samples are analyzed at 130° C. in a 10 mm broad band probe. The comonomer incorporation is determined using Randall's triad method (Randall, J. C.; JMS-Rev. Macromol. Chem. Phys., C29, 201-317 (1989), which is incorporated by reference herein in its entirety.

Polymer Fractionation by TREF

Large-scale TREF fractionation is carried by dissolving 15-20 g of polymer in 2 liters of 1,2,4-trichlorobenzene (TCB) by stirring for 4 hours at 160° C. The polymer solution is forced by 15 psig (100 kPa) nitrogen onto a 3 inch by 4 foot (7.6 cm×12 cm) steel column packed with a 60:40 (v:v) mix of 30-40 mesh (600-425 μm) spherical, technical quality glass beads (available from Potters Industries, HC 30 Box 20, Brownwood, Tex., 76801) and stainless steel, 0.028″ (0.7 mm) diameter cut wire shot (available from Pellets, Inc. 63 Industrial Drive, North Tonawanda, N.Y., 14120). The column is immersed in a thermally controlled oil jacket, set initially to 160° C. The column is first cooled ballistically to 125° C., then slow cooled to 20° C. at 0.04° C. per minute and held for one hour. Fresh TCB is introduced at about 65 ml/min while the temperature is increased at 0.167° C. per minute.

Approximately 2000 ml portions of eluant from the preparative TREF column are collected in a 16 station, heated fraction collector. The polymer is concentrated in each fraction using a rotary evaporator until about 50 to 100 ml of the polymer solution remains. The concentrated solutions are allowed to stand overnight before adding excess methanol, filtering, and rinsing (approx. 300-500 ml of methanol including the final rinse). The filtration step is performed on a 3 position vacuum assisted filtering station using 5.0 μm polytetrafluoroethylene coated filter paper (available from Osmonics Inc., Cat# Z50WPO4750). The filtrated fractions are dried overnight in a vacuum oven at 60° C. and weighed on an analytical balance before further testing.

Catalysts

The term “overnight”, if used, refers to a time of approximately 16-18 hours, the term “room temperature”, refers to a temperature of 20-25° C., and the term “mixed alkanes” refers to a commercially obtained mixture of C₆₋₉ aliphatic hydrocarbons available under the trade designation Isopar E®, from ExxonMobil Chemical Company. In the event the name of a compound herein does not conform to the structural representation thereof, the structural representation shall control. The synthesis of all metal complexes and the preparation of all screening experiments were carried out in a dry nitrogen atmosphere using dry box techniques. All solvents used were HPLC grade and were dried before their use.

MMAO refers to modified methylalumoxane, a triisobutylaluminum modified methylalumoxane available commercially from Akzo-Nobel Polymer Chemicals.

The preparation of catalyst (B1) is conducted as follows.

### (a) Preparation of (1-methylethyl)(2-hydroxy-3,5-di(t-tyl)phenyl)methylimine

3,5-Di-t-butylsalicylaldehyde (3.00 g) is added to 10 mL of isopropylamine. The solution rapidly turns bright yellow. After stirring at ambient temperature for 3 hours, volatiles are removed under vacuum to yield a bright yellow, crystalline solid (97 percent yield).

### (b) Preparation of 1,2-bis-(3,5-di-t-butylphenylene)(1-(N-(1-methylethyl)immino)methyl)(2-oxoyl)zirconium dibenzyl

A solution of (1-methylethyl)(2-hydroxy-3,5-di(t-butyl)phenyl)imine (605 mg, 2.2 mmol) in 5 mL toluene is slowly added to a solution of Zr(CH₂Ph)₄ (500 mg, 1.1 mmol) in 50 mL toluene. The resulting dark yellow solution is stirred for 30 min Solvent is removed under reduced pressure to yield the desired product as a reddish-brown solid.

The preparation of catalyst (B2) is conducted as follows.

### (a) Preparation of (1-(2-methylcyclohexyl)ethyl)(2-oxoyl-3,5-di(t-butyl)phenyl)imine

2-Methylcyclohexylamine (8.44 mL, 64.0 mmol) is dissolved in methanol (90 mL), and di-t-butylsalicaldehyde (10.00 g, 42.67 mmol) is added. The reaction mixture is stirred for three hours and then cooled to −25° C. for 12 hrs. The resulting yellow solid precipitate is collected by filtration and washed with cold methanol (2×15 mL), and then dried under reduced pressure. The yield is 11.17 g of a yellow solid. ¹H NMR is consistent with the desired product as a mixture of isomers.

### (b) Preparation of bis-(1-(2-methylcyclohexyl)ethyl)(2-oxoyl-3,5-di(t-butyl)phenyl)immino)zirconium dibenzyl

A solution of (1-(2-methylcyclohexyl)ethyl)(2-oxoyl-3,5-di(t-utyl)phenyl)imine (7.63 g, 23.2 mmol) in 200 mL toluene is slowly added to a solution of Zr(CH₂Ph)₄ (5.28 g, 11.6 mmol) in 600 mL toluene. The resulting dark yellow solution is stirred for 1 hour at 25° C. The solution is diluted further with 680 mL toluene to give a solution having a concentration of 0.00783 M.

Cocatalyst 1 A mixture of methyldi(C₁₄₋₁₈ alkyl)ammonium salts of tetrakis(pentafluorophenyl)borate (here-in-after armeenium borate), prepared by reaction of a long chain trialkylamine (Armeen™ M2HT, available from Akzo-Nobel, Inc.), HCl and Li[B(C₆F₅)₄], substantially as disclosed in U.S. Pat. No. 5,919,9883, Ex. 2.

Shuttling Agents The shuttling agents employed include diethylzinc (DEZ, SA1), di(i-butyl)zinc (SA2), di(n-hexyl)zinc (SA3), triethylaluminum (TEA, SA4), trioctylaluminum (SA5), triethylgallium (SA6), i-butylaluminum bis(dimethyl(t-butyl)siloxane) (SA7), i-butylaluminum bis(di(trimethylsilyl)amide) (SA8), n-octylaluminum di(pyridine-2-methoxide) (SA9), bis(n-octadecyl)i-butylaluminum (SA10), i-butylaluminum bis(di(n-pentyl)amide) (SA11), n-octylaluminum bis(2,6-di-t-butylphenoxide) (SA12), n-octylaluminum di(ethyl(1-naphthyl)amide) (SA13), ethylaluminum bis(t-butyldimethylsiloxide) (SA14), ethylaluminum di(bis(trimethylsilyl)amide) (SA15), ethylaluminum bis(2,3,6,7-dibenzo-1-azacycloheptaneamide) (SA16), n-octylaluminum bis(2,3,6,7-dibenzo-1-azacycloheptaneamide) (SA17), n-octylaluminum bis(dimethyl(t-butyl)siloxide (SA18), ethylzinc(2,6-diphenylphenoxide) (SA19), and ethylzinc(t-butoxide) (SA20).

### Fibers and Articles of Manufacture

Various homofil fibers can be made from the inventive block interpolymers (also referred to hereinafter as “copolymer(s)”), including staple fibers, spunbond fibers or melt blown fibers (using, e.g., systems as disclosed in U.S. Pat. No. 4,340,563, 4,663,220, 4,668,566 or 4,322,027, and gel spun fibers (e.g., the system disclosed in U.S. Pat. No. 4,413,110). Staple fibers can be melt spun into the final fiber diameter directly without additional drawing, or they can be melt spun into a higher diameter and subsequently hot or cold drawn to the desired diameter using conventional fiber drawing techniques.

Bicomponent fibers can also be made from the block copolymers according to some embodiments of the invention. Such bicomponent fibers have the inventive block interpolymer in at least one portion of the fiber. For example, in a sheath/core bicomponent fiber (i.e., one in which the sheath concentrically surrounds the core), the inventive block interpolymer can be in either the sheath or the core. Different copolymers can also be used independently as the sheath and the core in the same fiber, preferably where both components are elastic and especially where the sheath component has a lower melting point than the core component. Other types of bicomponent fibers are within the scope of the invention as well, and include such structures as side-by-side conjugated fibers (e.g., fibers having separate regions of polymers, wherein the inventive block interpolymer comprises at least a portion of the fiber's surface).

The shape of the fiber is not limited. For example, typical fiber has a circular cross-sectional shape, but sometimes fibers have different shapes, such as a trilobal shape, or a flat (i.e., “ribbon” like) shape. The fiber disclosed herein is not limited by the shape of the fiber.

Fiber diameter can be measured and reported in a variety of fashions. Generally, fiber diameter is measured in denier per filament. Denier is a textile term which is defined as the grams of the fiber per 9000 meters of that fiber's length. Monofilament generally refers to an extruded strand having a denier per filament greater than 15, usually greater than 30. Fine denier fiber generally refers to fiber having a denier of about 15 or less. Microdenier (aka microfiber) generally refers to fiber having a diameter not greater than about 100 micrometers. For the fibers according to some embodiments of the invention, the diameter can be widely varied, with little impact upon the elasticity of the fiber. The fiber denier, however, can be adjusted to suit the capabilities of the finished article and as such, would preferably be: from about 0.5 to about 30 denier/filament for melt blown; from about 1 to about 30 denier/filament for spunbond; and from about 1 to about 20,000 denier/filament for continuous wound filament. Nonetheless, preferably, the denier is greater than 40, more preferably greater than or equal to 55 and most preferably greater than or equal to 65.

The fibers according to embodiments of the invention can be used with other fibers such as PET, nylon, cotton, Kevlar™, etc. to make elastic fabrics. As an added advantage, the heat (and moisture) resistance of certain fibers can enable polyester PET fibers to be dyed at ordinary PET dyeing conditions. The other commonly used fibers, especially spandex (e.g., Lycra™), can only be used at less severe PET dyeing conditions to prevent degradation of properties.

Fabrics made from the fibers according to embodiments of the invention include woven, nonwoven and knit fabrics. Nonwoven fabrics can be made various by methods, e.g., spunlaced (or hydrodynamically entangled) fabrics as disclosed in U.S. Pat. Nos. 3,485,706 and 4,939,016, carding and thermally bonding staple fibers; spunbonding continuous fibers in one continuous operation; or by melt blowing fibers into fabric and subsequently calandering or thermally bonding the resultant web. These various nonwoven fabric manufacturing techniques are known to those skilled in the art and the disclosure is not limited to any particular method. Other structures made from such fibers are also included within the scope of the invention, including e.g., blends of these novel fibers with other fibers (e.g., poly(ethylene terephthalate) or cotton).

Nonwoven fabrics can be made from fibers obtained from solution spinning or flash spinning the inventive ethylene/α-olefin interpolymers. Solution spinning includes wet spinning and dry spinning. In both methods, a viscous solution of polymer is pumped through a filter and then passed through the fine holes of a spinnerette. The solvent is subsequently removed, leaving a fiber.

In some embodiments, the following process is used for flash spinning fibers and forming sheets from an inventive ethylene/α-olefin interpolymer. The basic system has been previously disclosed in U.S. Pat. No. 3,860,369 and No. 6,117,801, which are hereby incorporated by reference herein in its entirety. The process is conducted in a chamber, sometimes referred to as a spin cell, which has a vapor-removal port and an opening through which non-woven sheet material produced in the process is removed. Polymer solution (or spin liquid) is continuously or batchwise prepared at an elevated temperature and pressure and provided to the spin cell via a conduit. The pressure of the solution is greater than the cloud-point pressure which is the lowest pressure at which the polymer is fully dissolved in the spin agent forming a homogeneous single phase mixture.

The single phase polymer solution passes through a letdown orifice into a lower pressure (or letdown) chamber. In the lower pressure chamber, the solution separates into a two-phase liquid-liquid dispersion. One phase of the dispersion is a spin agent-rich phase which comprises primarily the spin agent and the other phase of the dispersion is a polymer-rich phase which contains most of the polymer. This two phase liquid-liquid dispersion is forced through a spinneret into an area of much lower pressure (preferably atmospheric pressure) where the spin agent evaporates very rapidly (flashes), and the polymer emerges from the spinneret as a yarn (or plexifilament). The yarn is stretched in a tunnel and is directed to impact a rotating baffle. The rotating baffle has a shape that transforms the yarn into a flat web, which is about 5-15 cm wide, and separating the fibrils to open up the web. The rotating baffle further imparts a back and forth oscillating motion having sufficient amplitude to generate a wide back and forth swath. The web is laid down on a moving wire lay-down belt located about 50 cm below the spinneret, and the back and forth oscillating motion is arranged to be generally across the belt to form a sheet.

As the web is deflected by the baffle on its way to the moving belt, it enters a corona charging zone between a stationary multi-needle ion gun and a grounded rotating target plate. The multi-needle ion gun is charged to a DC potential of by a suitable voltage source. The charged web is carried by a high velocity spin agent vapor stream through a diffuser comprising two parts: a front section and a back section. The diffuser controls the expansion of the web and slows it down. The back section of the diffuser may be stationary and separate from target plate, or it may be integral with it. In the case where the back section and the target plate are integral, they rotate together. Aspiration holes are drilled in the back section of the diffuser to assure adequate flow of gas between the moving web and the diffuser back section to prevent sticking of the moving web to the diffuser back section. The moving belt is grounded through rolls so that the charged web is electrostatically attracted to the belt and held in place thereon. Overlapping web swaths collected on the moving belt and held there by electrostatic forces are formed into a sheet with a thickness controlled by the belt speed. The sheet is compressed between the belt and the consolidation roll into a structure having sufficient strength to be handled outside the chamber and then collected outside the chamber on a windup roll.

Accordingly, some embodiments of the invention provide a soft polymeric flash-spun plexifilamentary material comprising an inventive ethylene/α-olefin interpolymer described herein. Preferably, the ethylene/α-olefin interpolymer has a melt index from about 0.1 to about 50 g/10 min or from about 0.4 to about 10 g/10 min and a density from about 0.85 to about 0.95 g/cc or from about 0.87 and about 0.90 g/cc. Preferably, the molecular weight distribution of the interpolymer is greater than about 1 but less than about four. Moreover, the flash-spun plexifilamentary material has a BET surface area of greater than about 2 m²/g or greater than about 8 m²/g. A soft flash-spun nonwoven sheet material can be made from the soft polymeric flash-spun plexifilamentary material. The soft flash-spun nonwoven sheet material can be spunbonded, area bonded, or pointed bonded. Other embodiments of the invention provide a soft polymeric flash-spun plexifilamentary material comprising an ethylene/α-alpha interpolymer (described herein) blended with high density polyethylene polymer, wherein the ethylene/α-alpha interpolymer has a melt index of between about 0.4 and about 10 g/10 min, a density between about 0.87 and about 0.93 g/cc, and a molecular weight distribution less than about 4, and wherein the plexifilamentary material has a BET surface area greater than about 8 m²/g. The soft flash-spun nonwoven sheet has an opacity of at least 85%.

Flash-spun nonwoven sheets made by the above process or a similar process can used to replace Tyvek® spunbonded olefin sheets for air infiltration barriers in construction applications, as packaging such as air express envelopes, as medical packaging, as banners, and for protective apparel and other uses.

Fabricated articles which can be made using the fibers and fabrics according to embodiments of the invention include elastic composite articles (e.g., diapers) that have elastic portions. For example, elastic portions are typically constructed into diaper waist band portions to prevent the diaper from falling and leg band portions to prevent leakage (as shown in U.S. Pat. No. 4,381,781, the disclosure of which is incorporated herein by reference). Often, the elastic portions promote better form fitting and/or fastening systems for a good combination of comfort and reliability. The inventive fibers and fabrics can also produce structures which combine elasticity with breathability. For example, the inventive fibers, fabrics and/or films may be incorporated into the structures disclosed in U.S. provisional patent application 60/083,784, filed May 1, 1998. Laminates of non-wovens comprising fibers of the invention can also be formed and can be used in various articles, including consumer goods, such as durables and disposable consumer goods, like apparel, diapers, hospital gowns, hygiene applications, upholstery fabrics, etc.

The inventive fibers, films and fabrics can also be used in various structures as described in U.S. Pat. No. 2,957,512. For example, layer 50 of the structure described in the preceding patent (i.e., the elastic component) can be replaced with the inventive fibers and fabrics, especially where flat, pleated, creped, crimped, etc., nonelastic materials are made into elastic structures. Attachment of the inventive fibers and/or fabric to nonfibers, fabrics or other structures can be done by melt bonding or with adhesives. Gathered or shirted elastic structures can be produced from the inventive fibers and/or fabrics and nonelastic components by pleating the non-elastic component (as described in U.S. Pat. No. 2,957,512) prior to attachment, pre-stretching the elastic component prior to attachment, or heat shrinking the elastic component after attachment.

The inventive fibers also can be used in a spunlaced (or hydrodynamically entangled) process to make novel structures. For example, U.S. Pat. No. 4,801,482 discloses an elastic sheet (12) which can now be made with the novel fibers/films/fabric described herein.

Continuous elastic filaments as described herein can also be used in woven or knit applications where high resilience is desired.

U.S. Pat. No. 5,037,416 describes the advantages of a form fitting top sheet by using elastic ribbons (see member 19 of U.S. Pat. No. 5,037,416). The inventive fibers could serve the function of member 19 of U.S. Pat. No. 5,037,416, or could be used in fabric form to provide the desired elasticity.

In U.S. Pat. No. 4,981,747 (Morman), the inventive fibers and/or fabrics disclosed herein can be substituted for elastic sheet 122, which forms a composite elastic material including a reversibly necked material.

The inventive fibers can also be a melt blown elastic component, as described in reference 6 of the drawings of U.S. Pat. No. 4,879,170.

Elastic panels can also be made from the inventive fibers and fabrics disclosed herein, and can be used, for example, as members 18, 20, 14, and/or 26 of U.S. Pat. No. 4,940,464. The inventive fibers and fabrics described herein can also be used as elastic components of composite side panels (e.g., layer 86 of the patent).

The elastic materials can also be rendered pervious or “breathable” by any method known in the art including by apperturing, slitting, microperforating, mixing with fibers or foams, or the like and combinations thereof. Examples of such methods include, U.S. Pat. No. 3,156,242 by Crowe, Jr., U.S. Pat. No. 3,881,489 by Hartwell, U.S. Pat. No. 3,989,867 by Sisson and U.S. Pat. No. 5,085,654 by Buell.

The fibers in accordance with certain embodiments of the invention can include covered fibers. Covered fibers comprise a core and a cover. Generally, the core comprises one or more elastic fibers, and the cover comprises one or more inelastic fibers. At the time of the construction of the covered fiber and in their respective unstretched states, the cover is longer, typically significantly longer, than the core fiber. The cover surrounds the core in a conventional manner, typically in a spiral wrap configuration. Uncovered fibers are fibers without a cover. Generally, a braided fiber or yarn, i.e., a fiber comprising two or more fiber strands or filaments (elastic and/or inelastic) of about equal length in their respective unstretched states intertwined with or twisted about one another, is not a covered fiber. These yarns can, however, be used as either or both the core and cover of the covered fiber. In other embodiments, covered fibers may comprise an elastic core wrapped in an elastic cover.

Preactivated articles can be made according to the teachings of U.S. Pat. Nos. 5,226,992, 4,981,747 (KCC, Morman), and 5,354,597, all of which are incorporated by reference herein in their entirety.

High tenacity fibers can be made according to the teachings of U.S. Pat. Nos. 6,113,656, 5,846,654, and 5,840,234, all of which are incorporated by reference herein in their entirety.

Low denier fibers, including microdenier fibers, can be made from the inventive interpolymers.

The preferred use of the inventive fibers, is in the formation of fabric, both woven and non-woven fabrics. Fabrics formed from the fibers have been found to have excellent elastic properties making them suitable for many garment applications. They also have good drapeability.

Some of the desirable properties of fibers and fabric may be expressed in terms of tensile modulus and permanent set. For a spunbonded fabric according to certain embodiments of the invention, the preferred properties which are obtained are as follows:

Blending with Another Polymer

The ethylene/α-olefin block interpolymers can be blended with at least another polymer make fibers, such as polyolefin (e.g., polypropylene). This second polymer is different from the/α-olefin block interpolymer in composition (comonomer type, comonomer content, etc.), structure, property, or a combination of both. For example, a block ethylene/octene copolymer is different than a random ethylene/octene copolymer, even if they have the same amount of comonomers. A block ethylene/octene copolymer is different than an ethylene/butane copolymer, regardless of whether it is a random or block copolymer or whether it has the same comonomer content. Two polymers also are considered different if they have a different molecular weight, even if they have the same structure and composition.

A polyolefin is a polymer derived from two or more olefins (i.e., alkenes). An olefin (i.e., alkene) is a hydrocarbon contains at least one carbon-carbon double bond. The olefin can be a monoene (i.e, an olefin having a single carbon-carbon double bond), diene (i.e, an olefin having two carbon-carbon double bonds), triene (i.e, an olefin having three carbon-carbon double bonds), tetraene (i.e, an olefin having four carbon-carbon double bonds), and other polyenes. The olefin or alkene, such as monoene, diene, triene, tetraene and other polyenes, can have 3 or more carbon atoms, 4 or more carbon atoms, 6 or more carbon atoms, 8 or more carbon atoms. In some embodiments, the olefin has from 3 to about 100 carbon atoms, from 4 to about 100 carbon atoms, from 6 to about 100 carbon atoms, from 8 to about 100 carbon atoms, from 3 to about 50 carbon atoms, from 3 to about 25 carbon atoms, from 4 to about 25 carbon atoms, from 6 to about 25 carbon atoms, from 8 to about 25 carbon atoms, or from 3 to about 10 carbon atoms. In some embodiments, the olefin is a linear or branched, cyclic or acyclic, monoene having from 2 to about 20 carbon atoms. In other embodiments, the alkene is a diene such as butadiene and 1,5-hexadiene. In further embodiments, at least one of the hydrogen atoms of the alkene is substituted with an alkyl or aryl. In particular embodiments, the alkene is ethylene, propylene, 1-butene, 1-hexene, 1-octene, 1-decene, 4-methyl-1-pentene, norbornene, 1-decene, butadiene, 1,5-hexadiene, styrene or a combination thereof.

The amount of the polyolefins in the polymer blend to make fibers can be from about 0.5 to about 99 wt %, from about 10 to about 90 wt %, from about 20 to about 80 wt %, from about 30 to about 70 wt %, from about 5 to about 50 wt %, from about 50 to about 95 wt %, from about 10 to about 50 wt %, or from about 50 to about 90 wt % of the total weight of the polymer blend.

Any polyolefin known to a person of ordinary skill in the art may be used to prepare the polymer blend disclosed herein. The polyolefins can be olefin homopolymers, olefin copolymers, olefin terpolymers, olefin quaterpolymers and the like, and combinations thereof.

In some embodiments, one of the at least two polyolefins is an olefin homopolymer. The olefin homopolymer can be derived from one olefin. Any olefin homopolymer known to a person of ordinary skill in the art may be used. Non-limiting examples of olefin homopolymers include polyethylene (e.g., ultralow, low, linear low, medium, high and ultrahigh density polyethylene), polypropylene, polybutylene (e.g., polybutene-1), polypentene-1, polyhexene-1, polyoctene-1, polydecene-1, poly-3-methylbutene-1, poly-4-methylpentene-1, polyisoprene, polybutadiene, poly-1,5-hexadiene.

In further embodiments, the olefin homopolymer is a polypropylene. Any polypropylene known to a person of ordinary skill in the art may be used to prepare the polymer blends disclosed herein. Non-limiting examples of polypropylene include polypropylene (LDPP), high density polypropylene (HDPP), high melt strength polypropylene (HMS-PP), high impact polypropylene (HIPP), isotactic polypropylene (iPP), syndiotactic polypropylene (sPP) and the like, and combinations thereof.

The amount of the polypropylene in the polymer blend can be from about 0.5 to about 99 wt %, from about 10 to about 90 wt %, from about 20 to about 80 wt %, from about 30 to about 70 wt %, from about 5 to about 50 wt %, from about 50 to about 95 wt %, from about 10 to about 50 wt %, or from about 50 to about 90 wt % of the total weight of the polymer blend.

### Crosslinking

The fibers can be cross-linked by any means known in the art, including, but not limited to, electron-beam irradiation, beta irradiation, gamma irradiation, corona irradiation, silanes, peroxides, allyl compounds and UV radiation with or without crosslinking catalyst. U.S. Pat. Nos. 6,803,014 and 6,667,351 disclose electron-beam irradiation methods that can be used in embodiments of the invention.

Irradiation may be accomplished by the use of high energy, ionizing electrons, ultra violet rays, X-rays, gamma rays, beta particles and the like and combination thereof. Preferably, electrons are employed up to 70 megarads dosages. The irradiation source can be any electron beam generator operating in a range of about 150 kilovolts to about 6 megavolts with a power output capable of supplying the desired dosage. The voltage can be adjusted to appropriate levels which may be, for example, 100,000, 300,000, 1,000,000 or 2,000,000 or 3,000,000 or 6,000,000 or higher or lower. Many other apparati for irradiating polymeric materials are known in the art. The irradiation is usually carried out at a dosage between about 3 megarads to about 35 megarads, preferably between about 8 to about 20 megarads. Further, the irradiation can be carried out conveniently at room temperature, although higher and lower temperatures, for example 0° C. to about 60° C., may also be employed. Preferably, the irradiation is carried out after shaping or fabrication of the article. Also, in a preferred embodiment, the ethylene interpolymer which has been incorporated with a pro-rad additive is irradiated with electron beam radiation at about 8 to about 20 megarads.

Crosslinking can be promoted with a crosslinking catalyst, and any catalyst that will provide this function can be used. Suitable catalysts generally include organic bases, carboxylic acids, and organometallic compounds including organic titanates and complexes or carboxylates of lead, cobalt, iron, nickel, zinc and tin. Dibutyltindilaurate, dioctyltinmaleate, dibutyltindiacetate, dibutyltindioctoate, stannous acetate, stannous octoate, lead naphthenate, zinc caprylate, cobalt naphthenate; and the like. Tin carboxylate, especially dibutyltindilaurate and dioctyltinmaleate, are particularly effective. The catalyst (or mixture of catalysts) is present in a catalytic amount, typically between about 0.015 and about 0.035 phr.

Representative pro-rad additives include, but are not limited to, azo compounds, organic peroxides and polyfunctional vinyl or allyl compounds such as, for example, triallyl cyanurate, triallyl isocyanurate, pentaerthritol tetramethacrylate, glutaraldehyde, ethylene glycol dimethacrylate, diallyl maleate, dipropargyl maleate, dipropargyl monoallyl cyanurate, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, tert-butyl peracetate, azobisisobutyl nitrite and the like and combination thereof. Preferred pro-rad additives for use in some embodiments of the invention are compounds which have poly-functional (i.e. at least two) moieties such as C═C, C═N or C═O.

At least one pro-rad additive can be introduced to the ethylene interpolymer by any method known in the art. However, preferably the pro-rad additive(s) is introduced via a masterbatch concentrate comprising the same or different base resin as the ethylene interpolymer. Preferably, the pro-rad additive concentration for the masterbatch is relatively high e.g., about 25 weight percent (based on the total weight of the concentrate).

The at least one pro-rad additive is introduced to the ethylene polymer in any effective amount. Preferably, the at least one pro-rad additive introduction amount is from about 0.001 to about 5 weight percent, more preferably from about 0.005 to about 2.5 weight percent and most preferably from about 0.015 to about 1 weight percent (based on the total weight of the ethylene interpolymer.

In addition to electron-beam irradiation, crosslinking can also be effected by UV irradiation. U.S. Pat. No. 6,709,742 discloses a cross-linking method by UV irradiation which can be used in embodiments of the invention. The method comprises mixing a photoinitiator, with or without a photocrosslinker, with a polymer before, during, or after a fiber is formed and then exposing the fiber with the photoinitiator to sufficient UV radiation to crosslink the polymer to the desired level. The photoinitiators used in the practice of the invention are aromatic ketones, e.g., benzophenones or monoacetals of 1,2-diketones. The primary photoreaction of the monacetals is the homolytic cleavage of the α-bond to give acyl and dialkoxyalkyl radicals. This type of α-cleavage is known as a Norrish Type I reaction which is more fully described in W. Horspool and D. Armesto, Organic Photochemistry: A Comprehensive Treatment, Ellis Horwood Limited, Chichester, England, 1992; J. Kopecky, Organic Photochemistry: A Visual Approach, VCH Publishers, Inc., New York, N.Y. 1992; N. J. Turro, et al., Acc. Chem. Res., 1972, 5, 92; and J. T. Banks, et al., J. Am. Chem. Soc., 1993, 115, 2473. The synthesis of monoacetals of aromatic 1,2 diketones, Ar—CO—C(OR)₂—Ar′ is described in U.S. Pat. No. 4,190,602 and Ger. Offen. 2,337,813. The preferred compound from this class is 2,2-dimethoxy-2-phenylacetophenone. C₆H₅—CO—C(OCH₃)₂—C₆H₅, which is commercially available from Ciba-Geigy as Irgacure 651. Examples of other aromatic ketones useful as photoinitiators are Irgacure 184, 369, 819, 907 and 2959, all available from Ciba-Geigy.

In one embodiment of the invention, the photoinitiator is used in combination with a photocrosslinker. Any photocrosslinker that will upon the generation of free radicals, link two or more olefin polymer backbones together through the formation of covalent bonds with the backbones can be used. Preferably these photocrosslinkers are polyfunctional, i.e., they comprise two or more sites that upon activation will form a covalent bond with a site on the backbone of the copolymer. Representative photocrosslinkers include, but are not limited to polyfunctional vinyl or allyl compounds such as, for example, triallyl cyanurate, triallyl isocyanurate, pentaerthritol tetramethacrylate, ethylene glycol dimethacrylate, diallyl maleate, dipropargyl maleate, dipropargyl monoallyl cyanurate and the like. Preferred photocrosslinkers for use in some embodiments of the invention are compounds which have polyfunctional (i.e. at least two) moieties. Particularly preferred photocrosslinkers are triallycyanurate (TAC) and triallylisocyanurate (TAIL).

Certain compounds act as both a photoinitiator and a photocrosslinker. These compounds are characterized by the ability to generate two or more reactive species (e.g., free radicals, carbenes, nitrenes, etc.) upon exposure to UV-light and to subsequently covalently bond with two polymer chains. Any compound that can preform these two functions can be used in some embodiments of the invention, and representative compounds include the sulfonyl azides described in U.S. Pat. Nos. 6,211,302 and 6,284,842.

In another embodiment of this invention, the copolymer is subjected to secondary crosslinking, i.e., crosslinking other than and in addition to photocrosslinking In this embodiment, the photoinitiator is used either in combination with a nonphotocrosslinker, e.g., a silane, or the copolymer is subjected to a secondary crosslinking procedure, e.g, exposure to E-beam radiation. Representative examples of silane crosslinkers are described in U.S. Pat. No. 5,824,718, and crosslinking through exposure to E-beam radiation is described in U.S. Pat. Nos. 5,525,257 and 5,324,576. The use of a photocrosslinker in this embodiment is optional.

At least one photoadditive, i.e., photoinitiator and optional photocrosslinker, can be introduced to the copolymer by any method known in the art. However, preferably the photoadditive(s) is (are) introduced via a masterbatch concentrate comprising the same or different base resin as the copolymer. Preferably, the photoadditive concentration for the masterbatch is relatively high e.g., about 25 weight percent (based on the total weight of the concentrate).

The at least one photoadditive is introduced to the copolymer in any effective amount. Preferably, the at least one photoadditive introduction amount is from about 0.001 to about 5, more preferably from about 0.005 to about 2.5 and most preferably from about 0.015 to about 1, wt % (based on the total weight of the copolymer).

The photoinitiator(s) and optional photocrosslinker(s) can be added during different stages of the fiber or film manufacturing process. If photoadditives can withstand the extrusion temperature, an olefin polymer resin can be mixed with additives before being fed into the extruder, e.g., via a masterbatch addition. Alternatively, additives can be introduced into the extruder just prior the slot die, but in this case the efficient mixing of components before extrusion is important. In another approach, olefin polymer fibers can be drawn without photoadditives, and a photoinitiator and/or photocrosslinker can be applied to the extruded fiber via a kiss-roll, spray, dipping into a solution with additives, or by using other industrial methods for post-treatment. The resulting fiber with photoadditive(s) is then cured via electromagnetic radiation in a continuous or batch process. The photo additives can be blended with an olefin polymer using conventional compounding equipment, including single and twin-screw extruders.

The power of the electromagnetic radiation and the irradiation time are chosen so as to allow efficient crosslinking without polymer degradation and/or dimensional defects. The preferred process is described in EP 0 490 854 B1. Photoadditive(s) with sufficient thermal stability is (are) premixed with an olefin polymer resin, extruded into a fiber, and irradiated in a continuous process using one energy source or several units linked in a series. There are several advantages to using a continuous process compared with a batch process to cure a fiber or sheet of a knitted fabric which are collected onto a spool.

Irradiation may be accomplished by the use of UV-radiation. Preferably, UV-radiation is employed up to the intensity of 100 J/cm². The irradiation source can be any UV-light generator operating in a range of about 50 watts to about 25000 watts with a power output capable of supplying the desired dosage. The wattage can be adjusted to appropriate levels which may be, for example, 1000 watts or 4800 watts or 6000 watts or higher or lower. Many other apparati for UV-irradiating polymeric materials are known in the art. The irradiation is usually carried out at a dosage between about 3 J/cm² to about 500 J/scm², preferably between about 5 J/cm² to about 100 J/cm². Further, the irradiation can be carried out conveniently at room temperature, although higher and lower temperatures, for example 0° C. to about 60° C., may also be employed. The photocrosslinking process is faster at higher temperatures. Preferably, the irradiation is carried out after shaping or fabrication of the article. In a preferred embodiment, the copolymer which has been incorporated with a photoadditive is irradiated with UV-radiation at about 10 J/cm² to about 50 J/cm².

### Other Additives

Antioxidants, e.g., Irgafos 168, Irganox 1010, Irganox 3790, and chimassorb 944 made by Ciba Geigy Corp., may be added to the ethylene polymer to protect against undo degradation during shaping or fabrication operation and/or to better control the extent of grafting or crosslinking (i.e., inhibit excessive gelation). In-process additives, e.g. calcium stearate, water, fluoropolymers, etc., may also be used for purposes such as for the deactivation of residual catalyst and/or improved processability. Tinuvin 770 (from Ciba-Geigy) can be used as a light stabilizer.

The copolymer can be filled or unfilled. If filled, then the amount of filler present should not exceed an amount that would adversely affect either heat-resistance or elasticity at an elevated temperature. If present, typically the amount of filler is between 0.01 and 80 wt % based on the total weight of the copolymer (or if a blend of a copolymer and one or more other polymers, then the total weight of the blend). Representative fillers include kaolin clay, magnesium hydroxide, zinc oxide, silica and calcium carbonate. In a preferred embodiment, in which a filler is present, the filler is coated with a material that will prevent or retard any tendency that the filler might otherwise have to interfere with the crosslinking reactions. Stearic acid is illustrative of such a filler coating.

To reduced the friction coefficient of the fibers, various spin finish formulations can be used, such as metallic soaps dispersed in textile oils (see for example U.S. Pat. No. 3,039,895 or U.S. Pat. No. 6,652,599), surfactants in a base oil (see for example US publication 2003/0024052) and polyalkylsiloxanes (see for example U.S. Pat. No. 3,296,063 or U.S. Pat. No. 4,999,120). U.S. patent application Ser. No. 10/933,721 (published as US20050142360) discloses spin finish compositions that can also be used.

The following examples are presented to exemplify embodiments of the invention but are not intended to limit the invention to the specific embodiments set forth. Unless indicated to the contrary, all parts and percentages are by weight. All numerical values are approximate. When numerical ranges are given, it should be understood that embodiments outside the stated ranges may still fall within the scope of the invention. Specific details described in each example should not be construed as necessary features of the invention.

### Examples

Spunbond nonwoven fabrics samples consisting of Example 1 to example 81c in Table IV, Table V and Table VI have been produced utilizing Reicofil 4 spunbond technology from Reicofil. The technology consists of a 1.2 meter wide spunbond line which have 2 separate extruders supplying a bicomponent spin beam configuration via and individual spinpump for each extruder.

Spunbond nonwoven fabric are produced by melting the polymer via an extruder which maintains a constant pressure of 60 bars onto a meltpump which delivers a meltfront to a spinbeam consisting of polymer melt die for delivering a uniform melt at a constant pressure to distribution plates and the spinnerette. The spinnerette design in this trial consists of 6827 holes/meter with and hole diameter of 0.6 mm and a L/D ratio of 4. Throughput is varied from 0.44 ghm to 0.72 ghm and fiber deniers is varied from 1.6 denier to 2.2 denier.

The molten polymer is exiting the spinnerette (6827 fibers per meter) and is then accelerated and stretched via airflow to produce the specific denier fibers indicated above. The air flow and temperature of the air is controlled in order to obtain optimum fiber properties. The fibers that have been stretched and cooled are then randomly layed on a webbelt which is located underneath the spinbeam and delivers the unbonded fibers to the bonding unit which consists of a calendared roll and a smooth roll. The examples in Table IV, Table V and Table VI are bonded at calendar oil temperatures varying from 70° C. to 125° C.

Meltblown nonwoven fabrics samples consisting of Example 82 to example 84 in Table VII, Table VIII, Table IX and Table X have been produced using a 1.2 meter wide J&M bicomponent meltblown die. The die used has 35 holes/per inch with a 0.4 mm diameter holes with a L/D of 10. The die was fed by two Davis Standard Fibermaster extruders (A-side 3.0″ in diameter and B-side 2.0″ in diameter). Bonding of the fabric was done using a calendar roll with 15% bonding area and using a oval design with calendar oil temperature set at 105° C. Nip roll pressure was set at 15 N/mm Line-speed was 7 meters per minute.

As demonstrated above, embodiments of the invention provide fibers made from unique multi-block copolymers of ethylene and α-olefin. The fibers may have one or more of the following advantages: good abrasion resistance; low coefficient of friction; high upper service temperature; high recovery/retractive force; low stress relaxation (high and low temperatures); soft stretch; high elongation at break; inert: chemical resistance; UV resistance. The fibers can be melt spun at a relatively high spin rate and lower temperature. The fibers can be crosslinked by electron beam or other irradiation methods. In addition, the fibers are less sticky, resulting in better unwind performance and better shelf life, and are substantially free of roping (i.e., fiber bundling, self-adhesion, self-sticking). Because the fibers can be spun at a higher spin rate, the fibers' production throughput is high. Such fibers also have broad formation windows and broad processing windows. Other advantages and characteristics are apparent to those skilled in the art.

Though not intended to be limited by theory, it is thought that greater usage of one or more relatively stiff and less elastic components in fibers can result in one or more of the following fabric characteristics:

(a) decreased elongation at peak force

(b) increased peak force

(c) increased permanent set

(d) increased retractive force measured as load down.

Though not intended to be limited by theory, it is further thought that usage of one or more components with greater elasticity can result in the diminished or sometimes even the reverse effects listed above for fabric.

For the fiber and fabric processes described herein and elsewhere, it is recognized that one of average skill in the art is capable of selecting and combining conversion technologies, adjusting material and process parameters when appropriate to produce product with the desired economics and performance characteristics. These parameters include but are not limited to material selection, fiber composition, formulation, fiber design, process conditions, and post-processing treatments. These parameters can further affect aspects of energy consumption, productivity, materials handling, subsequent product conversion steps, and end-use properties. For example, one of average skill in the art can recognize that the fibers and fabrics of the current invention can be fabricated using a series of fiber spinning units generally described as S(SₓM_{y})S such that S denotes a spunbond beam, M denotes a melt blown beam, and x and y are 0 or positive integers. This includes SSS, SMS, SMMS, SMMMS, SSMMSS, SSMMMS etc. Such machine configures can produce composite nonwoven structures with at least one of the following benefits: higher throughput, enhanced barrier, reduced need for adhesives, and reduced waste. The configurations above can also include a combination of Monocomponent and Bicomponent produced on different Spunbond and Meltblown beams in series in order to obtain specific properties like improved haptics while maintaining other properties like elasticity

While the invention has been described with respect to a limited number of embodiments, the specific features of one embodiment should not be attributed to other embodiments of the invention. No single embodiment is representative of all aspects of the invention. In some embodiments, the compositions or methods may include numerous compounds or steps not mentioned herein. In other embodiments, the compositions or methods do not include, or are substantially free of, any compounds or steps not enumerated herein. While some embodiments are described as comprising “at least” one component or step, other embodiments may include one and only such component or step. Variations and modifications from the described embodiments exist. The method of making the resins is described as comprising a number of acts or steps. These steps or acts may be practiced in any sequence or order unless otherwise indicated.

Finally, any number disclosed herein should be construed to mean approximate, regardless of whether the word “about” or “approximately” is used in describing the number. The appended claims intend to cover all those modifications and variations as falling within the scope of the invention.

TABLE I
Process Conditions

| | | | | | | Cat | Cat | Cat | Cat | | |
|---|---|---|---|---|---|---|---|---|---|---|---|
| | | | | | | A1 | A1 | B2 | B2 | DEZ* | DEZ* |
| | C₂H₄ | C₈H₁₆ | Solv | H₂ | T | Conc | Flow | Conc | Flow | Conc | Flow |
| Designation | (lb/hr) | (lb/hr) | (lb/hr) | (sccm) | (° C.) | (ppm) | (lb/hr) | (ppm) | (lb/hr) | (wt %) | (lb/hr) |
| OBC-1 | 154.3 | 95.8 | 1209.5 | 2493 | 125 | 600 | 1.73 | 100 | 2.54 | 3.0 | 1.85 |
| OBC-2 | 163.1 | 78.5 | 1200.6 | 2542 | 125 | 600 | 1.75 | 100 | 2.6 | 3.0 | 1.85 |
| OBC-3 | 149 | 89.5 | 1214.3 | 1755 | 120 | 575 | 2.2 | 100 | 3.08 | 5.0 | 1.97 |
| OBC-4 | 160.3 | 67.3 | 1201.4 | 2756 | 124.5 | 600 | 1.88 | 100 | 2.76 | 3.0 | 1.74 |

| | | | | | | | | | Cat Eff |
|---|---|---|---|---|---|---|---|---|---|
| | Cocat | Cocat | Additive | Additive | [Zn] in | Poly | | | (MMlb |
| | Conc | Flow | Conc | Flow | polymer | Rate | Conv | Polymer | poly/lb |
| Designation | (ppm) | (lb/hr) | (ppm) | (lb/hr) | (ppm) | (lb/hr) | (wt %) | (wt %) | metal) |
| OBC-1 | 8000 | 1.52 | 14250 | 0.68 | 240 | 262 | 89.9 | 17.7 | 0.202 |
| OBC-2 | 8000 | 1.54 | 9000 | 1.07 | 240 | 231 | 90.5 | 17.1 | 0.176 |
| OBC-3 | 5700 | 2.57 | 2356 | 1.19 | 400 | 232 | 91.2 | 17.3 | 0.147 |
| OBC-4 | 8000 | 1.65 | 14250 | 0.7 | 240 | 235 | 88.1 | 16.4 | 0.168 |

Notes:
Cat A1 concentration is given in ppm Hf.
Cat B2 concentration is given in ppm Zr.
Cocatalyst concentration is given in ppm.
Additive is MMAO for OBC-3 and is TEA for the other runs. MMAO conc is in ppm A1.
TEA conc is in ppm TEA.
Catalyst efficiency is given in MMlbs polymer produced per lb of combined Hf and Zr.
*Diethylzinc

TABLE II
Properties of Olefin Block Copolymers

| | | | | | | | | | | | | NMR ¹³C | | | | | |
|---|---|---|---|---|---|---|---|---|---|---|---|---|---|---|---|---|---|
| | | | | | | | | | | | | | Soft | Hard | | | Mechani- |
| | Density | Melt Index | | | | | DSC | | | | | Total | Seg- | Seg- | % Soft | % Hard | cal |
| | ASTM | I₂^{a} | I₁₀^{b} | | GPC | | | | | Heat of | Cryst | C8 | ment | ment | Seg- | Seg- | 2% Secant |
| Desig- | D792 | (g/10 | (g/10 | I₁₀/ | Mw | Mw/ | Tc | Tm | Tg | Fusion | (wt | (mol | C8 | C8 | ment | ment | Modulus |
| nation | (g/cm²) | min) | min) | I₂ | (g/mol) | Mn | (° C.) | (° C.) | (° C.) | (J/g) | %) | %) | (mol %) | (mol %) | (wt. %) | (wt. %) | (MPa) |
| OBC-1 | 0.8796 | 22.1 | 168.9 | 7.6 | 57940 | 2.3 | 104.3 | 120.1 | −63.4 | 55.3 | 19 | 12.61 | 18.10 | 0.86 | 75 | 25 | 35 |
| OBC-2 | 0.8860 | 24.1 | 170.8 | 7.1 | 52430 | 2.2 | 106.2 | 121.0 | −58.1 | 75.2 | 26 | 10.17 | 15.50 | 0.72 | 70 | 30 | 52 |
| OBC-3 | 0.8775 | 14.6 | 102.2 | 7.0 | 61850 | 2.3 | 103.2 | 122.5 | −60.0 | 57.9 | 20 | 11.66 | 14.7 | 0.67 | 84 | 16 | 30 |
| OBC-4 | 0.8895 | 21.3 | 153.0 | 7.2 | 53360 | 2.2 | 105.4 | 122.6 | −56.2 | 85.2 | 29 | 9.03 | 13.30 | 0.60 | 71 | 29 | 63 |

^{a}melt index measured at 190° C. and 2.16 kg for polyethylene (ASTM D 1238-00)
^{b}melt index measured at 190° C. and 10 kg for polyethylene (ASTM D 1238-00)
‘C8’ denotes 1-octene
‘Cryst’ denotes crystallinity as measured using DSC.
‘mol %’ denotes mole percent as measured using NMR ¹³C
‘wt. %’ denotes percentage by weight

TABLE III
Properties of Other Polymers

| | | | | | | | | | | | | | Mechani- |
|---|---|---|---|---|---|---|---|---|---|---|---|---|---|
| | | | | | | | | DSC | | | | | cal |
| | | Density | Melt Index | | | GPC | | | | | Heat of | | 2% Secant |
| | | ASTM D792 | I₂ | I10 | | Mw | Mw/ | Tc | Tm | Tg | Fusion | Cryst | Modulus |
| Designation | Description | (g/cc) | (g/10 min) | (g/10 min) | I10/I2 | (g/mol) | Mn | (° C.) | (° C.) | (° C.) | (J/g) | (wt %) | (MPa) |
| P/E-1 | propylene- | 0.867 | 25^{a} | — | — | — | — | 19.8 | 95.2 | −27.7 | 30.6 | 19 | 35 |
| | ethylene | | | | | | | | | | | | |
| | copolymer | | | | | | | | | | | | |
| PE-1 | polyethylene | 0.950 | 17^{c} | — | — | — | — | — | — | — | — | — | 993 |
| PE-2 | polyethylene | 0.950 | 17^{c} | — | — | 58336 | 3.3 | 114.2 | 129.4 | — | 193.4 | 67 | 993 |
| PE-3 | polyethylene | 0.935 | 19^{c} | 129.2^{b} | 6.8 | 52100 | 2.8 | — | — | — | — | — | 550 |
| PP-1 | homopolymer | 0.880 | 25^{c} | — | — | 179950 | 2.8 | 117.1 | 161.0 | −7.6 | 109.7 | 66 | 1200 |
| | polypropylene | | | | | | | | | | | | |

^{a}melt index measured at 190° C. and 2.16 kg for polyethylene (ASTM D 1238-00)
^{b}melt index measured at 190° C. and 10 kg for polyethylene (ASTM D 1238-00)
^{c}melt index measured at 230° C. and 2.16 kg for polypropylene (ASTM D 1238-00)
‘C8’ denotes 1-octene
‘Cryst’ denotes crystallinity as measured using DSC.
‘mol %’ denotes mole percent as measured using NMR ¹³C
‘wt. %’ denotes percentage by weight

TABLE IV
Spunbond Fabric Examples

| | | | | | throughput per | line speed | | melt temp. | melt temp. | process air |
|---|---|---|---|---|---|---|---|---|---|---|
| | Core | Sheath | Core | Sheath | hole [g/ | [m/ | extruder temp. | spinneret | spinneret | volume Q1 |
| Example | Resin | Resin | (wt. %) | (Wt %) | min * hole] | min] | C1/C2 [° C.] | C1 [° C.] | C2 [° C.] | [m³/h] |
| 1 | OBC-1 | PE-1 | 90 | 10 | 0.53 | 135 | 225 | 226 | 228 | 1453 |
| 2 | OBC-1 | PE-1 | 90 | 10 | 0.53 | 68 | 225 | 226 | 229 | 943 |
| 3 | OBC-1 | PE-1 | 90 | 10 | 0.53 | 70 | 225 | 226 | 230 | 1264 |
| 4 | OBC-1 | PE-1 | 90 | 10 | 0.53 | 175 | 225 | 226 | 230 | 1264 |
| 5 | OBC-1 | PE-1 | 90 | 10 | 0.53 | 70 | 225 | 226 | 229 | 1273 |
| 6 | OBC-1 | PE-1 | 80 | 20 | 0.53 | 70 | 225 | 226 | 323 | 1144 |
| 7 | OBC-1 | PE-1 | 80 | 20 | 0.53 | 70 | 225 | 226 | 233 | 1101 |
| 8 | OBC-1 | PE-1 | 70 | 30 | 0.53 | 70 | 225 | 226 | 234 | 1114 |
| 9 | OBC-1 | PE-1 | 80 | 20 | 0.53 | 70 | 225 | 226 | 233 | 1101 |
| 10 | OBC-1 | PE-1 | 90 | 10 | 0.53 | 70 | 225 | 226 | 232 | 1087 |
| 11 | OBC-1 | PE-1 | 90 | 10 | 0.53 | 70 | 225 | 226 | 230 | 1081 |
| 12 | OBC-1 | PE-1 | 80 | 20 | 0.53 | 70 | 225 | 226 | 232 | 1079 |
| 13 | OBC-1 | PE-1 | 70 | 30 | 0.53 | 70 | 225 | 226 | 234 | 1091 |
| 14 | OBC-1 | PE-1 | 90 | 10 | 0.53 | 70 | 225 | 225 | 229 | 1023 |
| 15 | OBC-1 | PE-1 | 80 | 20 | 0.53 | 70 | 225 | 225 | 231 | 1016 |
| 16 | OBC-1 | PE-1 | 70 | 30 | 0.53 | 70 | 225 | 226 | 233 | 1014 |
| 17 | OBC-1 | PE-1 | 90 | 10 | 0.53 | 70 | 225 | 226 | 230 | 1019 |
| 19 | OBC-1 | PE-1 | 70 | 30 | 0.53 | 70 | 225 | 226 | 233 | 1007 |
| 32 | OBC-2 | PP-1 | 90 | 10 | 0.53 | 70 | 225 | 225 | 229 | 1088 |
| 34 | OBC-2 | PP-1 | 70 | 30 | 0.53 | 70 | 225 | 225 | 231 | 1081 |
| 44 | OBC-2 | PE-1 | 70 | 30 | 0.53 | 70 | 225 | 225 | 226 | 68 |
| 46 | OBC-2 | PE-1 | 90 | 10 | 0.53 | 70 | 225 | 225 | 226 | 36 |
| 47 | OBC-3 | PE-1 | 90 | 10 | 0.53 | 70 | 225 | 225 | 225 | 37 |
| 49 | OBC-3 | PE-1 | 70 | 30 | 0.53 | 70 | 225 | 225 | 225 | 69 |
| 50 | OBC-4 | PE-1 | 90 | 10 | 0.53 | 70 | 225 | 225 | 226 | 37 |
| 52 | OBC-4 | PE-1 | 70 | 30 | 0.53 | 70 | 225 | 225 | 226 | 69 |
| 53 | OBC-4 | PE-1 | 70 | 30 | 0.73 | 96 | 225 | 225 | 226 | 88 |
| 54 | OBC-4 | PE-1 | 90 | 10 | 0.73 | 96 | 225 | 225 | 225 | 48 |
| 55c | PP-1 | PP-1 | 80 | 20 | 0.53 | 185 | 245 | 250 | 250 | 1108 |
| 56c | PP-1 | PP-1 | 80 | 20 | 0.53 | 185 | 245 | 250 | 250 | 1107 |
| 57c | PP-1 | PE-2 | 70 | 30 | 0.53 | 177 | 245 | 250 | 230 | 1338 |
| 58c | PP-1 | PE-2 | 70 | 30 | 0.53 | 177 | 245 | 250 | 230 | 1345 |
| 59c | PP-1 | PE-2 | 70 | 30 | 0.53 | 173 | 245 | 250 | 230 | 1341 |
| 60c | PP-1 | PE-2 | 70 | 30 | 0.53 | 173 | 245 | 250 | 230 | 1341 |
| 61c | PP-1 | PE-2 | 70 | 30 | 0.53 | 173 | 245 | 250 | 230 | 1338 |
| 62 | PP-1 | OBC-3 | 70 | 30 | 0.53 | (47) | 245 | 250 | 230 | n/a |
| 63 | OBC-3 | OBC-3 | 70 | 30 | 0.53 | 25 | 225 | 230 | 230 | 1121 |
| 64 | OBC-3 | OBC-3 | 70 | 30 | 0.53 | 25 | 225 | 230 | 230 | 980 |
| 65 | OBC-3 | PE-2 | 90 | 10 | 0.49 | 31 | 225 | 230 | 230 | 978 |
| 66 | OBC-3 | PE-2 | 90 | 10 | 0.49 | 33.2 | 225 | 230 | 230 | 994 |
| 67 | OBC-3 | PE-2 | 90 | 10 | 0.49 | 42.2 | 225 | 230 | 230 | 990 |
| 68 | OBC-3 | PE-2 | 90 | 10 | 0.49 | 56.3 | 225 | 230 | 230 | 984 |
| 69 | OBC-3 | PE-2 | 90 | 10 | 0.53 | 36.5 | 225 | 230 | 230 | 1000 |
| 70 | OBC-3 | PE-3 | 90 | 10 | 0.53 | 36.5 | 225 | 230 | 230 | 984 |
| 71 | OBC-3 | PE-3 | 90 | 10 | 0.49 | 33.2 | 225 | 230 | 230 | 1034 |
| 72 | OBC-3 | PE-3 | 90 | 10 | 0.49 | 42.2 | 225 | 230 | 230 | 1078 |
| 73 | OBC-3 | PE-3 | 90 | 10 | 0.49 | 56.3 | 225 | 230 | 230 | 1071 |
| 74c | P/E-1 | PE-3 | 90 | 10 | 0.44 | 30.5 | 235 | 240 | 230 | 668 |
| 75c | P/E-1 | PE-2 | 90 | 10 | 0.44 | 30.5 | 235 | 240 | 230 | 635 |
| 76c | P/E-1 | PE-2 | 90 | 10 | 0.44 | 38.0 | 235 | 240 | 230 | 624 |
| 77c | P/E-1 | PE-2 | 90 | 10 | 0.44 | 50.0 | 235 | 240 | 230 | 632 |
| 78c | PE-3 | PE-3 | 60 | 40 | 0.53 | 88.0 | 225 | 230 | 230 | 875 |
| 79c | PE-3 | PE-3 | 60 | 40 | 0.53 | 173 | 225 | 230 | 230 | 839 |
| 80c | PE-3 | PE-3 | 60 | 40 | 0.53 | 173 | 225 | 230 | 230 | 835 |
| 81c | PE-3 | PE-3 | 60 | 40 | 0.53 | 173 | 225 | 230 | 230 | 859 |

| | process air | quench air | cabin | nip | engraved | HOT-S-roll | fabric |
|---|---|---|---|---|---|---|---|
| | volume Q1 | temp. Q1 | pressure | pressure | roll temp. | temp. | weight |
| Example | [m³/h] | [° C.] | (SET) [Pa] | [N/mm] | (oil) [° C.] | (oil) [° C.] | (SET) [gsm] |
| 1 | 5052 | 30 | 2000 | 60 | 90 | 90 | 54.24 |
| 2 | 3906 | 30 | 2000 | 40 | 90 | 90 | 51.4 |
| 3 | 5707 | 30 | 4500 | 40 | 85 | 85 | 53.0 |
| 4 | 5707 | 30 | 4500 | 40 | 85 | 85 | 22.7 |
| 5 | 5391 | 30 | 4500 | 40 | 85 | 85 | 53.4 |
| 6 | 5608 | 30 | 4500 | 40 | 85 | 85 | 53.5 |
| 7 | 5616 | 28 | 4500 | 40 | 85 | 85 | 53.6 |
| 8 | 5647 | 28 | 4500 | 40 | 90 | 90 | 52.5 |
| 9 | 5616 | 28 | 4500 | 40 | 90 | 90 | 53.7 |
| 10 | 5556 | 28 | 4500 | 40 | 90 | 90 | 53.9 |
| 11 | 5603 | 28 | 4500 | 40 | 95 | 93 | 54.3 |
| 12 | 5638 | 28 | 4500 | 40 | 95 | 93 | 54.6 |
| 13 | 5573 | 28 | 4500 | 40 | 95 | 93 | 53.0 |
| 14 | 5729 | 28 | 4500 | 40 | 105 | 102 | 53.9 |
| 15 | 5707 | 28 | 4500 | 40 | 105 | 103 | 53.1 |
| 16 | 5642 | 28 | 4500 | 40 | 105 | 103 | 52.3 |
| 17 | 5660 | 28 | 4500 | 40 | 115 | 113 | 55.7 |
| 19 | 5616 | 28 | 4500 | 40 | 115 | 113 | 53.1 |
| 32 | 5534 | 28 | 4500 | 40 | 115 | 113 | 52.0 |
| 34 | 5582 | 28 | 4500 | 40 | 115 | 113 | 52.33 |
| 44 | 220 | 28 | 4500 | 40 | 115 | 113 | 39.8 |
| 46 | 253 | 28 | 4500 | 40 | 115 | 113 | 18.0 |
| 47 | 492 | 28 | 4500 | 40 | 115 | 113 | 24.3 |
| 49 | 480 | 28 | 4500 | 40 | 115 | 113 | 47.2 |
| 50 | 615 | 28 | 4500 | 40 | 115 | 113 | 24.1 |
| 52 | 602 | 28 | 4500 | 40 | 115 | 113 | 41.5 |
| 53 | 447 | 28 | 4500 | 40 | 115 | 113 | 34.2 |
| 54 | 469 | 28 | 4500 | 40 | 115 | 113 | 17.5 |
| 55c | 4900 | 30 | 3000 | 60 | 155 | 155 | 19.2 |
| 56c | 4887 | 30 | 3000 | 60 | 145 | 145 | 19.0 |
| 57c | 5864 | 30 | 4500 | 50 | 122 | 120 | 19.3 |
| 58c | 5846 | 30 | 4500 | 60 | 125 | 123 | 19.5 |
| 59c | 5825 | 30 | 4500 | 60 | 130 | 128 | 19.8 |
| 60c | 5812 | 30 | 4500 | 60 | 133 | 131 | 20.0 |
| 61c | 5803 | 30 | 4500 | 60 | 136 | 134 | 19.8 |
| 62 | n/a | 30 | 2500 | 50 | 110 | 110 | 73.4 |
| 63 | 4970 | 30 | 3000 | 30 | 70 | 78 | 137.0 |
| 64 | 4350 | 30 | 2500 | 30 | 70 | 75 | 138.4 |
| 65 | 4379 | 30 | 2500 | 30 | 70 | 72 | 132.9 |
| 66 | 4327 | 30 | 2500 | 30 | 70 | 72 | 101.1 |
| 67 | 4249 | 30 | 2500 | 30 | 70 | 72 | 80.5 |
| 68 | 4275 | 30 | 2500 | 30 | 70 | 72 | 59.3 |
| 69 | 4605 | 30 | 2500 | 30 | 70 | 70 | 99.7 |
| 70 | 4540 | 30 | 2500 | 30 | 70 | 70 | 100.6 |
| 71 | 4596 | 30 | 2500 | 30 | 70 | 70 | 95.2 |
| 72 | 4531 | 30 | 2500 | 30 | 70 | 70 | 75.0 |
| 73 | 4501 | 30 | 2500 | 30 | 70 | 70 | 56.3 |
| 74c | 2886 | 30 | 1000 | 30 | 70 | 70 | 88.9 |
| 75c | 2960 | 30 | 1000 | 30 | 70 | 70 | 92.7 |
| 76c | 2925 | 30 | 1000 | 30 | 70 | 70 | 72.2 |
| 77c | 2930 | 30 | 1000 | 30 | 70 | 70 | 55.4 |
| 78c | 3924 | 30 | 2000 | 60 | 120 | 120 | 39.2 |
| 79c | 4032 | 30 | 2000 | 60 | 120 | 120 | 19.2 |
| 80c | 4036 | 30 | 2000 | 60 | 125 | 125 | 19.4 |
| 81c | 4023 | 30 | 2000 | 60 | 130 | 130 | 18.9 |

‘n/a’—denotes not available
‘c’—denotes comparative example

TABLE V
Mechanical Properties of Spunbond Fabrics

| | | | | | | | | | Hysteresis | | | |
|---|---|---|---|---|---|---|---|---|---|---|---|---|
| | Tensile | | | | | | | | MD | | | |
| | MD | | | | CD | | | | | | Load | |
| | | | Peak | | | | Peak | | Set, | | Down, | |
| Ex- | Elongation, | | Force | | Elongation, | | Force | | MD | | 50% | |
| ample | (%) | stdev | (N) | stdev | (%) | stdev | (N) | stdev | (%) | stdev | (N) | stdev |
| 1 | — | — | — | — | — | — | — | — | — | — | — | — |
| 2 | — | — | — | — | — | — | — | — | — | — | — | — |
| 3 | — | — | — | — | — | — | — | — | — | — | — | — |
| 4 | — | — | — | — | — | — | — | — | — | — | — | — |
| 5 | 187 | 6 | 16.3 | 0.2 | 211 | 9 | 8.5 | 0.4 | 17 | 1 | 1.0 | 0.0 |
| 6 | — | — | — | — | — | — | — | — | — | — | — | — |
| 7 | 131 | 16 | 26.7 | 1.7 | 183 | 4 | 8.4 | 0.1 | 32 | 3 | 0.4 | 0.4 |
| 8 | — | — | — | — | — | — | — | — | — | — | — | — |
| 9 | 157 | 14 | 17.0 | 0.7 | 190 | 6 | 8.0 | 0.3 | 26 | 1 | 0.7 | 0.0 |
| 10 | — | — | — | — | — | — | — | — | — | — | — | — |
| 11 | — | — | — | — | — | — | — | — | — | — | — | — |
| 12 | 141 | 8 | 15.5 | 0.3 | 168 | 12 | 7.3 | 0.3 | 27 | 2 | 0.6 | 0.2 |
| 13 | 92 | 5 | 20.7 | 0.4 | 172 | 5 | 7.6 | 0.4 | 32 | 1 | 0.5 | 0.1 |
| 14 | 171 | 20 | 11.3 | 1.2 | 173 | 7 | 5.6 | 0.3 | 16 | 0 | 0.8 | 0.0 |
| 15 | — | — | — | — | — | — | — | — | — | — | — | — |
| 16 | 99 | 10 | 25.1 | 1.0 | 167 | 11 | 7.1 | 0.3 | 33 | 1 | 0.5 | 0.2 |
| 17 | 128 | 9.02 | 8.3 | 0.51 | 163 | 13.2 | 4.36 | 0.3 | 16 | 1 | 0.7 | 0.0 |
| 18 | — | — | — | — | — | — | — | — | — | — | — | — |
| 19 | 91 | 6 | 17.3 | 0.6 | 5 | 3 | 0.2 | 0.0 | 31 | 0 | 0.5 | 0.0 |
| 20 | — | — | — | — | — | — | — | — | — | — | — | — |
| 21 | — | — | — | — | — | — | — | — | — | — | — | — |
| 22 | — | — | — | — | — | — | — | — | — | — | — | — |
| 23 | — | — | — | — | — | — | — | — | — | — | — | — |
| 24 | — | — | — | — | — | — | — | — | — | — | — | — |
| 25 | — | — | — | — | — | — | — | — | — | — | — | — |
| 26 | — | — | — | — | — | — | — | — | — | — | — | — |
| 27 | — | — | — | — | — | — | — | — | — | — | — | — |
| 28 | — | — | — | — | — | — | — | — | — | — | — | — |
| 29 | — | — | — | — | — | — | — | — | — | — | — | — |
| 30 | — | — | — | — | — | — | — | — | — | — | — | — |
| 31 | — | — | — | — | — | — | — | — | — | — | — | — |
| 32 | 8 | 11 | 0.6 | 0.0 | 4 | 5 | 0.7 | 0.1 | — | — | — | — |
| 33 | — | — | — | — | — | — | — | — | — | — | — | — |
| 34 | 4 | 6 | 1.1 | 0.0 | 2 | 3 | 0.5 | 0.0 | — | — | — | — |
| 35 | — | — | — | — | — | — | — | — | — | — | — | — |
| 36 | — | — | — | — | — | — | — | — | — | — | — | — |
| 37 | — | — | — | — | — | — | — | — | — | — | — | — |
| 38 | — | — | — | — | — | — | — | — | — | — | — | — |
| 39 | — | — | — | — | — | — | — | — | — | — | — | — |
| 40 | — | — | — | — | — | — | — | — | — | — | — | — |
| 41 | — | — | — | — | — | — | — | — | — | — | — | — |
| 42 | — | — | — | — | — | — | — | — | — | — | — | — |
| 43 | — | — | — | — | — | — | — | — | — | — | — | — |
| 44 | 8 | 8 | 0.6 | 0.0 | 152 | 12 | 7.5 | 0.2 | 30 | 1 | 0.7 | 0.1 |
| 45 | — | — | — | — | — | — | — | — | — | — | — | — |
| 46 | 15 | 10.2 | 0.4 | 0.04 | 154 | 13.6 | 4.69 | 0.5 | 16 | 0 | 0.9 | 0.0 |
| 47 | 5 | 3 | 0.7 | 0.1 | 176 | 21 | 6.3 | 0.2 | 17 | 0 | 1.1 | 0.0 |
| 48 | — | — | — | — | — | — | — | — | — | — | — | — |
| 49 | 2 | 2 | 1.3 | 0.0 | 5 | 3 | 0.2 | 0.0 | 29 | 0 | 1.0 | 0.1 |
| 50 | 3 | 2 | 0.9 | 0.1 | 13 | 8 | 0.7 | 0.1 | 17 | 0 | 1.0 | 0.0 |
| 51 | — | — | — | — | — | — | — | — | — | — | — | — |
| 52 | 101 | 13 | 22.1 | 1.4 | 17 | 11 | 0.7 | 0.1 | 29 | 0 | 0.8 | 0.1 |
| 53 | 94 | 4 | 18.4 | 0.2 | 129 | 12 | 7.3 | 0.6 | 31 | 1 | 0.5 | 0.1 |
| 54 | 152 | 8 | 10.5 | 0.2 | 172 | 5 | 5.6 | 0.3 | 18 | 1 | 0.8 | 0.1 |
| 62 | 89 | 6 | 18.4 | 1.0 | 114 | 9 | 20.9 | 1.0 | 44 | 0 | 0.0 | 0.0 |
| 63 | 12 | 1 | 0.2 | 0.0 | 496 | 4 | 0.6 | 0.1 | — | — | — | — |
| 64 | 97 | 36 | 0.6 | 0.0 | 210 | 10 | 0.9 | 0.1 | 43 | 1 | 0.0 | 0.0 |
| 65 | 252 | 22 | 20.2 | 0.8 | 282 | 35 | 14.2 | 1.1 | 20 | 0 | 1.6 | 0.1 |
| 66 | — | — | — | — | — | — | — | — | — | — | — | — |
| 67 | 223 | 26 | 11.4 | 0.7 | 245 | 18 | 8.1 | 0.3 | 20 | 0 | 0.9 | 0.1 |
| 68 | — | — | — | — | — | — | — | — | — | — | — | — |
| 69 | 214 | 25 | 14.4 | 1.9 | 244 | 4 | 10.5 | 0.2 | 21 | 0 | 0.9 | 0.1 |
| 70 | 220 | 17 | 12.6 | 1.1 | 251 | 29 | 9.0 | 0.5 | 18 | 0 | 1.0 | 0.1 |
| 71 | — | — | — | — | — | — | — | — | — | — | — | — |
| 72 | — | — | — | — | — | — | — | — | — | — | — | — |
| 73 | 186 | 10 | 6.8 | 0.8 | 205 | 25 | 5.0 | 0.2 | 10 | 9 | 0.7 | 0.0 |
| 55c | 48 | 9 | 15.8 | 1.7 | 47 | 9 | 9.8 | 1.9 | — | — | — | — |
| 56c | 43 | 4 | 14.3 | 1.5 | 48 | 5 | 8.9 | 0.2 | — | — | — | — |
| 57c | 16 | 2 | 9.8 | 0.4 | 31 | 5 | 3.0 | 0.3 | — | — | — | — |
| 58c | — | — | — | — | — | — | — | — | — | — | — | — |
| 59c | — | — | — | — | — | — | — | — | — | — | — | — |
| 60c | — | — | — | — | — | — | — | — | — | — | — | — |
| 61c | 70 | 6 | 22.3 | 1.4 | 110 | 12 | 10.0 | 0.6 | 44 | 0 | 0.0 | 0.0 |
| 74c | — | — | — | — | — | — | — | — | — | — | — | — |
| 75c | 281 | 19 | 8.5 | 0.1 | 241 | 33 | 6.3 | 0.3 | 20 | 1 | 0.9 | 0.1 |
| 76c | 222 | 41 | 6.4 | 0.7 | 247 | 24 | 4.6 | 0.2 | 21 | 0 | 0.6 | 0.0 |
| 77c | — | — | — | — | — | — | — | — | — | — | — | — |
| 78c | 83 | 8 | 12.4 | 0.5 | 99 | 6 | 6.5 | 0.1 | 35 | 4 | 0.1 | 0.0 |
| 79c | 79 | 3 | 5.2 | 0.1 | 97 | 4 | 3.3 | 0.2 | | | | |
| 80c | — | — | — | — | — | — | — | — | — | — | — | — |
| 81c | 64 | 14 | 4.5 | 0.8 | 106 | 9 | 3.6 | 0.3 | — | — | — | — |

| | Hysteresis | | | | RMS | | | |
|---|---|---|---|---|---|---|---|---|
| | CD | | | | | | | Load |
| | | | Load | | Elong | Peak | | Down, |
| | Set, | | Down, | | at | Force | Set | 50% |
| Example | (%) | stdev | 50% (N) | stdev | peak | (N/gsm) | (%) | (N/gsm) |
| 1 | — | — | — | — | | | — | — |
| 2 | — | — | — | — | | | — | — |
| 3 | — | — | — | — | | | — | — |
| 4 | — | — | — | — | | | — | — |
| 5 | 22 | 1 | 0.36 | 0.03 | 199 | 024 | 20 | 0.014 |
| 6 | — | — | — | — | | | — | — |
| 7 | 29 | 3 | 0.18 | 0.04 | 159 | 0.37 | 31 | 0.006 |
| 8 | — | — | — | — | | | — | — |
| 9 | 28 | 1 | 0.23 | 0.04 | 174 | 0.25 | 27 | 0.009 |
| 10 | — | — | — | — | | | — | — |
| 11 | — | — | — | — | | | — | — |
| 12 | 28 | 1 | 0.23 | 0.02 | 155 | 0.22 | 28 | 0.008 |
| 13 | 31 | 2 | 0.14 | 0.05 | 138 | 0.29 | 31 | 0.007 |
| 14 | 21 | 1 | 0.31 | 0.01 | 172 | 0.16 | 18 | 0.011 |
| 15 | — | — | — | — | | | — | — |
| 16 | 30 | 1 | 0.16 | 0.02 | 137 | 0.35 | 32 | 0.007 |
| 17 | 20 | 0 | 0.32 | 0.01 | 147 | 0.12 | 18 | 0.010 |
| 18 | — | — | — | — | | | — | — |
| 19 | 30 | 3 | 0.19 | 0.02 | 64 | 0.23 | 30 | 0.007 |
| 20 | — | — | — | — | | | — | — |
| 21 | — | — | — | — | | | — | — |
| 22 | — | — | — | — | | | — | — |
| 23 | — | — | — | — | | | — | — |
| 24 | — | — | — | — | | | — | — |
| 25 | — | — | — | — | | | — | — |
| 26 | — | — | — | — | | | — | — |
| 27 | — | — | — | — | | | — | — |
| 28 | — | — | — | — | | | — | — |
| 29 | — | — | — | — | | | — | — |
| 30 | — | — | — | — | | | — | — |
| 31 | — | — | — | — | | | — | — |
| 32 | 34 | 1 | 0.30 | 0.09 | 6 | 0.01 | — | — |
| 33 | — | — | — | — | — | — | — | — |
| 34 | — | — | — | — | 3 | 0.02 | — | — |
| 35 | — | — | — | — | — | — | — | — |
| 36 | — | — | — | — | — | — | — | — |
| 37 | — | — | — | — | — | — | — | — |
| 38 | — | — | — | — | — | — | — | — |
| 39 | — | — | — | — | — | — | — | — |
| 40 | — | — | — | — | — | — | — | — |
| 41 | — | — | — | — | — | — | — | — |
| 42 | — | — | — | — | — | — | — | — |
| 43 | — | — | — | — | — | — | — | — |
| 44 | 30 | 0 | 0.23 | 0.01 | 108 | 0.13 | 30 | 0.013 |
| 45 | — | — | — | — | — | — | — | — |
| 46 | 21 | 0 | 0.35 | 0.00 | 109 | 0.18 | 19 | 0.036 |
| 47 | 21 | 0 | 0.40 | 0.01 | 125 | 0.18 | 19 | 0.034 |
| 48 | — | — | — | — | — | — | — | — |
| 49 | 29 | 0 | 0.23 | 0.01 | 4 | 0.02 | 29 | 0.015 |
| 50 | 21 | 0 | 0.38 | 0.01 | 10 | 0.03 | 19 | 0.032 |
| 51 | — | — | — | — | — | — | — | — |
| 52 | 30 | 0 | 0.23 | 0.02 | 72 | 0.38 | 29 | 0.015 |
| 53 | 30 | 0 | 0.21 | 0.00 | 113 | 0.41 | 30 | 0.011 |
| 54 | 21 | 1 | 0.34 | 0.02 | 163 | 0.48 | 20 | 0.035 |
| 62 | 44 | 0 | −0.01 | 0.00 | 102 | 0.27 | 44 | 0.000 |
| 63 | 69 | 1 | −0.02 | 0.01 | 351 | 0.00 | — | — |
| 64 | 54 | 1 | −0.01 | 0.00 | 163 | 0.01 | — | — |
| 65 | 23 | 0 | 0.72 | 0.04 | 267 | 0.13 | 22 | 0.009 |
| 66 | — | — | — | — | — | — | — | — |
| 67 | 24 | 0 | 0.39 | 0.01 | 234 | 0.12 | 22 | 0.008 |
| 68 | — | — | — | — | — | — | — | — |
| 69 | 25 | 0 | 0.43 | 0.02 | 229 | 0.13 | 23 | 0.007 |
| 70 | 23 | 0 | 0.46 | 0.00 | 236 | 0.11 | 21 | 0.008 |
| 71 | — | — | — | — | — | — | — | — |
| 72 | — | — | — | — | — | — | — | — |
| 73 | 20 | 1 | 0.38 | 0.02 | 196 | 0.11 | 16 | 0.010 |
| 55c | — | — | — | — | 48 | 0.69 | — | — |
| 56c | — | — | — | — | 46 | 0.63 | — | — |
| 57c | — | — | — | — | 24 | 0.38 | — | — |
| 58c | — | — | — | — | — | — | — | — |
| 59c | — | — | — | — | — | — | — | — |
| 60c | — | — | — | — | — | — | — | — |
| 61c | 18 | 1 | 0.79 | 0.06 | 92 | 0.87 | 34 | 0.028 |
| 74c | — | — | — | — | — | — | — | — |
| 75c | 23 | 1 | 0.52 | 0.05 | 261 | 0.08 | 22 | 0.008 |
| 76c | 25 | 0 | 0.29 | 0.01 | 235 | 0.08 | 23 | 0.007 |
| 77c | — | — | — | — | — | — | — | — |
| 78c | 27 | 9 | 0.08 | 0.01 | 91 | 0.25 | 32 | 0.002 |
| 79c | 35 | 2 | 0.06 | 0.01 | 89 | 0.22 | 25 | 0.002 |
| 80c | — | — | — | — | — | — | — | — |
| 81c | 33 | 1 | 0.09 | 0.01 | 87 | 0.22 | 24 | 0.003 |

‘—’ denotes not measured.
‘c’ denotes comparative example

TABLE VI
Coefficient of Friction of Spunbond Examples.

| | Average Kinetic COF | | Average Static COF | |
|---|---|---|---|---|
| Example | (ASTM D 1894-06) | stdev | (ASTM D 1894-06) | stdev |
| 5 | 0.282 | 0.007 | 0.303 | 0.007 |
| 7 | 0.152 | 0.003 | 0.186 | 0.007 |
| 9 | 0.215 | 0.003 | 0.237 | 0.005 |
| 29 | 0.218 | 0.002 | 0.235 | 0.002 |
| 30 | 0.254 | 0.002 | 0.272 | 0.004 |
| 31 | 0.37 | 0.01 | 0.39 | 0.01 |
| 38 | 0.242 | 0.003 | 0.260 | 0.004 |
| 39 | 0.233 | 0.003 | 0.249 | 0.004 |
| 40 | 0.316 | 0.006 | 0.341 | 0.003 |
| 67 | 0.37 | 0.02 | 0.395 | 0.012 |
| 69 | 0.299 | 0.003 | 0.319 | 0.003 |
| 73 | 0.372 | 0.006 | 0.400 | 0.006 |
| 55c | 0.142 | 0.008 | 0.155 | 0.007 |
| 56c | 0.141 | 0.004 | 0.155 | 0.004 |
| 59c | 0.105 | 0.001 | 0.133 | 0.002 |
| 60c | 0.108 | 0.002 | 0.134 | 0.005 |
| 61c | 0.104 | 0.002 | 0.130 | 0.004 |
| 75c | 0.203 | 0.003 | 0.223 | 0.004 |
| 79c | 0.135 | 0.003 | 0.146 | 0.002 |
| 81c | 0.139 | 0.002 | 0.151 | 0.003 |

TABLE VII
Process Conditions for Meltblown Fabric Example 82..

| Polymer OBC-4 | | Units | Polymer OBC-4 | | Units |
|---|---|---|---|---|---|
| Extruder A | | | Extruder B | | |
| Melt | 438.4 | ° F. | Melt | 428.1 | ° F. |
| Pipe A | | | Pipe B | | |
| Melt | 458.6 | ° F. | Melt | 454.8 | ° F. |
| Die A | | | Die B | | |
| Pack Melt | 463.2 | ° F. | Pack Melt | 462.7 | ° F. |
| Number of Holes | 1497 | — | Hole Throughput | 0.2 | ghm |
| Spray Width | 45.5 | inches | Beam Throughput | 16.6 | kg/h |
| | | | Primary Throughput | 0.1 | ghm |
| Process Air (Outlet) | 574.7 | ° F. | Forming Table | 5.0 | M/min |
| Process Air (Die) | 478.0 | ° F. | Calender Engraved Roll | 80.6 | ° F. |
| Quench Air | 51.0 | ° F. | Calender Steel Roll | 123.8 | ° F. |
| Process Air A | 1.0 | psi | | | |
| Process Air B | 1.2 | psi | Winder | 5.0 | m/min |
| DCD | 10.0 | ” | Inside Temperature | 73.0 | ° F. |
| Extruder A | 9.0 | rpm | Outside Temperature | 75.3 | ° F. |
| Extruder B | 19.0 | rpm | US Spill Air Fan | | |
| Pump A | 6.0 | rpm | Flow Rate | 20500 | cfm |
| Pump B | 9.1 | rpm | Static Pressure | 4.0 | in. |
| | | | | | wg. |
| Process Air Blower | 1082.0 | rpm | Formation Fan | | |
| Flow | 20.0 | scfm | Flow Rate | 8250 | cfm |
| Quench Air Fan | 799.0 | rpm | | | |
| US Spill Air Fan | 895.0 | rpm | Basis Weight | 47.9 | gsm |
| Formation Fan | 902.0 | rpm | Total Throughput | 16.6 | kg/h |
| DS Spill Air Fan | 1803.0 | rpm | Total Basis Weight | 47.9 | gsm |

‘psi’ denotes pounds per square inch
‘rpm’ denotes rotations per minute
‘scfm’ denotes standard cubic feet per minute
‘ghm’ denotes grams per hole per minute
‘m/min’ denotes meters per minute
‘cfm’ denotes cubic feat per minute
Comment [GC4]: This is not and hence deleted it
‘kg/h’ denotes kilograms per hour
‘gsm’ denotes grams per square meter

TABLE VIIII
Process Conditions for Meltblown Fabric Example 83.

| Polymer OBC-4 | | | Polymer OBC-4 | | |
|---|---|---|---|---|---|
| | | Units | | | Units |
| Extruder A | | | Extruder B | | |
| Melt | 493.5 | ° F. | Melt | 478.7 | ° F. |
| Pipe A | | | Pipe B | | |
| Melt | 518.7 | ° F. | Melt | 512.2 | ° F. |
| Die A | | | Die B | | |
| Pack Melt | 511.7 | ° F. | Pack Melt | 511.3 | ° F. |
| Number of Holes | 1497 | — | Hole Throughput | 0.2 | ghm |
| Spray Width | 45.5 | inches | Beam Throughput | 16.5 | kg/h |
| | | | Primary Throughput | 0.1 | ghm |
| Process Air (Outlet) | 530.7 | ° F. | Forming Table | 5.0 | M/min |
| Process Air (Die) | 518.5 | ° F. | Calender Eng Roll | 75.2 | ° F. |
| Quench Air | 51.6 | ° F. | Calender Steel Roll | 102.2 | ° F. |
| Process Air A | 2.5 | psi | | | |
| Process Air B | 2.8 | psi | Winder | 5.0 | M/min |
| DCD | 22.0 | ” | Inside Temperature | 74.5 | ° F. |
| Extruder A | 9.0 | rpm | Outside Temperature | 80.5 | ° F. |
| Extruder B | 18.0 | rpm | US Spill Air Fan | | |
| Pump A | 6.2 | rpm | Flow Rate | 20500 | cfm |
| Pump B | 9.1 | rpm | Static Pressure | 4.0 | in. wg. |
| Process Air Blower | 1806.0 | rpm | Formation Fan | | |
| Flow | 27.0 | scfm | Flow Rate | 4125 | cfm |
| Quench Air Fan | 709.0 | rpm | Static Pressure | 4.0 | in. wg. |
| US Spill Air Fan | 895.0 | rpm | Basis Weight | 47.7 | gsm |
| Formation Fan | 449.0 | rpm | Total Throughput | 16.5 | kg/h |
| DS Spill Air Fan | 1804.0 | rpm | Total Basis Weight | 47.7 | gsm |

TABLE IX
Process Conditions for Meltblown Fabric Example 84.

| Polymer OBC-4 | | | Polymer OBC-4 | | |
|---|---|---|---|---|---|
| | | Units | | | Units |
| Extruder A | | | Extruder B | | |
| Melt | 492.0 | ° F. | Melt | 476.9 | ° F. |
| Pipe A | | | Pipe B | | |
| Melt | 516.9 | ° F. | Melt | 511.8 | ° F. |
| Die A | | | Die B | | |
| Pack Melt | 515.4 | ° F. | Pack Melt | 515.4 | ° F. |
| Number of Holes | 1497 | — | Hole Throughput | 0.4 | ghm |
| Spray Width | 45.5 | inches | Beam Throughput | 35.9 | kg/h |
| | | | Primary Throughput | 0.2 | ghm |
| Process Air (Outlet) | 508.1 | ° F. | Forming Table | 10.4 | M/min |
| Process Air (Die) | 522.1 | ° F. | Calender Eng Roll | 73.4 | ° F. |
| Quench Air | 52.1 | ° F. | Calender Steel Roll | 98.6 | ° F. |
| Process Air A | 5.8 | psi | | | |
| Process Air B | 6.4 | psi | Winder | 10.4 | M/min |
| DCD | 9.9 | ” | Inside Temperature | 74.9 | ° F. |
| Extruder A | 14.0 | rpm | Outside Temperature | 79.3 | ° F. |
| Extruder B | 30.0 | rpm | US Spill Air Fan | | |
| Pump A | 13.1 | rpm | Flow Rate | 20500 | cfm |
| Pump B | 19.7 | rpm | Static Pressure | 4.0 | in. wg. |
| Process Air Blower | 2894.0 | rpm | Formation Fan | | |
| Flow | 42.2 | scfm | Flow Rate | 8250 | cfm |
| Quench Air Fan | 709.0 | rpm | Static Pressure | 18.0 | in. wg. |
| US Spill Air Fan | 895.0 | rpm | Basis Weight | 50.7 | gsm |
| Formation Fan | 901.0 | rpm | Total Throughput | 35.9 | kg/h |
| DS Spill Air Fan | 1803.0 | rpm | Total Basis Weight | 50.7 | gsm |

TABLE X
Mechanical Properties of Meltblown Fabric Examples

| | | Tensile | | | | | | | | Hysteresis | | | |
|---|---|---|---|---|---|---|---|---|---|---|---|---|---|
| | | MD | | | | CD | | | | MD | | | |
| | Basis | Elongation, | | Peak | | Elongation, | | Peak | | Set, | | Load | |
| Example | wt (gsm) | (%) | stdev | Force (N) | stdev | (%) | stdev | Force (N) | stdev | MD (%) | stdev | Down, 50% (N) | stdev |
| 82 | 47.9 | 220 | 21 | 1.91 | 0.03 | 205 | 5 | 1.3 | 0.2 | 16.4 | 0.5 | 0.39 | 0.02 |
| 83 | 47.7 | 379 | 6 | 4.6 | 0.3 | 461 | 19 | 4.3 | 0.3 | 13.4 | 0.5 | 0.47 | 0.01 |
| 84 | 50.7 | 507 | 74.7 | 2.1 | 0.1 | 534 | 9 | 2.6 | 0.3 | 20 | 2 | 0.19 | 0.03 |

| | Hysteresis | | | | | | | |
|---|---|---|---|---|---|---|---|---|
| | CD | | | | RMS | | | |
| | Set, | | Load | | Elong at | Peak | Set | Load Down, |
| Example | (%) | stdev | Down, 50% (N) | stdev | peak (%) | Force (N/gsm) | (%) | 50% (N/gsm) |
| 82 | 18 | 1 | 0.24 | 0.01 | 213 | 0.03 | 17 | 0.007 |
| 83 | 16.5 | 0.9 | 0.41 | 0.04 | 422 | 0.09 | 15 | 0.009 |
| 84 | 20.3 | 0.6 | 0.23 | 0.02 | 521 | 0.05 | 20 | 0.004 |

1. A nonwoven fabric comprising bicomponent fiber comprising at least one ethylene/α-olefin interpolymer, wherein the ethylene/α-olefin interpolymer is present in a portion of the fiber other than a surface and is characterized by one or more of the following properties:
(a) a Mw/Mn from about 1.7 to about 3.5, at least one melting point, Tm, in degrees Celsius, and a density, d, in grams/cubic centimeter, wherein the numerical values of Tm and d correspond to the relationship:
Tₘ>−6553.3+13735(d)−7051.7(d)²; or
(b) a Mw/Mn from about 1.7 to about 3.5, and a heat of fusion, ΔH I in J/g, and a delta quantity, ΔT, in degrees Celsius defined as the temperature difference between the tallest DSC peak and the tallest CRYSTAF peak, wherein the numerical values of ΔT and ΔH have the following relationships:
ΔT>−0.1299(ΔH)+62.81 for ΔH greater than zero and up to 130 J/g,
ΔT≧48° C. for ΔH greater than 130 J/g,
wherein the CRYSTAF peak is determined using at least 5 percent of the cumulative polymer, and if less than 5 percent of the polymer has an identifiable CRYSTAF peak, then the CRYSTAF temperature is 30° C.; or
(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:
Re>1481−1629(d); or
(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer; or
(e) having a storage modulus at 25° C., G′ (25° C.), and a storage modulus at 100° C., G′(100° C.), wherein the ratio of G′ (25° C.) to G′ (100° C.) is from about 1:1 to about 10:1; or
(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or
(g) having an average block index greater than zero and up to about 1.0 and a molecular weight distribution, Mw/Mn, greater than about 1.3.

2. The nonwoven fabric of claim 1, wherein the bicomponent fiber comprises a sheath/core structure and where the interpolymer comprises the core of the fiber.

3. The nonwoven fabric of claim 2 wherein the core comprises from about 40 to about 95 weight percent of the total composition of the bicomponent fiber.

4. (canceled)

5. (canceled)

6. (canceled)

7. The nonwoven fabric of claim 5 wherein the sheath is discontinuous.

8. The nonwoven fabric of claim 32 further comprising a melt blown fabric thereby forming a spunbond/melt blown composite fabric structure.

9. The spunbond/melt blown fabric structure of claim 8 wherein the melt blown fabric is in intimate contact with the spunbond fabric.

10. The spunbond/melt blown fabric structure of claim 8 wherein the melt blown fabric comprises at least one bicomponent fiber having a sheath/core structure.

11. (canceled)

12. The spunbond/melt blown fabric structure of claim 10 wherein the core of the bicomponent fiber of the melt blown fabric comprises an ethylene/alpha-olefin interpolymer and is characterized by one or more of the following properties:
(a) a Mw/Mn from about 1.7 to about 3.5, at least one melting point, Tm, in degrees Celsius, and a density, d, in grams/cubic centimeter, wherein the numerical values of Tm and d correspond to the relationship:
Tₘ>−6553.3+13735(d)−7051.7(d)²; or
(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:
ΔT>−0.1299(ΔH)+62.81 for ΔH greater than zero and up to 130 J/g,
ΔT≧48° C. for ΔH greater than 130 J/g,
wherein the CRYSTAF peak is determined using at least 5 percent of the cumulative polymer, and if less than 5 percent of the polymer has an identifiable CRYSTAF peak, then the CRYSTAF temperature is 30° C.; or
(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:
Re>1481−1629(d); or
(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer; or
(e) having a storage modulus at 25° C., G′ (25° C.), and a storage modulus at 100° C., G′(100° C.), wherein the ratio of G′ (25° C.) to G′ (100° C.) is from about 1:1 to about 10:1; or
(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or
(g) having an average block index greater than zero and up to about 1.0 and a molecular weight distribution, Mw/Mn, greater than about 1.3.

13. The nonwoven fabric of claim 1 wherein the nonwoven fabric comprises a carded staple fiber web comprising the at least one ethylene/α-olefin interpolymer.

14. The nonwoven fabric of claim 13 wherein the carded staple fiber web is thermally bonded.

15. The nonwoven fabric of claim 14 further comprising a spunbond fabric.

16. The carded staple fiber web of claim 14 further comprising a melt blown fabric.

17. The nonwoven of claim 1 wherein the nonwoven fabric comprises a spun laced web comprising the at least one ethylene/α-olefin interpolymer.

18. A spunbonded fabric comprising an ethylene based bicomponent fiber wherein the bicomponent fiber comprises at least about 50 percent by weight of units derived from ethylene, the spunbonded fabric having been melt spun at a rate of no less than about 0.5 grams/minute/hole, and wherein the fabric has one or more of the following properties:
(a) a root mean square elongation at peak force greater than about 50%,
(b) a root mean square peak force greater than about 0.1 N/grams/square meter per inch width;
(c). a root mean square permanent set greater than about 15%;
(d) a root mean square load down at 50% strain greater than about 0 N/gram/square meter per inch width and as high as about 0.004 N/grams/square meter per inch width; or
(e) has a coefficient of friction less than about 0.45.

19. (canceled)

20. (canceled)

21. (canceled)

22. (canceled)

23. (canceled)

24. (canceled)

25. The nonwoven fabric of claim 1 wherein the fibers have a thermal bonding temperature range of from about 70° C. to about 125° C.

26. The nonwoven fabric of claim 1 wherein the interpolymer has a density of 0.895 g/cc or below and/or a melt index of 15 g/10 minutes and above, preferably in from about 20 to about 30 grams/10 minutes.

27. The nonwoven fabric of claim 1 wherein the nonwoven fabric comprises a melt blown fabric comprising the at least one ethylene/α-olefin interpolymer.

28. A bicomponent fiber comprising at least one ethylene/α-olefin interpolymer, wherein the ethylene/α-olefin interpolymer is present in a portion of the fiber other than the sheath and is characterized by one or more of the following properties:
(a) a Mw/Mn from about 1.7 to about 3.5, at least one melting point, Tm, in degrees Celsius, and a density, d, in grams/cubic centimeter, wherein the numerical values of Tm and d correspond to the relationship:
Tₘ>−6553.3+13735(d)−7051.7(d)²; or
(b) a Mw/Mn from about 1.7 to about 3.5, and a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:
ΔT>−0.1299(ΔH)+62.81 for ΔH greater than zero and up to 130 J/g,
ΔT≧48° C. for ΔH greater than 130 J/g,
wherein the CRYSTAF peak is determined using at least 5 percent of the cumulative polymer, and if less than 5 percent of the polymer has an identifiable CRYSTAF peak, then the CRYSTAF temperature is 30° C.; or
(c) an elastic recovery, Re, in percent at 300 percent strain and 1 cycle measured with a compression-molded film of the ethylene/α-olefin interpolymer, and a density, d, in grams/cubic centimeter, wherein the numerical values of Re and d satisfy the following relationship when the ethylene/α-olefin interpolymer is substantially free of a cross-linked phase:
Re>1481−1629(d); or
(d) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer comprises the same comonomer(s) and has a melt index, density, and molar comonomer content (based on the whole polymer) within 10 percent of that of the ethylene/α-olefin interpolymer; or
(e) having a storage modulus at 25° C., G′ (25° C.), and a storage modulus at 100° C., G′(100° C.), wherein the ratio of G′ (25° C.) to G′ (100° C.) is from about 1:1 to about 10:1; or
(f) having at least one molecular fraction which elutes between 40° C. and 130° C. when fractionated using TREF, characterized in that the fraction has a block index of at least 0.5 and up to about 1 and a molecular weight distribution, Mw/Mn, greater than about 1.3; or
(g) having an average block index greater than zero and up to about 1.0 and a molecular weight distribution, Mw/Mn, greater than about 1.3.

29. The bicomponent fiber of claim 28 wherein the interpolymer comprises from about 5 to about 35% of the total weight of the fiber.

30. (canceled)

31. (canceled)

32. The nonwoven fabric of claim 1 wherein the nonwoven fabric comprises a spunbonded fabric comprising the at least one ethylene/α-olefin interpolymer.
